(19) United States
(12) Patent Application Publication
(10) Pub. No.: US 2024/0301325 A1
(43) Pub. Date: Sep. 12, 2024

(54) Cationic Poly Alpha-1,6-Glucan Ethers and Compositions Comprising Same

(71) Applicant: NUTRITION & BIOSCIENCES USA 4, INC., Rochester, NY (US)

(72) Inventors: Brandon J. Burkhart, Newark, DE (US); Michael D. Gagnon, West Grove, PA (US); Helen S. M. Lu, Wallingford, PA (US); Weiming Qiu, Wilmington, DE (US); Mark Robert Sivik, Cincinnati, OH (US)

(21) Appl. No.: 18/001,624

(22) PCT Filed: Jun. 17, 2021
(86) PCT No.: PCT/US2021/037756

§ 371 Date: Dec. 13, 2023

Related U.S. Application Data
(60) Provisional application No. 63/040,569, filed on Jun. 18, 2020.

(51) Int. Cl. C11D 3/00; C08B 37/00; C08L 5/02; C11D 3/30; C11D 3/386

(52) U.S. Cl. CPC C11D 3/001; C08B 37/0009; C08L 5/02; C11D 3/30; C11D 3/38618; C11D 3/38627; C11D 3/38636

(57) ABSTRACT

The disclosure relates to poly alpha-1,6-glucan ether compounds comprising poly alpha-1,6-glucan substituted with at least one positively charged organic group and having a degree of substitution of about 0.001 to about 3.0. The poly alpha-1,6-glucan comprises a backbone of glucose monomer units wherein greater than or equal to 40% of the glucose monomer units are linked via alpha-1,6 glycosidic linkages, and optionally about 3% of the backbone glucose monomer units have branches via alpha-1,2 and/or alpha-1,3 glycosidic linkages. Compositions comprising a poly alpha-1,6-glucan ether compound can be useful in various applications.

This application claims the benefit of U.S. Provisional Appl. No. 63/040,569 (filed Jun. 18, 2020), which is incorporated herein by reference in its entirety.

### FIELD OF THE DISCLOSURE

The present disclosure is directed towards cationic poly alpha-1,6-glucan ether compounds comprising poly alpha-1,6-glucan substituted with at least one positively charged organic group. The poly alpha-1,6-glucan comprises a backbone of glucose monomer units wherein greater than or equal to 40% of the glucose monomer units are linked via alpha-1,6 glycosidic linkages and optionally at least 3% of the backbone units have branches via alpha-1,2 and/or alpha-1,3 glycosidic linkages.

### BACKGROUND

Driven by a desire to find new structural polysaccharides using enzymatic syntheses or genetic engineering of microorganisms, researchers have discovered oligosaccharides and polysaccharides that are biodegradable and can be made economically from renewably-sourced feedstocks. Cationic polysaccharides have utilities in personal care, household, industrial, and instutional products. Cationic polysaccharides derived from enzymatic syntheses or genetic engineering of microorganisms can find applications as viscosity modifiers, emulsifiers, binders, film formers, spreading and deposition aids, and carriers for enhancing the rheology, efficacy, deposition, aesthetics and delivery of active ingredients in personal care, household, or pet care, and provide these functions in formulations such as laundry, fabric care, cleaning, and personal care compositions.

Modern detergent compositions, including laundry, fabric, dishwashing or other cleaning compositions, comprise common detergent ingredients such as anionic, nonionic, cationic, amphoteric, zwitterionic, and/or semi-polar surfactants; as well as enzymes such as proteases, cellulases, lipases, amylases, and/or peroxidases. Laundry detergent and/or fabric care compositions may further comprise various detergent ingredients having one or more purposes in obtaining fabrics which are not only clean, fresh, and sanitized but also have retained appearance and integrity. Therefore, benefit agents such as perfumes, hygiene agents, insect control agents, bleaching agents, fabric softeners, dye fixatives, soil release agents, and fabric brightening agents have been incorporated into laundry detergent and/or fabric care compositions. In using such detergent components, it is important that some of these compounds deposit on the fabrics so as to be effective during or after the laundering and/or fabric care process.

There is a continuing need for new materials which can be used in aqueous applications such as fabric care, for example as anti-deposition and/or anti-graying agents in laundry detergents, and in home, personal care, and industrial applications. There remains a need for such materials which can be made from renewable resources.

### SUMMARY

Disclosed herein are poly alpha-1,6-glucan ether compounds comprising:
(i) poly alpha-1,6-glucan substituted with at least one positively charged organic group;
(ii) a weight average degree of polymerization of at least 5; and
(iii) a degree of substitution of about 0.001 to about 3.0;
   wherein the poly alpha-1,6-glucan comprises a backbone of glucose monomer units, and wherein at least 40% of the glucose monomer units are linked via alpha-1,6 glycosidic linkages.

In one embodiment, at least 3% of the backbone glucose monomer units have branches via alpha-1,2 and/or alpha-1,3-glycosidic linkages. In one embodiment, from about 3% to about 50% of the backbone glucose monomer units have branches via alpha-1,2- and/or alpha-1,3-glycosidic linkages. In one embodiment, from about 3% to about 35% of the backbone glucose monomer units have branches via alpha-1,2- and/or alpha-1,3-glycosidic linkages. In one embodiment, the branches are via alpha-1,2 glycosidic linkages. In one embodiment, the branches are via alpha-1,3 glycosidic linkages.

In one embodiment, the poly alpha-1,6-glucan ether compound has a weight average degree of polymerization in the range of from about 5 to about 6000.

In one embodiment, the degree of substitution is about 0.01 to about 1.5.

In one embodiment, the positively charged organic group comprises a substituted ammonium group. In one embodiment, the substituted ammonium group comprises a quaternary ammonium group. In one embodiment, the quaternary ammonium group comprises a trimethylammonium group.

In one embodiment, the quaternary ammonium group comprises at least one C₁ to C₁₈ alkyl group. In one embodiment, the quaternary ammonium group comprises at least one C₁ to C₄ alkyl group. In one embodiment, the quaternary ammonium group comprises at least one C₁₀ to C₁₆ alkyl group. In one embodiment, the quaternary ammonium group comprises at least one C₁₀ to C₁₆ alkyl group, and further comprises two methyl groups.

In one embodiment, the positively charged organic group comprises a quaternary ammonium hydroxyalkyl group. In one embodiment, the quaternary ammonium hydroxyalkyl group comprises a quaternary ammonium hydroxymethyl group, a quaternary ammonium hydroxyethyl group, or a quaternary ammonium hydroxypropyl group. In one embodiment, the quaternary ammonium hydroxyalkyl group comprises a trimethylammonium hydroxyalkyl group. In one embodiment, the trimethylammonium hydroxyalkyl group is a trimethylammonium hydroxypropyl group.

Also disclosed herein are compositions comprising a poly alpha-1,6-glucan ether compound as disclosed herein. Further disclosed herein are a personal care product, a home care product, and an industrial product comprising a poly alpha-1,6-glucan ether compound as disclosed herein, or comprising a composition containing a poly alpha-1,6-glucan ether compound as disclosed herein.

In another embodiment, the composition is in the form of a liquid, a gel, a powder, a hydrocolloid, an aqueous solution, a granule, a tablet, a capsule, a bead or pastille, a single compartment sachet, a pad, a multi-compartment sachet, a single compartment pouch, or a multi-compartment pouch.

In yet another embodiment, the composition further comprises at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer-inhibiting agent, a chelating agent, a hueing dye, a calcium cation, a magnesium cation, a visual signaling ingredient, an anti-foam, a structurant, a thickener, an anti-caking agent, a starch, sand, a gelling agent, or a combination thereof.

In one embodiment, the enzyme is a cellulase, a protease, a lipase, an amylase, or a combination thereof. In one embodiment, the enzyme is a cellulase. In another embodiment, the enzyme is a protease. In a further embodiment, the enzyme is an amylase.

Also disclosed herein is a personal care product, a home care product, an industrial product, or a fabric care product comprising the composition.

Also disclosed herein is a method for treating a substrate, the method comprising the steps:
(a) providing a composition comprising a poly alpha-1,6-glucan ether compound as disclosed herein;
(b) contacting the substrate with the composition; and
(c) optionally rinsing the substrate;
   wherein the substrate is a textile, a fabric, carpet, upholstery, apparel, or a surface.

### DETAILED DESCRIPTION

The disclosures of all cited patent and non-patent literature are incorporated herein by reference in their entirety.

As used herein, the term “embodiment” or “disclosure” is not meant to be limiting, but applies generally to any of the embodiments defined in the claims or described herein. These terms are used interchangeably herein.

In this disclosure, a number of terms and abbreviations are used. The following definitions apply unless specifically stated otherwise.

The articles “a”, “an”, and “the” preceding an element or component are intended to be nonrestrictive regarding the number of instances (i.e. occurrences) of the element or component. These articles “a”, “an”, and “the” should be read to include one or at least one, and the singular word form of the element or component also includes the plural unless the number is obviously meant to be singular.

The term “comprising” means the presence of the stated features, integers, steps, or components as referred to in the claims, but that it does not preclude the presence or addition of one or more other features, integers, steps, components, or groups thereof. The term “comprising” is intended to include embodiments encompassed by the terms “consisting essentially of” and “consisting of”. Similarly, the term “consisting essentially of” is intended to include embodiments encompassed by the term “consisting of”.

Where present, all ranges are inclusive and combinable. For example, when a range of “1 to 5” is recited, the recited range should be construed as including ranges “1 to 4”, “1 to 3”, “1-2”, “1-2 and 4-5”, “1-3 and 5”, and the like.

It is intended that every maximum numerical limitation given throughout this Specification includes every lower numerical limitation, as if such lower numerical limitations were expressly written herein. Every minimum numerical limitation given throughout this Specification will include every higher numerical limitation, as if such higher numerical limitations were expressly written herein. Every numerical range given throughout this Specification will include every narrower numerical range that falls within such broader numerical range, as if such narrower numerical ranges were all expressly written herein.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including each and every value between the minimum and maximum values.

The features and advantages of the present disclosure will be more readily understood, by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

As used herein:

The term “polysaccharide” means a polymeric carbohydrate molecule composed of long chains of monosaccharide units bound together by glycosidic linkages and on hydrolysis gives the constituent monosaccharides or oligosaccharides.

The terms “poly alpha-1,6-glucan”, “alpha-1,6-glucan”, “dextran”, “dextran polymer” and the like herein refer to an alpha-glucan comprising at least 40% alpha-1,6 glycosidic linkages.

The terms “percent by weight”, “weight percentage (wt %)” and “weight-weight percentage (% w/w)” are used interchangeably herein. Percent by weight refers to the percentage of a material on a mass basis as it is comprised in a composition, mixture or solution.

The term “polysaccharide derivative” as used herein means a chemically modified polysaccharide in which at least some of the hydroxyl groups of the glucose monomer units have been replaced with one or more ether groups. As used herein, the term “polysaccharide derivative” is used interchangeably with “poly alpha-1,6-glucan ether” and “poly alpha-1,6-glucan ether compound”.

The term “hydrophobic” refers to a molecule or substituent which is nonpolar and has little or no affinity for water, and which tends to repel water.

The term “hydrophilic” refers to a molecule or a substituent which is polar and has affinity to interact with polar solvents, in particular with water, or with other polar groups. A hydrophilic molecule or substituent tends to attract water.

The “molecular weight” of a poly alpha-1,6-glucan or poly alpha-1,6-glucan ether can be represented as statistically averaged molecular mass distribution, i.e. as number-average molecular weight (Mₙ) or as weight-average molecular weight (M_{w}), both of which are generally given in units of Daltons (Da), i.e. in grams/mole. Alternatively, molecular weight can be represented as DPw (weight average degree of polymerization) or DPn (number average degree of polymerization). Various means are known in the art for calculating these molecular weights from techniques such as high-pressure liquid chromatography (HPLC), size exclusion chromatography (SEC), gel permeation chromatography (GPC), and gel filtration chromatography (GFC).

As used herein, “weight average molecular weight” or “M_{w}” is calculated as M_{w}=ΣNᵢMᵢ²/ΣNᵢMᵢ; where Mᵢ is the molecular weight of an individual chain i and Nᵢ is the number of chains of that molecular weight. In addition to using SEC, the weight average molecular weight can be determined by other techniques such as static light scattering, mass spectrometry especially MALDI-TOF (matrix-assisted laser desorption/ionization time-of-flight), small angle X-ray or neutron scattering, and ultracentrifugation.

As used herein, “number average molecular weight” or “Mₙ” refers to the statistical average molecular weight of all the polymer chains in a sample. The number average molecular weight is calculated as Mₙ=ΣNᵢMᵢ/ΣNᵢ where Mᵢ is the molecular weight of a chain i and Nᵢ is the number of chains of that molecular weight. In addition to using SEC, the number average molecular weight of a polymer can be determined by various colligative methods such as vapor pressure osmometry or end-group determination by spectroscopic methods such as proton NMR, FTIR, or UV-vis.

As used herein, number average degree of polymerization (DPn) and weight average degree of polymerization (DPw) are calculated from the corresponding average molecular weights Mw or Mn by dividing by the molar mass of one monomer unit M₁. In the case of unsubstituted glucan polymer, M₁=162. In the case of a substituted glucan polymer, M₁=162+M_{f}×DoS, where M_{f} is the molar mass of the substituent group and DoS is the degree of substitution with respect to that substituent group (average number of substituted groups per one glucose unit).

Glucose carbon positions 1, 2, 3, 4, 5 and 6 as referred to herein are as known in the art and depicted in Structure I:

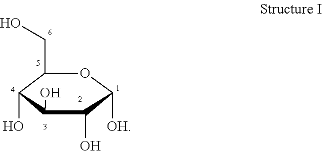

The terms “glycosidic linkage” and “glycosidic bond” are used interchangeably herein and refer to the type of covalent bond that joins a carbohydrate (sugar) molecule to another group such as another carbohydrate. The term “alpha-1,6-glucosidic linkage” as used herein refers to the covalent bond that joins alpha-D-glucose molecules to each other through carbons 1 and 6 on adjacent alpha-D-glucose rings. The term “alpha-1,3-glucosidic linkage” as used herein refers to the covalent bond that joins alpha-D-glucose molecules to each other through carbons 1 and 3 on adjacent alpha-D-glucose rings. The term “alpha-1,2-glucosidic linkage” as used herein refers to the covalent bond that joins alpha-D-glucose molecules to each other through carbons 1 and 2 on adjacent alpha-D-glucose rings. The term “alpha-1,4-glucosidic linkage” as used herein refers to the covalent bond that joins alpha-D-glucose molecules to each other through carbons 1 and 4 on adjacent alpha-D-glucose rings. Herein, “alpha-D-glucose” will be referred to as “glucose”.

The glycosidic linkage profile of a glucan, dextran, substituted glucan, or substituted dextran can be determined using any method known in the art. For example, a linkage profile can be determined using methods that use nuclear magnetic resonance (NMR) spectroscopy (e.g., ¹³C NMR or ¹H NMR). These and other methods that can be used are disclosed in Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, F L, 2005), which is incorporated herein by reference.

The structure, molecular weight, and degree of substitution of a polysaccharide or polysaccharide derivative can be confirmed using various physiochemical analyses known in the art such as NMR spectroscopy and size exclusion chromatography (SEC).

The term “alkyl group”, as used herein, refers to linear, branched, aralkyl (such as benzyl), or cyclic (“cycloalkyl”) hydrocarbon groups containing no unsaturation. As used herein, the term “alkyl group” encompasses substituted alkyls, for example alkyl groups substituted with at least one hydroxyalkyl group or dihydroxy alkyl group, as well as alkyl groups containing one or more heteroatoms such as oxygen, sulfur, and/or nitrogen within the hydrocarbon chain.

As used herein, the term “aryl” means an aromatic/carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with alkyl groups. By aryl is also meant heteroaryl groups where heteroaryl is defined as 5-, 6-, or 7-membered aromatic ring systems having at least one hetero atom selected from the group consisting of nitrogen, oxygen and sulfur. Examples of heteroaryl groups include pyridyl, pyrimidinyl, pyrrolyl, pyrazolyl, pyrazinyl, pyridazinyl, oxazolyl, furanyl, imidazole, quinolinyl, isoquinolinyl, thiazolyl, and thienyl, which can optionally be substituted with alkyl groups.

The terms “household care product”, “home care product”, and like terms typically refer to products, goods and services relating to the treatment, cleaning, caring, and/or conditioning of a home and its contents. The foregoing include, for example, chemicals, compositions, products, or combinations thereof having application in such care.

The term “personal care product” and like terms typically refer to products, goods and services relating to the treatment, cleaning, cleansing, caring, or conditioning of a person. The foregoing include, for example, chemicals, compositions, products, or combinations thereof having application in such care.

The term “industrial product” and like terms typically refer to products, goods and services used in industrial settings, but typically not by individual consumers.

The present disclosure is directed to a poly alpha-1,6-glucan ether compound comprising:
(i) poly alpha-1,6-glucan substituted with at least one positively charged organic group;
(ii) a weight average degree of polymerization of at least 5; and
(iii) a degree of substitution of about 0.001 to about 3.0;
   wherein the poly alpha-1,6-glucan comprises a backbone of glucose monomer units, wherein at least 40% of the glucose monomer units are linked via alpha-1,6-glycosidic linkages, and optionally at least 3% of the backbone glucose monomer units have branches via alpha-1,2 and/or alpha-1,3 glycosidic linkages. Optionally, the poly alpha-1,6-glucan is (a) only substituted with the at least one positively charged organic group, or (b) not substituted with a hydrophobic group or negatively charged organic group.

The poly alpha-1,6-glucan ether compounds disclosed herein comprise poly alpha-1,6-glucan substituted with at least one positively charged organic group, wherein the organic group or groups are independently linked to the poly alpha-1,6-glucan polysaccharide backbone and/or to any branches, if present, through an ether (—O—) linkage. The at least one positively charged organic group can derivatize the poly alpha-1,6-glucan at the 2, 3, and/or 4 glucose carbon position(s) of a glucose monomer on the backbone of the glucan, and/or at the 2, 3, 4, or 6 glucose carbon position(s) of a glucose monomer on a branch, if present. At unsubstituted positions a hydroxyl group is present in a glucose monomer.

The poly alpha-1,6-glucan ether compounds disclosed herein are referred to as “cationic” ether compounds due to the presence of one or more positively charged organic groups. The terms “positively charged organic group”, “positively charged ionic group”, and “cationic group” are used interchangeably herein. A positively charged group comprises a cation (a positively charged ion). Examples of positively charged groups include substituted ammonium groups, carbocation groups, and acyl cation groups.

The cationic poly alpha-1,6-glucan ether compounds disclosed herein comprise water-soluble poly alpha-1,6-glucan comprising a backbone of glucose monomer units, wherein at least 40% of the glucose monomer units are linked via alpha-1,6-glycosidic linkages, and optionally at least 3% of the backbone glucose monomer units have branches via alpha-1,2 and/or alpha-1,3-glycosidic linkages, the poly alpha-1,6-glucan being substituted (preferably randomly substituted) with positively charged organic groups on the polysaccharide backbone and/or on any branches which may be present, such that the poly alpha-1,6-glucan ether compound comprises unsubstituted and substituted alpha-D-glucose rings. As used herein, the term “randomly substituted” means the substituents on the glucose rings in the randomly substituted polysaccharide occur in a non-repeating or random fashion. That is, the substitution on a substituted glucose ring may be the same or different [i.e. the substituents (which may be the same or different) on different atoms in the glucose rings in the polysaccharide] from the substitution on a second substituted glucose ring in the polysaccharide, such that the overall substitution on the polymer has no pattern. Further, the substituted glucose rings occur randomly within the polysaccharide (i.e., there is no pattern with the substituted and unsubstituted glucose rings within the polysaccharide).

In some embodiments, depending on reaction conditions and the specific substituent used to derivatize the poly alpha-1,6-glucan, the glucose monomers of the polymer backbone may be disproportionately substituted relative to the glucose monomers of any branches, including branches via alpha-1,2 and/or alpha-1,3 linkages, if present. In another embodiment, the glucose monomers of the branches, including branches via alpha-1,2 and/or alpha-1,3 linkages, if present, may be disproportionately substituted relative to the glucose monomers of the polymer backbone. In some embodiments, depending on reaction conditions and the specific substituent used, substitution of the poly alpha-1,6-glucan may occur in a block manner.

In some embodiments, depending on reaction conditions and the specific substituent used to derivatize the poly alpha-1,6-glucan, the glucose monomers of the polymer backbone may be disproportionately substituted relative to the glucose monomers of any branches, including branches via alpha-1,2 and/or alpha-1,3 linkages, if present. In another embodiment, the glucose monomers of the branches, including branches via alpha-1,2 and/or alpha-1,3 linkages, if present, may be disproportionately substituted relative to the glucose monomers of the polymer backbone. In some embodiments, depending on reaction conditions and the specific substituent used, substitution of the poly alpha-1,6-glucan may occur in a block manner.

The poly alpha-1,6-glucan ether compounds disclosed herein contain positively charged organic groups and are of interest due to their solubility characteristics in water, which can be varied by appropriate selection of substituents and the degree of substitution. Compositions comprising the poly alpha-1,6-glucan ether compounds can be useful in a wide range of applications, including laundry, cleaning, food, cosmetics, industrial, film, and paper production. Poly alpha-1,6-glucan ether compounds having greater than 0.1 weight percent (wt %) solubility in water can be useful as rheology modifiers, emulsion stabilizers, and dispersing agents in cleaning, detergent, cosmetics, food, cement, film, and paper production, wherein the products are in a primarily water based formulation and optical clarity is desired. Poly alpha-1,6-glucan ether compounds having less than 0.1 wt % solubility in water can be useful as rheology modifiers, emulsion stabilizers, and dispersing agents in cleaning, detergent, cosmetics, food, cement, film, and paper production, wherein the products are in formulations which contain organic solvents to solubilize or disperse the poly alpha-1,6-glucan derivatives. In one embodiment, a poly alpha-1,6-glucan ether compound has a DoS of about 0.001 to about 1.5 and a solubility of 0.1% by weight or higher in deionized water at 25° C. In another embodiment, a poly alpha-1,6-glucan ether compound has a DoS of about 0.05 to about 1.5 and a solubility of less than 0.1% by weight in pH 7 water at 25° C.

The cationic poly alpha-1,6-glucan ether compounds disclosed herein can be comprised in a personal care product, pharmaceutical product, household product, or industrial product in an amount that provides a desired degree of one or more of the following physical properties to the product: thickening, freeze/thaw stability, lubricity, moisture retention and release, texture, consistency, shape retention, emulsification, binding, suspension, dispersion, and gelation, for example. Examples of a concentration or amount of a poly alpha-1,6-glucan ether compound as disclosed herein in a product, on a weight basis, can be about 0.01-10 wt %, 0.1-0.8 wt %, 0.1-1 wt %, 0.1-2 wt %, 0.1-3 wt %, 0.1-5 wt %, 1-2 wt %, 1.5-2.5 wt %, 2.0 wt %, 0.1-4 wt %, 0.1-5 wt %, or 0.1-10 wt %, for example.

An aqueous composition comprising a cationic poly alpha-1,6-glucan ether compound herein can have a viscosity of about, or at least about, 5, 10, 100, 200, 300, 400, 500, 600, 700, 1000, 2000, 3000, 4000, 5000, 6000, 7000, 8000, 9000, 10000, 15000, 1-1500, 100-1000, 100-500, 100-300, or 100-200 centipoise (cps), for example. Viscosity can be as measured with an aqueous composition at any temperature between about 3° C. to about 80° C., for example (e.g., 4-30° C., 15-30° C., 15-25° C.). Viscosity typically is as measured at atmospheric pressure (about 760 torr) or a pressure that is +10% thereof. Viscosity can be measured using a viscometer or rheometer, for example, and can optionally be as measured at a shear rate (rotational shear rate) of about 0.1, 0.5, 1.0, 5, 10, 50, 100, 500, 1000, 0.1-500, 0.1-100, 1.0-500, 1.0-1000, or 1.0-100 s⁻¹ (1/s), for example.

An composition herein comprising a cationic poly alpha-1,6-glucan ether compound as presently disclosed can have a turbidity of about, or less than about, 0.5, 1, 2, 3, 4, 5, 6, 7, 8, 9, 10, 11, 12, 13, 14, 15, 16, 17, 18, 19, 20, 0.5-20, 0.5-15, 0.5-10, 0.5-5, 0.5-3, 1-20, 1-15, 1-10, 1-5, or 1-3 NTU (nephelometric turbidity units), for example. Turbidity can be as measured with an aqueous composition at any temperature between about 3° C. to about 80° C., for example (e.g., 4-30° C., 15-30° C., 15-25° C.). Any suitable method can be used to measure turbidity, such as the methodology disclosed in Progress in Filtration and Separation (Edition: 1, Chapter 16. Turbidity: Measurement of Filtrate and Supernatant Quality?, Publisher: Academic Press, Editors: E. S. Tarleton, July 2015), which is incorporated herein by reference.

A household and/or industrial product herein can be in the form of drywall tape-joint compounds; mortars; grouts; cement plasters; spray plasters; cement stucco; adhesives; pastes; wall/ceiling texturizers; binders and processing aids for tape casting, extrusion forming, injection molding and ceramics; spray adherents and suspending/dispersing aids for pesticides, herbicides, and fertilizers; fabric care products such as fabric softeners and laundry detergents; hard surface cleaners; air fresheners; polymer emulsions; gels such as water-based gels; surfactant solutions; paints such as water-based paints; protective coatings; adhesives; sealants and caulks; inks such as water-based ink; metal-working fluids; emulsion-based metal cleaning fluids used in electroplating, phosphatizing, galvanizing and/or general metal cleaning operations; hydraulic fluids (e.g., those used for fracking in downhole operations); and aqueous mineral slurries, for example.

The terms “poly alpha-1,6-glucan” and “dextran” are used interchangeably herein. Dextrans represent a family of complex, branched alpha-glucans generally comprising chains of alpha-1,6-linked glucose monomers, with periodic side chains (branches) linked to the straight chains by alpha-1,3-linkage (loan et al., Macromolecules 33:5730-5739) and/or alpha-1,2-linkage. Production of dextran for producing a poly alpha-1,6-glucan derivative herein can be done, for example, through fermentation of sucrose with bacteria (e.g., Leuconostoc or Streptococcus species), where sucrose serves as the source of glucose for dextran polymerization (Naessens et al., J. Chem. Technol. Biotechnol. 80:845-860; Sarwat et al., Int. J. Biol. Sci. 4:379-386; Onilude et al., Int. Food Res. J. 20:1645-1651). Alternatively, poly alpha-1,6-glucan can be prepared using a glucosyltransferase (dextransucrase) such as (but not limited to) GTF1729, GTF1428, GTF5604, GTF6831, GTF8845, GTF0088, and GTF8117 as described in Int. Patent Appl. Publ. Nos. WO2015/183714 or WO2017/091533, or U.S. Patent Appl. Publ. Nos. 2017/0218093 or 2018/0282385, all of which are incorporated herein by reference.

In some embodiments, the cationic poly alpha-1,6-glucan ether compound comprises a backbone of glucose monomer units wherein greater than or equal to 40%, 45%, 50%, 55%, 60%, 65%, 70%, 75%, 80%, 85%, 90%, 95%, 96%, 97%, 98%, 99%, 99.5%, or 100% of the glucose monomer units are linked via alpha-1,6-glycosodic linkages. The backbone of the cationic poly alpha-1,6-glucan ether compound can comprise 0.5%, 1%, 2%, 3%, 4%, 5%, 10%, 15%, 20%, 25%, 30%, 35%, 40%, 45%, 50%, 55%, or 60% glucose monomer units which are linked via alpha-1,2, alpha-1,3, and/or alpha-1,4 glycosidic linkages. In some aspects, the poly alpha-1,6-glucan derivative comprises a backbone that is linear (unbranched).

Dextran “long chains” can comprise “substantially (or mostly) alpha-1,6-glucosidic linkages”, meaning that they can have at least about 98.0% alpha-1,6-glucosidic linkages in some aspects. Dextran herein can comprise a “branching structure” (branched structure, dendritic) in some aspects. It is contemplated that in this structure, long chains branch from other long chains, likely in an iterative manner (e.g., a long chain can be a branch from another long chain, which in turn can itself be a branch from another long chain, and so on). It is contemplated that long chains in this structure can be “similar in length”, meaning that the length (DP [degree of polymerization]) of at least 70% of all the long chains in a branching structure is within plus/minus 30% of the mean length of all the long chains of the branching structure.

Dextran in some embodiments can also comprise “short chains” branching from the long chains, typically being one to three glucose monomers in length, and typically comprising less than about 10% of all the glucose monomers of a dextran polymer. Such short chains typically comprise alpha-1,2-, alpha-1,3-, and/or alpha-1,4-glucosidic linkages (it is understood that there can also be a small percentage of such non-alpha-1,6 linkages in long chains in some aspects). In certain embodiments, the poly-1,6-glucan with branching is produced enzymatically according to the procedures in WO2015/183714 and WO2017/091533 (both incorporated herein by reference) where, for example, alpha-1,2-branching enzymes such as GTFJ18T1 or GTF9905 can be added during or after the production of the dextran polymer (polysaccharide). In some embodiments, any other enzyme known to produce alpha-1,2-branching can be added. Poly alpha-1,6-glucan with alpha-1,3-branching can be prepared as disclosed in Vuillemin et al. (2016, J. Biol Chem. 291:7687-7702), Int. Patent Appl. Publ. No. WO2021/007264, or U.S. Appl. No. 62/871,796 (as originally filed), which are incorporated herein by reference. The degree of branching of poly alpha-1,6-glucan or a poly alpha-1,6-glucan derivative in such embodiments has less than or equal to 50%, 40%, 30%, 20%, 10%, or 5% (or any integer value between 5% and 50%) of short branching, for example alpha-1,2-branching or 1,3-branching. In one embodiment, the poly alpha-1,6-glucan or the poly alpha-1,6-glucan derivative has a degree of alpha-1,2-branching that is less than 50%. In another embodiment, the poly alpha-1,6-glucan or the poly alpha-1,6-glucan derivative has a degree of alpha-1,2-branching that is at least 3%. In one embodiment, at least 3% of the backbone glucose monomer units of the poly alpha-1,6-glucan derivative have branches via alpha-1,2- or alpha-1,3-glycosidic linkages. In one embodiment, the poly apha-1,6-glucan or the poly alpha-1,6-glucan derivative comprises a backbone of glucose monomer units wherein greater than or equal to 40% of the glucose monomer units are linked via alpha-1,6-glycosidic linkages. In one embodiment, the poly alpha-1,6-glucan derivative comprises a backbone of glucose monomer units wherein greater than or equal to 40% of the glucose monomer units are linked via alpha-1,6-glycosidic linkages and at least 3% of the glucose monomer units have branches via alpha-1,2- or alpha-1,3-glycosidic linkages. In one embodiment, the poly alpha-1,6-glucan derivative comprises a backbone of glucose monomer units wherein greater than or equal to 40% of the glucose monomer units are linked via alpha-1,6-glycosidic linkages and at least 3% of the glucose monomer units have branches via alpha-1,2 linkages. In one embodiment, the poly alpha-1,6-glucan derivative comprises a backbone of glucose monomer units wherein greater than or equal to 40% of the glucose monomer units are linked via alpha-1,6-glycosidic linkages and at least 3% of the glucose monomer units have branches via alpha-1,3 linkages. In one embodiment, the poly alpha-1,6-glucan or poly alpha-1,6-glucan derivative is linear, or predominantly linear. In some aspects, about, at least about, or less than about, 1%, 2%, 3%, 4%, 5%, 10%, 15%, 20%, 25%, 30%, 35%, 40%, 50%, 55%, 60%, 65%, 70%, 75%, 80%, 85%, 90%, 20-50%, 20-60%, 30-50%, 30-60%, or 35-45% of the backbone glucose monomer units of a poly alpha-1,6-glucan or derivative thereof as presently disclosed can have branches via alpha-1,2 and/or alpha-1,3 glycosidic linkages. In some aspects, about, at least about, or less than about, 1%, 2%, 2.5%, 5%, 10%, 15%, 20%, 25%, 30%, 35%, 40%, 45%, 10-25%, 10-30%, 15-25%, 15-30%, or 17-23% of all the glycosidic linkages of an alpha-1,2- and/or alpha-1,3-branched poly alpha-1,6-glucan or derivative thereof as presently disclosed are alpha-1,2 and/or alpha-1,3 glycosidic linkages. The amount of alpha-1,2-branching or alpha-1,3-branching can be determined by NMR methods, as disclosed in the Examples.

In one embodiment, a poly alpha-1,6-glucan ether compound has a degree of alpha-1,2-branching that is less than 50%. In another embodiment, a poly alpha-1,6-glucan ether compound has a degree of alpha-1,2-branching that is at least 3%. In one embodiment, about 3% to about 50% of the backbone glucose monomer units of a poly alpha-1,6-glucan ether compound have branches via alpha-1,2 or alpha-1,3 glycosidic linkages. In a further embodiment, about 3% to about 35% of the backbone glucose monomer units of a poly alpha-1,6-glucan ether compound have branches via alpha-1,2 or alpha-1,3 glycosidic linkages.

In one embodiment, at least 3% of the backbone glucose monomer units of a poly alpha-1,6-glucan ether compound have branches via alpha-1,2- or alpha-1,3-glycosidic linkages. In one embodiment, a poly alpha-1,6-glucan ether compound comprises a backbone of glucose monomer units wherein greater than or equal to 40% of the glucose monomer units are linked via alpha-1,6-glycosidic linkages. In one embodiment, a poly alpha-1,6-glucan ether compound comprises a backbone of glucose monomer units wherein greater than or equal to 40% of the glucose monomer units are linked via alpha-1,6-glycosidic linkages and at least 3% of the glucose monomer units have branches via alpha-1,2- or alpha-1,3-glycosidic linkages. In one embodiment, a poly alpha-1,6-glucan ether compound comprises a backbone of glucose monomer units wherein greater than or equal to 40% of the glucose monomer units are linked via alpha-1,6-glycosidic linkages and at least 3% of the glucose monomer units have branches via alpha-1,2 linkages. In one embodiment, a poly alpha-1,6-glucan ether compound comprises a backbone of glucose monomer units wherein greater than or equal to 40% of the glucose monomer units are linked via alpha-1,6-glycosidic linkages and at least 3% of the glucose monomer units have branches via alpha-1,3 linkages. In one embodiment, a poly alpha-1,6-glucan ether compound comprises a backbone of glucose monomer units wherein greater than or equal to 40% of the glucose monomer units are linked via alpha-1,6-glycosidic linkages and from about 3% to about 50% of the glucose monomer units have branches via alpha-1,2- or alpha-1,3-glycosidic linkages. In one embodiment, a poly alpha-1,6-glucan ether compound comprises a backbone of glucose monomer units wherein greater than or equal to 70% of the glucose monomer units are linked via alpha-1,6-glycosidic linkages and from about 3% to about 35% of the glucose monomer units have branches via alpha-1,2- or alpha-1,3-glycosidic linkages.

In one embodiment, a poly alpha-1,6-glucan ether compound comprises a backbone of glucose monomer units wherein greater than or equal to 90% of the glucose monomer units are linked via alpha-1,6-glycosidic linkages. In one embodiment, a poly alpha-1,6-glucan ether compound comprises a backbone of glucose monomer units wherein greater than or equal to 90% of the glucose monomer units are linked via alpha-1,6-glycosidic linkages and at least 3% of the glucose monomer units have branches via alpha-1,2- or alpha-1,3-glycosidic linkages. In one embodiment, a poly alpha-1,6-glucan ether compound comprises a backbone of glucose monomer units wherein greater than or equal to 90% of the glucose monomer units are linked via alpha-1,6-glycosidic linkages and at least 3% of the glucose monomer units have branches via alpha-1,2 linkages. In one embodiment, a poly alpha-1,6-glucan ether compound comprises a backbone of glucose monomer units wherein greater than or equal to 90% of the glucose monomer units are linked via alpha-1,6-glycosidic linkages and at least 3% of the glucose monomer units have branches via alpha-1,3 linkages. In one embodiment, a poly alpha-1,6-glucan ether compound comprises a backbone of glucose monomer units wherein greater than or equal to 90% of the glucose monomer units are linked via alpha-1,6-glycosidic linkages and from about 3% to about 50% of the glucose monomer units have branches via alpha-1,2- or alpha-1,3-glycosidic linkages. In one embodiment, a poly alpha-1,6-glucan ether compound comprises a backbone of glucose monomer units wherein greater than or equal to 90% of the glucose monomer units are linked via alpha-1,6-glycosidic linkages and from about 3% to about 35% of the glucose monomer units have branches via alpha-1,2- or alpha-1,3-glycosidic linkages.

The poly alpha-1,6-glucan and poly alpha-1,6-glucan derivatives disclosed herein can have a number-average degree of polymerization (DPn) or weight-average degree of polymerization (DPw) in the range of 5 to 6000. In some embodiments, the DPn or DPw can be in the range of 5 to 100, 5 to 500, 5 to 1000, 5 to 1500, 5 to 2000, 5 to 2500, 5 to 3000, 5 to 4000, 5 to 5000, or 5 to 6000. In some embodiments, the DPn or DPw can be in the range of 50 to 500, 50 to 1000, 50 to 1500, 50 to 2000, 50 to 3000, 50 to 4000, 50 to 5000, or 50 to 6000. In some embodiments, the DPn or DPw can be in the range of 400 to 6000, 400 to 5000, 400 to 4000, 400 to 3000, 400 to 2000, or 400 to 1000. In some embodiments, the DPn or DPw can be about, at least about, or less than about, 5, 10, 25, 50, 100, 250, 500, 1000, 1500, 2000, 2500, 3000, 4000, 5000, 6000, 5-100, 5-250, 5-500, 5-1000, 5-1500, 5-2000, 5-2500, 5-3000, 5-4000, 5-5000, 5-6000, 10-100, 10-250, 10-500, 10-1000, 10-1500, 10-2000, 10-2500, 10-3000, 10-4000, 10-5000, 10-6000, 25-100, 25-250, 25-500, 25-1000, 25-1500, 25-2000, 25-2500, 25-3000, 25-4000, 25-5000, 25-6000, 50-100, 50-250, 50-500, 50-1000, 50-1500, 50-2000, 50-2500, 50-3000, 50-4000, 50-5000, 50-6000, 100-100, 100-250, 100-400, 100-500, 100-1000, 100-1500, 100-2000, 100-2500, 100-3000, 100-4000, 100-5000, 100-6000, 250-500, 250-1000, 250-1500, 250-2000, 250-2500, 250-3000, 250-4000, 250-5000, 250-6000, 300-2800, 300-3000, 350-2800, 350-3000, 500-1000, 500-1500, 500-2000, 500-2500, 500-2800, 500-3000, 500-4000, 500-5000, 500-6000, 600-1550, 600-1850, 600-2000, 600-2500, 600-3000, 750-1000, 750-1250, 750-1500, 750-2000, 750-2500, 750-3000, 750-4000, 750-5000, 750-6000, 900-1250, 900-1500, 900-2000, 1000-1250, 1000-1400, 1000-1500, 1000-2000, 1000-2500, 1000-3000, 1000-4000, 1000-5000, 1000-6000, or 1100-1300.

The term “degree of substitution” (DOS) as used herein refers to the average number of hydroxyl groups substituted in each monomeric unit (glucose) of a cationic poly alpha-1,6-glucan ether compound, which includes the monomeric units within the backbone and within any alpha-1,2 or alpha-1,3 branches which may be present. Since there are at most three hydroxyl groups in a glucose monomeric unit in a poly alpha-1,6-glucan polymer, the overall degree of substitution can be no higher than 3.0. It would be understood by those skilled in the art that, since a cationic poly alpha-1,6-glucan ether compound as disclosed herein can have a degree of substitution between about 0.001 to about 3.0, the substituents on the polysaccharide cannot only be hydroxyl. The degree of substitution of a poly alpha-1,6-glucan ether compound can be stated with reference to a specific substituent or with reference to the overall degree of substitution, that is, the sum of the DoS of each different substituent for an ether compound as defined herein. As used herein, when the degree of substitution is not stated with reference to a specific substituent or substituent type, the overall degree of substitution of the cationic poly alpha-1,6-glucan ether compound is meant. The target DoS can be chosen to provide the desired solubility and performance of a composition comprising a cationic poly alpha-1,6-glucan ether compound in the specific application of interest.

Cationic poly alpha-1,6-glucan ether compounds disclosed herein have a DoS with respect to a positively charged organic group in the range of about 0.001 to about 3.0. In a further embodiment, a cationic poly alpha-1,6-glucan ether has a DoS of about 0.01 to about 1.5. In another embodiment, the poly alpha-1,6-glucan ether has a DoS of about 0.01 to about 0.7. In yet another embodiment, the poly alpha-1,6-glucan ether has a DoS of about 0.01 to about 0.4 In a further embodiment, the poly alpha-1,6-glucan ether has a DoS of about 0.01 to about 0.2. In yet another embodiment, the DoS of the poly alpha-1,6-glucan ether compound can be about, at least about, or less than about, 0.001, 0.005, 0.01, 0.02, 0.03, 0.04, 0.05, 0.06, 0.07, 0.08, 0.09, 0.1, 0.15, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 0.01-1.5, 0.01-1.0, 0.01-0.8, 0.01-0.6, 0.01-0.5, 0.01-0.25, 0.01-0.2, 0.01-0.15, 0.01-0.12, 0.01-0.1, 0.01-0.08, 0.02-1.5, 0.02-1.0, 0.02-0.8, 0.02-0.6, 0.02-0.5, 0.02-0.25, 0.02-0.2, 0.02-0.15, 0.02-0.12, 0.02-0.1, 0.02-0.08, 0.03-1.5, 0.03-1.0, 0.03-0.8, 0.03-0.7, 0.03-0.6, 0.03-0.5, 0.03-0.25, 0.03-0.2, 0.03-0.15, 0.03-0.12, 0.03-0.1, 0.03-0.08, 0.04-1.5, 0.04-1.0, 0.04-0.8, 0.04-0.7, 0.04-0.6, 0.04-0.5, 0.04-0.25, 0.04-0.2, 0.04-0.15, 0.04-0.12, 0.04-0.1, 0.04-0.08, 0.05-0.6, 0.05-0.5, 0.06-1.5, 0.06-1.0, 0.06-0.8, 0.06-0.7, 0.06-0.6, 0.06-0.5, 0.06-0.25, 0.06-0.2, 0.06-0.15, 0.06-0.12, 0.06-0.1, 0.06-0.08, 0.2-0.8, 0.2-0.6, 0.2-0.5, 0.3-0.8, 0.3-0.6, 0.3-0.5, or 0.4-0.6, or any value between 0.001 and 3.0.

A poly alpha-1,6-glucan ether compound as disclosed herein comprises:
(i) poly alpha-1,6-glucan substituted with at least one positively charged organic group;
(ii) a weight average degree of polymerization of at least 5; and
(iii) a degree of substitution of about 0.001 to about 3.0;
   wherein the poly alpha-1,6-glucan comprises a backbone of glucose monomer units, wherein at least 40% of the glucose monomer units are linked via alpha-1,6-glycosidic linkages, and optionally at least 3% of the backbone glucose monomer units have branches via alpha-1,2 and/or alpha-1,3 glycosidic linkages. A positively charged organic group comprises a chain of one or more carbons having one or more hydrogens substituted with another atom or functional group, wherein one or more of the substitutions is with a positively charged group. The term “chain” as used herein encompasses linear, branched, and cyclic arrangements of carbon atoms, as well as combinations thereof.

The poly alpha-1,6-glucan derivative comprises poly alpha-1,6-glucan substituted with at least one positively charged organic group on the polysaccharide backbone and/or on one or more of the optional branches. When substitution occurs on a glucose monomer contained in the backbone, the polysaccharide is derivatized at the 2, 3, and/or 4 glucose carbon position(s) with an organic group as defined herein which is linked to the polysaccharide through an ether (—O—) linkage in place of the hydroxyl group originally present in the underivatized (unsubstituted) poly alpha-1,6-glucan. When substitution occurs on a glucose monomer contained in a branch, the polysaccharide is derivatized at the 2, 3, 4, or 6 glucose carbon position(s) with a positively charged organic group as defined herein which is linked to the polysaccharide through an ether (—O—) linkage.

A poly alpha-1,6-glucan ether compound as disclosed herein is termed a glucan “ether” herein by virtue of comprising the substructure —C_{G}—O—C_{R}—, wherein “—C_{G}—” represents a carbon of a glucose monomer unit of a poly alpha-1,6-glucan ether compound, and wherein “—C_{R}—” is comprised in the positively charged organic group. A cationic poly alpha-1,6-glucan monoether contains one type of a positively charged organic group. A cationic poly alpha-1,6-glucan mixed ether contains two or more types of positively charged organic groups. Mixtures of cationic poly alpha-1,6-glucan ether compounds can also be used.

Compositions disclosed herein can comprise, or consist essentially of, one or more cationic poly alpha-1,6-glucan ether compounds as disclosed herein. In one embodiment, a composition can comprise one poly alpha-1,6-glucan ether compound. In another embodiment, a composition may comprise two or more poly alpha-1,6-glucan ether compounds, for example wherein the positively charged organic groups are different.

A “positively charged organic group” as used herein refers to a chain of one or more carbons that has one or more hydrogens substituted with another atom or functional group, wherein one or more of the substitutions is with a positively charged group. A positively charged group is typically bonded to the terminal carbon atom of the carbon chain. A positively charged organic group is considered to have a net positive charge since it comprises one or more positively charged groups, and comprises a cation (a positively charged ion). An organic group or compound that is “positively charged” typically has more protons than electrons and is repelled from other positively charged substances, but attracted to negatively charged substances. An example of a positively charged groups includes a substituted ammonium group. In some embodiments, a positively charged organic group may have a further substitution, for example with one or more hydroxyl groups, oxygen atoms (forming a ketone group), alkyl groups, and/or at least one additional positively charged group.

In one embodiment, a positively charged organic group comprises a substituted ammonium group, which can be represented by Structure II:

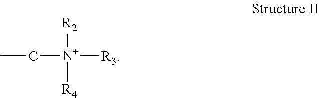

In Structure II, R₂, R₃ and R₄ each independently represent a hydrogen atom, a alkyl group, or a C₆-C₂₄ aryl group. The carbon atom (C) shown in Structure II is part of the carbon chain of the positively charged organic group. The carbon atom is either directly ether-linked to a glucose monomer of poly alpha-1,6-glucan, or is part of a chain of two or more carbon atoms ether-linked to a glucose monomer of poly alpha-1,6-glucan. The carbon atom shown in Structure II can be —CH₂—, —CH— (where a H is substituted with another group such as a hydroxy group), or—C— (where both H's are substituted). While a positively charged organic group herein typically comprises one type of substituted ammonium group, a positively charged organic group can comprise two or more different substituted ammonium groups, for example.

In some embodiments, the alkyl group can be a C₁-C₃₀ alkyl group, for example a methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, C₂₅, C₂₆, C₂₇, C₂₈, C₂₉, or C₃₀ group. In some embodiments, the alkyl group can be a C₁-C₂₄ alkyl group, or a C₁-C₁₈ or a C₆-C₂₀ alkyl group, or a C₁₀-C₁₆ alkyl group, or a C₁-C₄ alkyl group. When a positively charged organic group comprises a substituted ammonium group which has two or more alkyl groups, each alkyl group can be the same as or different from the other.

In some embodiments, the aryl group can be a C₆-C₂₄ aryl group, optionally substituted with alkyl substituents. In some embodiments, the aryl group can be a C₁₂-C₂₄ aryl group, optionally substituted with alkyl substituents, or a C₆-C₁₈ aryl group, optionally substituted with alkyl substituents. In some aspects, a positively charged organic group can comprise a heteroaryl group such as an imidazole group.

A substituted ammonium group can be a “primary ammonium group”, “secondary ammonium group”, “tertiary ammonium group”, or “quaternary ammonium” group, depending on the composition of R₂, R₃ and R₄ in Structure II. A primary ammonium group is an ammonium group represented by Structure II in which each of R₂, R₃ and R₄ is a hydrogen atom (i.e., —C—NH₃⁺).

A secondary ammonium group is an ammonium group represented by Structure II in which each of R₂ and R₃ is a hydrogen atom and R₄ is a C₁-C₃₀ alkyl group or a C₆-C₂₄ aryl group. A “secondary ammonium poly alpha-1,6-glucan ether compound” comprises a positively charged organic group having a monoalkylammonium group. A secondary ammonium poly alpha-1,6-glucan ether compound can be represented in shorthand as a monoalkylammonium poly alpha-1,6-glucan ether, for example monomethyl-, monoethyl-, monopropyl-, monobutyl-, monopentyl-, monohexyl-, monoheptyl-, monooctyl-, monononyl-, monodecyl-, monoundecyl-, monododecyl-, monotridecyl-, monotetradecyl-, monopentadecyl-, monohexadecyl-, monoheptadecyl-, or monooctadecyl-ammonium poly alpha-1,6-glucan ether. These poly alpha-1,6-glucan ether compounds can also be referred to as methyl-, ethyl-, propyl-, butyl-, pentyl-, hexyl-, heptyl-, octyl-, nonyl-, decyl-, undecyl-, dodecyl-, tridecyl-, tetradecyl-, pentadecyl-, hexadecyl-, heptadecyl-, or octadecyl-ammonium poly alpha-1,6-glucan ether compounds, respectively. An octadecyl ammonium group is an example of a monoalkylammonium group wherein each of R₂ and R₃ is a hydrogen atom and R₄ is an octadecyl group. It would be understood that a second member (i.e., R₁) implied by “secondary” in the above nomenclature is the chain of one or more carbons of the positively charged organic group that is ether-linked to a glucose monomer of poly alpha-1,6-glucan.

A tertiary ammonium group is an ammonium group represented by Structure II in which R₂ is a hydrogen atom and each of R₃ and R₄ is independently a C₁-C₂₄ alkyl group or a C₆-C₂₄ aryl group. The alkyl groups can be the same or different. A “tertiary ammonium poly alpha-1,6-glucan ether compound” comprises a positively charged organic group having a dialkylammonium group. A tertiary ammonium poly alpha-1,6-glucan ether compound can be represented in shorthand as a dialkylammonium poly alpha-1,6-glucan ether, for example dimethyl-, diethyl-, dipropyl-, dibutyl-, dipentyl-, dihexyl-, diheptyl-, dioctyl-, dinonyl-, didecyl-, diundecyl-, didodecyl-, ditridecyl-, ditetradecyl-, dipentadecyl-, dihexadecyl-, diheptadecyl-, or dioctadecyl-ammonium poly alpha-1,6-glucan ether. A didodecyl ammonium group is an example of a dialkyl ammonium group, wherein R₂ is a hydrogen atom and each of R₃ and R₄ is a dodecyl group. It would be understood that a third member (i.e., R₁) implied by “tertiary” in the above nomenclature is the chain of one or more carbons of the positively charged organic group that is ether-linked to a glucose monomer of poly alpha-1,6-glucan.

A quaternary ammonium group is an ammonium group represented by Structure II in which each of R₂, R₃ and R₄ is independently a C₁-C₃₀ alkyl group or a C₆-C₂₄ aryl group (i.e., none of R₂, R₃ and R₄ is a hydrogen atom).

In one embodiment, a quaternary ammonium poly alpha-1,6-glucan ether compound can comprise a trialkyl ammonium group, where each of R₂, R₃ and R₄ is independently a C₁-C₃₀ alkyl group. The alkyl groups can all be the same, or two of the alkyl groups can be the same and one different from the others, or all three alkyl groups can be different from one another. A quaternary ammonium poly alpha-1,6-glucan ether compound can be represented in shorthand as a trialkylammonium poly alpha-1,6-glucan ether, for example trimethyl-, triethyl-, tripropyl-, tributyl-, tripentyl-, trihexyl-, triheptyl-, trioctyl-, trinonyl-, tridecyl-, triundecyl-, tridodecyl-, tritridecyl-, tritetradecyl-, tripentadecyl-, trihexadecyl-, triheptadecyl-, or trioctadecyl-ammonium poly alpha-1,6-glucan ether. It would be understood that a fourth member (i.e., R₁) implied by “quaternary” in this nomenclature is the chain of one or more carbons of the positively charged organic group that is ether-linked to a glucose monomer of poly alpha-1,6-glucan. A trimethylammonium group is an example of a trialkyl ammonium group, wherein each of R₂, R₃ and R₄ is a methyl group.

In additional embodiments, a positively charged organic group comprising a substituted ammonium group represented by Structure II can have each of R₂, R₃ and R₄ independently represent a hydrogen atom or an aryl group, such as a phenyl or naphthyl group, or an aralkyl group such as a benzyl group, or a cycloalkyl group such as cyclohexyl or cyclopentyl. Each of R₂, R₃ and R₄ may further comprise an amino group or a hydroxyl group.

The substituted ammonium group of the positively charged organic group is a substituent on a chain of one or more carbons which is ether-linked to a glucose monomer of the alpha-1,6-glucan. The carbon chain can contain from one to 30 carbon atoms. In one embodiment, the carbon chain can be linear. Examples of linear carbon chains include, for example, —CH₂—, —CH₂CH₂—, —CH₂CH₂CH₂—, —CH₂(CH₂)₂CH₂—, —CH₂(CH₂)₃CH₂—, —CH₂(CH₂)₄CH₂—, —CH₂(CH₂)₅CH₂—, —CH₂(CH₂)₆CH₂—, —CH₂(CH₂)₇CH₂—, —CH₂(CH₂)₈CH₂—, —CH₂(CH₂)₉CH₂—, and—CH₂(CH₂)₁₀CH₂—; longer carbon chains can also be used, if desired. In another embodiment, the carbon chain can be branched, meaning the carbon chain is substituted with one or more alkyl groups, for example methyl, ethyl, propyl, or butyl groups. The point of substitution can be anywhere along the carbon chain. Examples of branched carbon chains include —CH(CH₃)CH₂—, —CH(CH₃)CH₂CH₂—, —CH₂CH(CH₃)CH₂—, —CH(CH₂CH₃)CH₂—, —CH(CH₂CH₃)CH₂CH₂—, —CH₂CH(CH₂CH₃)CH₂—, —CH(CH₂CH₂CH₃)CH₂—, —CH(CH₂CH₂CH₃)CH₂CH₂—, and—CH₂CH(CH₂CH₂CH₃)CH₂—; longer branched carbon chains can also be used, if desired. Where the positively charged group is a substituted ammonium group, the first carbon atom in the chain is ether-linked to a glucose monomer of the poly alpha-1,6-glucan, and the last carbon atom of the chain in each of these examples is represented by the C in Structure II.

In another embodiment, the chain of one or more carbons is further substituted with one or more hydroxyl groups. Examples of a carbon chain having one or more substitutions with a hydroxyl group include hydroxyalkyl (e.g., hydroxyethyl, hydroxypropyl, hydroxybutyl, hydroxypentyl, hydroxyhexyl, hydroxyheptyl, hydroxyoctyl) groups and dihydroxyalkyl (e.g., dihydroxyethyl, dihydroxypropyl, dihydroxybutyl, dihydroxypentyl, dihydroxyhexyl, dihydroxyheptyl, dihydroxyoctyl) groups. Examples of hydroxyalkyl and dihydroxyalkyl (diol) carbon chains include-CH(OH)—, —CH(OH)CH₂—, —C(OH)₂CH₂—, —CH₂CH(OH)CH₂—, —CH(OH)CH₂CH₂—, —CH(OH)CH(OH)CH₂—, —CH₂CH₂CH(OH)CH₂—, —CH₂CH(OH)CH₂CH₂—, —CH(OH)CH₂CH₂CH₂—, —CH₂CH(OH)CH(OH)CH₂—, —CH(OH)CH(OH)CH₂CH₂— and —CH(OH)CH₂CH(OH)CH₂—. In each of these examples, the first carbon atom of the chain is ether-linked to a glucose monomer of poly alpha-1,6-glucan, and the last carbon atom of the chain is linked to a positively charged group. Where the positively charged group is a substituted ammonium group, the last carbon atom of the chain in each of these examples is represented by the C in Structure II.

In some aspects, the substituted ammonium group of the positively charged organic group is a substituent on a polyether chain that is ether-linked to a glucose monomer of the alpha-1,6-glucan. A polyether chain can comprise repeat units of (—CH₂CH₂O—), (—CH₂CH(CH₃)O—), or a mixture thereof, for example. The total number of repeat units of a polyether chain herein can be in the range of 2 to 100 (e.g., 4-100), for instance.

An example of a quaternary ammonium poly alpha-1,6-glucan ether compound is trimethylammonium hydroxypropyl poly alpha-1,6-glucan. The positively charged organic group of this ether compound can be represented by the following structure:

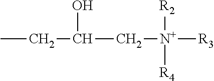

where each of R₂, R₃ and R₄ is a methyl group. The structure above is an example of a quaternary ammonium hydroxypropyl group.

Where a carbon chain of a positively charged organic group has a substitution in addition to a substitution with a positively charged group, such additional substitution may be with one or more hydroxyl groups, oxygen atoms (thereby forming an aldehyde or ketone group), alkyl groups (e.g., methyl, ethyl, propyl, butyl), and/or additional positively charged groups. A positively charged group is typically bonded to the terminal carbon atom of the carbon chain. A positively charged group can also comprise one or more imidazoline rings.

A cationic poly alpha-1,6-glucan ether compound as disclosed herein is a salt. The counter ion for the positively charged organic group can be any anion, including an acetate, borate, bromate, bromide, carbonate, chlorate, chloride, chlorite, dihydrogen phosphate, fluoride, hydrogen carbonate, hydrogen phosphate, hydrogen sulfate, hydrogen sulfide, hydrogen sulfite, hydroxide, hypochlorite, iodate, iodide, nitrate, nitride, nitrite, oxalate, oxide, perchlorate, permanganate, phosphate, phosphide, phosphite, silicate, stannate, stannite, sulfate, sulfide, sulfite, tartrate, or thiocyanate anion. In an aqueous solution, a poly alpha-1,6-glucan ether compound is in a cationic form. The positively charged organic groups of a cationic poly alpha-1,6-glucan ether compound can interact with salt anions that may be present in an aqueous solution, such as those listed herein above.

A poly alpha-1,6-glucan ether compound herein can contain one type of etherified cationic organic group, for example. In some aspects, a poly alpha-1,6-glucan ether compound can contain two or more different types of etherified, and/or otherwise linked, organic groups, where at least one of the organic groups is an ether-linked cationic group. Examples of other types of groups include nonionic ether-linked organic groups and anionic ether-linked organic groups. A poly alpha-1,6-glucan ether compound as presently disclosed can optionally be characterized by cationic charge density (CCD). CCD can be expressed as milliequivalents of charge per gram of compound (meq/g) and can be determined according to the Examples (below). Poly alpha-1,6-glucan ether compounds can be characterized as having a CCD of about 0.05-12, 0.1-8, 0.1-4, 0.1-3, or 0.1-2.6 meq/g, for instance. In some aspects, a poly alpha-1,6-glucan ether compound can have a DoS with respect to substitutions that are not cationic of less than about 1.0, 0.5, 0.2, or 0.1, or have no substitutions that are not cationic. In some aspects, a poly alpha-1,6-glucan ether compound can have a DoS with respect to hydrophobic substitutions (e.g., benzyl substitution) of less than about 1.0, 0.5, 0.2, or 0.1, or have no substitutions that are hydrophobic (e.g., no benzyl substitution).

In one embodiment, the poly alpha-1,6-glucan ether compound comprises a positively charged organic group, wherein the positively charged organic group comprises a substituted ammonium group. In one embodiment, from about 0.5% to about 50% of the backbone glucose monomer units of the ether compound have branches via alpha-1,2 glycosidic linkages, and the positively charged organic group comprises a substituted ammonium group. In one embodiment, from about 3% to about 35% of the backbone glucose monomer units of the ether compound have branches via alpha-1,2 glycosidic linkages, and the substituted ammonium group comprises a substituted ammonium group. In one embodiment, from about 0.5% to about 50% of the backbone glucose monomer units of the ether compound have branches via alpha-1,2 glycosidic linkages, and the substituted ammonium group comprises a trimethyl ammonium group. In one embodiment, from about 3% to about 35% of the backbone glucose monomer units of the ether compound have branches via alpha-1,2 glycosidic linkages, and the substituted ammonium group comprises a trimethyl ammonium group.

In one embodiment, the poly alpha-1,6-glucan ether compound comprises a positively charged organic group, wherein the positively charged organic group comprises a trimethylammonium hydroxyalkyl group. In one embodiment, from about 0.5% to about 50% of the backbone glucose monomer units of the ether compound have branches via alpha-1,2 glycosidic linkages, and the positively charged organic group comprises a trimethylammonium hydroxyalkyl group. In one embodiment, from about 3% to about 35% of the backbone glucose monomer units of the ether compound have branches via alpha-1,2 glycosidic linkages, and the positively charged organic group comprises a trimethylammonium hydroxyalkyl group. In one embodiment, from about 0.5% to about 50% of the backbone glucose monomer units of the ether compound have branches via alpha-1,2 glycosidic linkages, and the trimethylammonium hydroxyalkyl group comprises a trimethylammonium hydroxypropyl group. In one embodiment, from about 3% to about 35% of the backbone glucose monomer units of the ether compound have branches via alpha-1,2 glycosidic linkages, and the trimethylammonium hydroxyalkyl group comprises a trimethylammonium hydroxypropyl group.

In one embodiment, the poly alpha-1,6-glucan ether compound comprises a positively charged organic group, wherein the positively charged organic group comprises a substituted ammonium group comprising a quaternary ammonium group. In one embodiment, from about 0.5% to about 50% of the backbone glucose monomer units of the ether compound have branches via alpha-1,2 glycosidic linkages, and the quaternary ammonium group comprises at least one C₁ to C₁₈ alkyl group. In one embodiment, from about 3% to about 35% of the backbone glucose monomer units of the ether compound have branches via alpha-1,2 glycosidic linkages, the quaternary ammonium group comprises at least one C₁ to C₁₈ alkyl group. In one embodiment, from about 0.5% to about 50% of the backbone glucose monomer units of the ether compound have branches via alpha-1,2 glycosidic linkages, and the quaternary ammonium group comprises at least one C₁ to C₄ alkyl group. In one embodiment, from about 3% to about 35% of the backbone glucose monomer units of the ether compound have branches via alpha-1,2 glycosidic linkages, and the quaternary ammonium group comprises at least one C₁ to C₄ alkyl group. In one embodiment, from about 0.5% to about 50% of the backbone glucose monomer units of the ether compound have branches via alpha-1,2 glycosidic linkages, and the quaternary ammonium group comprises at least one C₁₀ to C₁₆ alkyl group. In one embodiment, from about 3% to about 35% of the backbone glucose monomer units of the ether compound have branches via alpha-1,2 glycosidic linkages, and the quaternary ammonium group comprises at least one C₁₀ to C₁₆ alkyl group.

In one embodiment, the poly alpha-1,6-glucan ether compound comprises a quaternary ammonium group comprising one C₁₀ to C₁₆ alkyl group, and the quaternary ammonium group further comprises two methyl groups. In one embodiment, from about 0.5% to about 50% of the backbone glucose monomer units of the ether compound have branches via alpha-1,2 glycosidic linkages, and the quaternary ammonium group comprising one C₁₀ to C₁₆ alkyl group further comprises two methyl groups. In one embodiment, from about 3% to about 35% of the backbone glucose monomer units of the ether compound have branches via alpha-1,2 glycosidic linkages, and the quaternary ammonium group comprising one C₁₀ to C₁₆ alkyl group further comprises two methyl groups.

In one embodiment, from about 0.5% to about 50% of the backbone glucose monomer units of the ether compound have branches via alpha-1,2 glycosidic linkages, and the quaternary ammonium group comprises one C₁₀ alkyl group and two methyl groups. In one embodiment, from about 3% to about 35% of the backbone glucose monomer units of the ether compound have branches via alpha-1,2 glycosidic linkages, and the quaternary ammonium group comprises one C₁₀ alkyl group and two methyl groups.

In one embodiment, the poly alpha-1,6-glucan ether compound comprises a positively charged organic group, wherein the positively charged organic group comprises a quaternary ammonium hydroxyalkyl group. In one embodiment, from about 0.5% to about 50% of the backbone glucose monomer units of the ether compound have branches via alpha-1,2 glycosidic linkages, and the positively charged organic group comprises a quaternary ammonium hydroxyalkyl group. In one embodiment, from about 3% to about 35% of the backbone glucose monomer units of the ether compound have branches via alpha-1,2 glycosidic linkages, and the positively charged organic group comprises a quaternary ammonium hydroxyalkyl group. In one embodiment, from about 0.5% to about 50% of the backbone glucose monomer units of the ether compound have branches via alpha-1,2 glycosidic linkages, and the quaternary ammonium hydroxyalkyl group comprises a quaternary ammonium hydroxymethyl group, a quaternary ammonium hydroxyethyl group, or a quaternary ammonium hydroxypropyl group. In one embodiment, from about 3% to about 35% of the backbone glucose monomer units of the ether compound have branches via alpha-1,2 glycosidic linkages, and the quaternary ammonium hydroxyalkyl group comprises a quaternary ammonium hydroxymethyl group, a quaternary ammonium hydroxyethyl group, or a quaternary ammonium hydroxypropyl group. In one embodiment, from about 0.5% to about 50% of the backbone glucose monomer units of the ether compound have branches via alpha-1,2 glycosidic linkages, and the quaternary ammonium hydroxyalkyl group comprises a quaternary ammonium hydroxymethyl group. In one embodiment, from about 3% to about 35% of the backbone glucose monomer units of the ether compound have branches via alpha-1,2 glycosidic linkages, and the quaternary ammonium hydroxyalkyl group comprises a quaternary ammonium hydroxymethyl group. In one embodiment, from about 0.5% to about 50% of the backbone glucose monomer units of the ether compound have branches via alpha-1,2 glycosidic linkages, and the quaternary ammonium hydroxyalkyl group comprises a quaternary ammonium hydroxyethyl group. In one embodiment, from about 3% to about 35% of the backbone glucose monomer units of the ether compound have branches via alpha-1,2 glycosidic linkages, and the quaternary ammonium hydroxyalkyl group comprises a quaternary ammonium hydroxyethyl group. In one embodiment, from about 0.5% to about 50% of the backbone glucose monomer units of the ether compound have branches via alpha-1,2 glycosidic linkages, and the quaternary ammonium hydroxyalkyl group comprises a quaternary ammonium hydroxypropyl group. In one embodiment, from about 3% to about 35% of the backbone glucose monomer units of the ether compound have branches via alpha-1,2 glycosidic linkages, and the quaternary ammonium hydroxyalkyl group comprises a quaternary ammonium hydroxypropyl group.

A poly alpha-1,6-glucan ether compound herein can have a biodegradability as determined by the Carbon Dioxide Evolution Test Method (OECD Guideline 301B, incorporated herein by reference; e.g., refer to test methods of below Examples) of at least 10% after 90 days of testing, for example. In some aspects, the biodegradability is about, or at least about 5%, 10%, 15%, 20%, 25%, 30%, 35%, 40%, 45%, 50%, 55%, 60%, 65%, 70%, 75%, 80%, 85%, 90%, 5-60%, 5-80%, 5-90%, 40-70%, 50-70%, 60-70%, 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 30, 60, or 90 days of testing.

Poly alpha-1,6-glucan ether compounds containing a positively charged organic group, such as a trimethyl ammonium group, a substituted ammonium group, or a quaternary ammonium group, can be prepared using methods similar to those disclosed in published patent application US 2016/0311935, which is incorporated herein by reference in its entirety. US 2016/0311935 discloses poly alpha-1,3-glucan ether compounds comprising positively charged organic groups and having a degree of substitution up to about 3.0, as well as methods of producing such ether compounds. Cationic poly alpha-1,6-glucan ethers may be prepared by contacting poly alpha-1,6-glucan with at least one etherification agent comprising a positively charged organic group under alkaline conditions. In one embodiment, alkaline conditions are prepared by contacting the poly alpha-1,6-glucan with a solvent and one or more alkali hydroxides to provide a solution or mixture, and at least one etherification agent is then added. In another embodiment, at least one etherification agent can be contacted with poly alpha-1,6-glucan and solvent, and then the alkali hydroxide can be added. The mixture of poly alpha-1,6-glucan, etherification agent, and alkali hydroxides can be maintained at ambient temperature or optionally heated, for example to a temperature between about 25° C. and about 200° C., depending on the etherification agent and/or solvent employed. Reaction time for producing a poly alpha-1,6-glucan ether will vary corresponding to the reaction temperature, with longer reaction time necessary at lower temperatures and lower reaction time necessary at higher temperatures.

Typically, the solvent comprises water. Optionally, additional solvent can be added to the alkaline solution, for example alcohols such as isopropanol, acetone, dioxane, and toluene. Alternatively, solvents such as lithium chloride(LiCl)/N, N-dimethyl-acetamide (DMAc), SO₂/diethylamine (DEA)/dimethyl sulfoxide (DMSO), LiCl/1,3-dimethy-2-imidazolidinone (DMI), N,N-dimethylformamide (DMF)/N₂O₄, DMSO/tetrabutyl-ammonium fluoride trihydrate (TBAF), N-methylmorpholine-N-oxide (NMMO), Ni(tren)(OH)₂ [tren=tris(2-aminoethyl)amine] aqueous solutions and melts of LiClO₄·3H₂O, NaOH/urea aqueous solutions, aqueous sodium hydroxide, aqueous potassium hydroxide, formic acid, and ionic liquids can be used.

In one embodiment, an etherification agent may be one that can etherify poly alpha-1,6-glucan with a positively charged organic group, where the carbon chain of the positively charged organic group only has a substitution with a positively charged group (e.g., substituted ammonium group such as trimethylammonium). Examples of such etherification agents include dialkyl sulfates, dialkyl carbonates, alkyl halides (e.g., alkyl chloride), iodoalkanes, alkyl triflates (alkyl trifluoromethanesulfonates) and alkyl fluorosulfonates, where the alkyl group(s) of each of these agents has one or more substitutions with a positively charged group (e.g., substituted ammonium group such as trimethylammonium). Other examples of such etherification agents include dimethyl sulfate, dimethyl carbonate, methyl chloride, iodomethane, methyl triflate and methyl fluorosulfonate, where the methyl group(s) of each of these agents has a substitution with a positively charged group (e.g., substituted ammonium group such as trimethylammonium). Other examples of such etherification agents include diethyl sulfate, diethyl carbonate, ethyl chloride, iodoethane, ethyl triflate and ethyl fluorosulfonate, where the ethyl group(s) of each of these agents has a substitution with a positively charged group (e.g., substituted ammonium group such as trimethylammonium). Other examples of such etherification agents include dipropyl sulfate, dipropyl carbonate, propyl chloride, iodopropane, propyl triflate and propyl fluorosulfonate, where the propyl group(s) of each of these agents has one or more substitutions with a positively charged group (e.g., substituted ammonium group such as trimethylammonium). Other examples of such etherification agents include dibutyl sulfate, dibutyl carbonate, butyl chloride, iodobutane and butyl triflate, where the butyl group(s) of each of these agents has one or more substitutions with a positively charged group (e.g., substituted ammonium group such as trimethylammonium). Other example of etherification agent includes halides of imidazoline ring containing compounds.

In another embodiment, an etherification agent may be one that can etherify poly alpha-1,6-glucan with a positively charged organic group, where the carbon chain of the positively charged organic group has a substitution, for example a hydroxyl group, in addition to a substitution with a positively charged group, for example a substituted ammonium group such as trimethylammonium. Examples of such etherification agents include hydroxyalkyl halides (e.g., hydroxyalkyl chloride) such as hydroxypropyl halide and hydroxybutyl halide, where a terminal carbon of each of these agents has a substitution with a positively charged group (e.g., substituted ammonium group such as trimethylammonium); an example is 3-chloro-2-hydroxypropyl-trimethylammonium. Additional examples of etherification agents comprising a positively charged organic group include 2,3-epoxypropyltrimethylammonium chloride, 3-chloro-2-hydroxypropyl dodecyldimethylammonium chloride, 3-chloro-2-hydroxypropyl cocoalkyldimethylammonium chloride, 3-chloro-2-hydroxypropyl stearyldimethylammonium chloride, and quaternary ammonium compounds such as halides of imidazoline ring containing compounds. Other examples of such etherification agents include alkylene oxides such as propylene oxide (e.g., 1,2-propylene oxide) and butylene oxide (e.g., 1,2-butylene oxide; 2,3-butylene oxide), where a terminal carbon of each of these agents has a substitution with a positively charged group (e.g., substituted ammonium group such as trimethylammonium).

When producing a poly alpha-1,6-glucan ether compound comprising two or more different positively charged organic groups, two or more different etherification agents would be used, accordingly. Any of the etherification agents disclosed herein may be combined to produce poly alpha-1,6-glucan ether compounds having two or more different positively charged organic groups. Such two or more etherification agents may be used in the reaction at the same time, or may be used sequentially in the reaction. When used sequentially, any of the temperature-treatment (e.g., heating) steps may optionally be used between each addition. Sequential introduction of etherification agents may be used to control the desired DoS of each positively charged organic group. In general, a particular etherification agent would be used first if the organic group it forms in the ether product is desired at a higher DoS compared to the DoS of another organic group to be added.

The amount of etherification agent to be contacted with poly alpha-1,6-glucan in a reaction under alkaline conditions can be selected based on the degree of substitution desired in the ether compound. The amount of ether substitution groups on each monomeric unit in poly alpha-1,6-glucan ether compounds can be determined using nuclear magnetic resonance (NMR) spectroscopy. In general, an etherification agent can be used in a quantity of at least about 0.01, 0.02, 0.03, 0.04, or 0.05 mole per mole of poly glucan. There is no upper limit to the quantity of etherification agent that can be used.

Reactions for producing poly alpha-1,6-glucan ether compounds can optionally be carried out in a pressure vessel such as a Parr reactor, an autoclave, a shaker tube, or any other pressure vessel well known in the art. Optionally, poly alpha-1,6-glucan ether compounds can be prepared under an inert atmosphere, with or without heating. As used herein, the term “inert atmosphere” refers to a nonreactive gas atmosphere such as nitrogen, argon, or helium

After contacting the poly alpha-1,6-glucan, solvent, alkali hydroxide, and etherification reagent for a sufficient reaction time to produce a poly alpha-1,6-glucan ether compound, the reaction mixture can optionally be filtered by any means known in the art which allows removal of liquids from solids.

Following etherification, one or more acids are optionally added to the reaction mixture to lower the pH to a neutral pH range that is neither substantially acidic nor substantially acidic, for example a pH of about 6-8, or about 6.0, 6.2, 6.4, 6.6, 6.8, 7.0, 7.2, 7.4, 7.6, 7.8, or 8.0, if desired. Various acids useful for this purpose include sulfuric, acetic, hydrochloric, nitric, any mineral (inorganic) acid, any organic acid, or any combination of these acids.

A poly alpha-1,6-glucan ether compound can optionally be washed one or more times with a liquid that does not readily dissolve the compound. For example, a poly alpha-1,6-glucan ether can be washed with water, alcohol, isopropanol, acetone, aromatics, or any combination of these, depending on the solubility of the ether compound therein (where lack of solubility is desirable for washing). In general, a solvent comprising an organic solvent such as alcohol is preferred for the washing. A poly alpha-1,6-glucan ether product can be washed one or more times with an aqueous solution containing methanol or ethanol, for example. For example, 70-95 wt % ethanol can be used to wash the product. In another embodiment, a poly alpha-1,6-glucan ether product can be washed with a methanol:acetone (e.g., 60:40) solution.

A poly alpha-1,6-glucan ether compound can optionally purified by membrane filtration.

A poly alpha-1,6-glucan ether produced using the methods disclosed above can be isolated. This step can be performed before or after neutralization and/or washing steps using a funnel, centrifuge, press filter, or any other method or equipment known in the art that allows removal of liquids from solids. An isolated poly alpha-1,6-glucan ether product can be dried using any method known in the art, such as vacuum drying, air drying, or freeze drying.

Any of the above etherification reactions can be repeated using a poly alpha-1,6-glucan ether product as the starting material for further modification. This approach may be suitable for increasing the DoS of a positively charged organic group, and/or adding one or more different positively charged organic groups to the ether product. Also, this approach may be suitable for adding one or more organic groups that are not positively charged, such as an alkyl group (e.g., methyl, ethyl, propyl, butyl) and/or a hydroxyalkyl group (e.g., hydroxyethyl, hydroxypropyl, hydroxybutyl). Any of the above etherification agents, but without the substitution with a positively charged group, can be used for this purpose.

Depending upon the desired application, compositions comprising a cationic poly alpha-1,6-glucan ether compound as disclosed herein can be formulated, for example, blended, mixed, or incorporated into, with one or more other materials and/or active ingredients suitable for use in various compositions, for example compositions for use in laundry care, textile/fabric care, other home care applications, and/or personal care products. The term “composition comprising a cationic poly alpha-1,6-glucan ether compound” in this context may include, for example, aqueous formulations, rheology modifying compositions, fabric treatment/care compositions, laundry care formulations/compositions, fabric softeners or personal care compositions (hair, skin and oral care), each comprising a cationic poly alpha-1,6-glucan ether compound as disclosed herein.

As used herein, the term “effective amount” refers to the amount of the substance used or administered that is suitable to achieve the desired effect. The effective amount of material may vary depending upon the application. One of skill in the art will typically be able to determine an effective amount for a particular application or subject without undo experimentation.

The term “resistance to enzymatic hydrolysis” refers to the relative stability of the poly alpha-1,6-glucan ether to enzymatic hydrolysis. Having a resistance to hydrolysis is important for the use of these materials in applications wherein enzymes are present, such as in detergent, fabric care, and/or laundry care applications. In some embodiments, the poly alpha-1,6-glucan ether compound is resistant to cellulases. In other embodiments, the poly alpha-1,6-glucan ether compound is resistant to proteases. In still further embodiments, the poly alpha-1,6-glucan ether compound is resistant to amylases. In yet other embodiments, the poly alpha-1,6-glucan ether is resistant to mannanases. In other embodiments, the poly alpha-1,6-glucan ether is resistant to multiple classes of enzymes, for example, two or more cellulases, proteases, amylases, mannanases, or combinations thereof. Resistance to any particular enzyme will be defined as having at least 10, 20, 30, 40, 50, 60, 70, 80, 90, 95 or 100% of the materials remaining after treatment with the respective enzyme. The percentage remaining may be determined by measuring the supernatant after enzyme treatment using SEC-HPLC. The assay to measure enzyme resistance can be determined using the following procedure: A sample of the poly alpha-1,6-glucan ether compound is added to water in a vial and mixed using a PTFE magnetic stir bar to create a 1 percent by weight aqueous solution. The aqueous mixture is produced at pH 7.0 and 20° C. After the poly alpha-1,6-glucan ether compound thereof has completely dissolved, 1.0 milliliter (mL) (1 percent by weight of the enzyme formulation) of cellulase (PURADEX® EGL), amylase (PURASTAR® ST L) protease (SAVINASE® 16.0 L), or lipase (Lipex® 100 L) is added and mixed for 72 hours (hrs) at 20° C. After 72 hrs of stirring, the reaction mixture is heated to 70° C. for 10 minutes to inactivate the added enzyme, and the resulting mixture is cooled to room temperature and centrifuged to remove any precipitate. The supernatant is analyzed by SEC-HPLC for recovered poly alpha-1,6-glucan ether compound and compared to a control where no enzyme was added to the reaction mixture. Percent changes in area counts for the respective poly alpha-1,6-glucan ether compound thereof may be used to test the relative resistance of the materials to the respective enzyme treatment. Percent changes in area versus the total will be used to assess the relative amount of materials remaining after treatment with a particular enzyme. Materials having a percent recovery of at least 10%, preferably at least 50, 60, 70, 80, 90, 95 or 100% will be considered “resistant” to the respective enzyme treatment.

The phrase “aqueous composition” herein refers to a solution or mixture in which the solvent is at least about 1% by weight of water and which comprises the poly alpha-1,6-glucan ether.

The terms “hydrocolloid” and “hydrogel” are used interchangeably herein. A hydrocolloid refers to a colloid system in which water is the dispersion medium. A “colloid” herein refers to a substance that is microscopically dispersed throughout another substance. Therefore, a hydrocolloid herein can also refer to a dispersion, emulsion, mixture, or solution of the cationic poly alpha-1,6-glucan ether compound in water or aqueous solution.

The term “aqueous solution” herein refers to a solution in which the solvent is water. The poly alpha-1,6-glucan ether compound can be dispersed, mixed, and/or dissolved in an aqueous solution. An aqueous solution can serve as the dispersion medium of a hydrocolloid herein.

The terms “dispersant” and “dispersion agent” are used interchangeably herein to refer to a material that promotes the formation and stabilization of a dispersion of one substance in another. A “dispersion” herein refers to an aqueous composition comprising one or more particles, for example, any ingredient of a personal care product, pharmaceutical product, food product, household product or industrial product that are scattered, or uniformly distributed, throughout the aqueous composition. It is believed that the cationic poly alpha-1,6-glucan ether compound can act as dispersants in aqueous compositions disclosed herein.

The term “viscosity” as used herein refers to the measure of the extent to which a fluid or an aqueous composition such as a hydrocolloid resists a force tending to cause it to flow. Various units of viscosity that can be used herein include centipoise (cps) and Pascal-second (Pas). A centipoise is one one-hundredth of a poise; one poise is equal to 0.100 kg·m⁻¹·s⁻¹. Thus, the terms “viscosity modifier” and “viscosity-modifying agent” as used herein refer to anything that can alter/modify the viscosity of a fluid or aqueous composition.

The terms “fabric”, “textile”, and “cloth” are used interchangeably herein to refer to a woven or non-woven material having a network of natural and/or artificial fibers. Such fibers can be thread or yarn, for example.

A “fabric care composition” herein is any composition suitable for treating fabric in some manner. Suitable examples of such a composition include non-laundering fiber treatments (for desizing, scouring, mercerizing, bleaching, coloration, dying, printing, bio-polishing, anti-microbial treatments, anti-wrinkle treatments, stain resistance treatments, etc.), laundry care compositions (e.g., laundry care detergents), and fabric softeners.

The terms “detergent composition”, “heavy duty detergent” and “all-purpose detergent” are used interchangeably herein to refer to a composition useful for regular washing of a substrate, for example, dishware, cutlery, vehicles, fabrics, carpets, apparel, white and colored textiles at any temperature. Detergent compositions for treating of fabrics, hard surfaces and any other surfaces in the area of fabric and home care, include: laundry detergents, fabric conditioners (including softeners), laundry and rinse additives and care compositions, fabric freshening compositions, laundry prewash, laundry pretreat, hard surface treatment compositions, car care compositions, dishwashing compositions (including hand dishwashing and automatic dishwashing products), air care products, detergent contained on or in a porous substrate or nonwoven sheet, and other cleaner products for consumer or institutional use

The terms “cellulase” and “cellulase enzyme” are used interchangeably herein to refer to an enzyme that hydrolyzes β-1,4-D-glucosidic linkages in cellulose, thereby partially or completely degrading cellulose. Cellulase can alternatively be referred to as “3-1,4-glucanase”, for example, and can have endocellulase activity (EC 3.2.1.4), exocellulase activity (EC 3.2.1.91), or cellobiase activity (EC 3.2.1.21). A cellulase in certain embodiments herein can also hydrolyze β-1,4-D-glucosidic linkages in cellulose ether derivatives such as carboxymethyl cellulose. “Cellulose” refers to an insoluble polysaccharide having a linear chain of β-1,4-linked D-glucose monomeric units.

As used herein, the term “fabric hand” or “handle” is meant people's tactile sensory response towards fabric which may be physical, physiological, psychological, social or any combination thereof. In some embodiments, the fabric hand may be measured using a PHABROMETER® System (available from Nu Cybertek, Inc. Davis, California) for measuring the relative hand value as given by the American Association of Textile Chemists and Colorists (AATCC test method “202-2012, Relative Hand Value of Textiles: Instrumental Method”).

The composition can be in the form of a liquid, a gel, a powder, a hydrocolloid, an aqueous solution, a granule, a tablet, a capsule, a bead or pastille a single compartment sachet, a multi-compartment sachet, a single compartment pouch, or a multi-compartment pouch. In some embodiments, the composition is in the form of a liquid, a gel, a powder, a single compartment sachet, or a multi-compartment sachet.

In some embodiments, compositions comprising a cationic poly alpha-1,6-glucan ether compound as disclosed herein can be in the form of a fabric care composition. A fabric care composition can be used for hand wash, machine wash and/or other purposes such as soaking and/or pretreatment of fabrics, for example. A fabric care composition may take the form of, for example, a laundry detergent; fabric conditioner; any wash-, rinse-, or dryer-added product; unit dose or spray. Fabric care compositions in a liquid form may be in the form of an aqueous composition. In other embodiments, a fabric care composition can be in a dry form such as a granular detergent or dryer-added fabric softener sheet. Other non-limiting examples of fabric care compositions can include: granular or powder-form all-purpose or heavy-duty washing agents; liquid, gel or paste-form all-purpose or heavy-duty washing agents; liquid or dry fine-fabric (e.g. delicates) detergents; cleaning auxiliaries such as bleach additives, “stain-stick”, or pre-treatments; substrate-laden products such as dry and wetted wipes, pads, or sponges; sprays and mists; water-soluble unit dose articles.

In some embodiments, compositions comprising the cationic poly alpha-1,6-glucan ether compound can be in the form of a personal care product. Personal care products include, but are not limited to, hair care compositions, skin care compositions, sun care compositions, body cleanser compositions, oral care compositions, wipes, beauty care compositions, cosmetic compositions, antifungal compositions, and antibacterial compositions. The personal care products can include cleansing, cleaning, protecting, depositing, moisturizing, conditioning, occlusive barrier, and emollient compositions.

As used herein, “personal care products” also includes products used in the cleaning, bleaching and/or disinfecting of hair, skin, scalp, and teeth, including, but not limited to shampoos, body lotions, shower gels, topical moisturizers, toothpaste, toothgels, mouthwashes, mouth rinses, anti-plaque rinses, and/or other topical cleansers. In some embodiments, these products are utilized on humans, while in other embodiments, these products find use with non-human animals (e.g., in veterinary applications). In one aspect, “personal care products” includes hair care products. The hair care product can be in the form of a powder, paste, gel, liquid, oil, ointment, spray, foam, tablet, a hair shampoo, a hair conditioner rinse or any combination thereof.

The product formulation comprising the cationic poly alpha-1,6-glucan ether compound described herein may be optionally diluted with water, or a solution predominantly comprised of water, to produce a formulation with the desired poly alpha-1,6-glucan ether compound concentration for the target application. Clearly one of skill in the art can adjust the reaction components and/or dilution amounts to achieve the desired poly alpha-1,6-glucan ether concentration for the chosen personal care product.

The personal care compositions described herein may further comprise one or more dermatologically or cosmetically acceptable components known or otherwise effective for use in hair care or other personal care products, provided that the optional components are physically and chemically compatible with the essential components described herein, or do not otherwise unduly impair product stability, aesthetics, or performance. Non-limiting examples of such optional components are disclosed in International Cosmetic Ingredient Dictionary, Ninth Edition, 2002, and CTFA Cosmetic Ingredient Handbook, Tenth Edition, 2004.

In one embodiment, the dermatologically acceptable carrier may comprise from about 10 wt % to about 99.9 wt %, alternatively from about 50 wt % to about 95 wt %, and alternatively from about 75 wt % to about 95 wt %, of a dermatologically acceptable carrier. Carriers suitable for use with the composition(s) may include, for example, those used in the formulation of hair sprays, mousses, tonics, gels, skin moisturizers, lotions, and leave-on conditioners. The carrier may comprise water; organic oils; silicones such as volatile silicones, amino or non-amino silicone gums or oils, and mixtures thereof; mineral oils; plant oils such as olive oil, castor oil, rapeseed oil, coconut oil, wheatgerm oil, sweet almond oil, avocado oil, macadamia oil, apricot oil, safflower oil, candlenut oil, false flax oil, tamanu oil, lemon oil and mixtures thereof; waxes; and organic compounds such as C₂-C₁₀ alkanes, acetone, methyl ethyl ketone, volatile organic C₁-C₁₂ alcohols, esters (with the understanding that the choice of ester(s) may be dependent on whether or not it may act as a carboxylic acid ester substrates for the perhydrolases) of C₁-C₂₀ acids and of C₁-C₈ alcohols such as methyl acetate, butyl acetate, ethyl acetate, and isopropyl myristate, dimethoxyethane, diethoxyethane, C₁₀-C₃₀ fatty alcohols such as lauryl alcohol, cetyl alcohol, stearyl alcohol, and behenyl alcohol; C₁₀-C₃₀ fatty acids such as lauric acid and stearic acid; C₁₀-C₃₀ fatty amides such as lauric diethanolamide; C₁₀-C₃₀ fatty alkyl esters such as C₁₀-C₃₀ fatty alkyl benzoates; hydroxypropylcellulose, and mixtures thereof. In one embodiment, the carrier comprises water, fatty alcohols, volatile organic alcohols, and mixtures thereof.

The composition(s) disclosed herein further may comprise from about 0.1% to about 10%, and alternatively from about 0.2% to about 5.0%, of a gelling agent to help provide the desired viscosity to the composition(s). Non-limiting examples of suitable optional gelling agents include crosslinked carboxylic acid polymers; unneutralized crosslinked carboxylic acid polymers; unneutralized modified crosslinked carboxylic acid polymers; crosslinked ethylene/maleic anhydride copolymers; unneutralized crosslinked ethylene/maleic anhydride copolymers (e.g., EMA 81 commercially available from Monsanto); unneutralized crosslinked alkyl ether/acrylate copolymers (e.g., SALCARE™ SC90 commercially available from Allied Colloids); unneutralized crosslinked copolymers of sodium polyacrylate, mineral oil, and PEG-1 trideceth-6 (e.g., SALCARE™ SC91 commercially available from Allied Colloids); unneutralized crosslinked copolymers of methyl vinyl ether and maleic anhydride (e.g., STABILEZE™ QM-PVM/MA copolymer commercially available from International Specialty Products); hydrophobically modified nonionic cellulose polymers; hydrophobically modified ethoxylate urethane polymers (e.g., UCARE™ Polyphobe Series of alkali swellable polymers commercially available from Union Carbide); and combinations thereof. In this context, the term “unneutralized” means that the optional polymer and copolymer gelling agent materials contain unneutralized acid monomers. Preferred gelling agents include water-soluble unneutralized crosslinked ethylene/maleic anhydride copolymers, water-soluble unneutralized crosslinked carboxylic acid polymers, water-soluble hydrophobically modified nonionic cellulose polymers and surfactant/fatty alcohol gel networks such as those suitable for use in hair conditioning products.

The cationic poly alpha-1,6-glucan ether compounds described herein may be incorporated into hair care compositions and products, such as but not limited to, hair conditioning agents. Hair conditioning agents are well known in the art, see for example Green et al. (WO0107009), and are available commercially from various sources. Suitable examples of hair conditioning agents include, but are not limited to, cationic polymers, such as cationized guar gum, diallyl quaternary ammonium salt/acrylamide copolymers, quaternized polyvinylpyrrolidone and derivatives thereof, and various polyquaternium-compounds; cationic surfactants, such as stearalkonium chloride, centrimonium chloride, and sapamin hydrochloride; fatty alcohols, such as behenyl alcohol; fatty amines, such as stearyl amine; waxes; esters; nonionic polymers, such as polyvinylpyrrolidone, polyvinyl alcohol, and polyethylene glycol; silicones; siloxanes, such as decamethylcyclopentasiloxane; polymer emulsions, such as amodimethicone; and nanoparticles, such as silica nanoparticles and polymer nanoparticles.

The hair care products may also include additional components typically found in cosmetically acceptable media. Non-limiting examples of such components are disclosed in International Cosmetic Ingredient Dictionary, Ninth Edition, 2002, and CTFA Cosmetic Ingredient Handbook, Tenth Edition, 2004. A non-limiting list of components often included in a cosmetically acceptable medium for hair care are also described by Philippe et al. in U.S. Pat. No. 6,280,747, and by Omura et al. in U.S. Pat. No. 6,139,851 and Cannell et al. in U.S. Pat. No. 6,013,250, all of which are incorporated herein by reference. For example, hair care compositions can be aqueous, alcoholic or aqueous-alcoholic solutions, the alcohol preferably being ethanol or isopropanol, in a proportion of from about 1 to about 75% by weight relative to the total weight, for the aqueous-alcoholic solutions. Additionally, the hair care compositions may contain one or more conventional cosmetic or dermatological additives or adjuvants including but not limited to, antioxidants, preserving agents, fillers, surfactants, UVA and/or UVB sunscreens, fragrances, thickeners, gelling agents, wetting agents and anionic, nonionic or amphoteric polymers, and dyes or pigments.

The hair care compositions and methods may also include at least one coloring agents such as any dye, lake, pigment, and the like that may be used to change the color of hair, skin, or nails. Hair coloring agents are well known in the art (see for example Green et al. supra, CFTA International Color Handbook, 2nd ed., Micelle Press, England (1992) and Cosmetic Handbook, US Food and Drug Administration, FDA/IAS Booklet (1992)), and are available commercially from various sources (for example Bayer, Pittsburgh, PA; Ciba-Geigy, Tarrytown, NY; ICI, Bridgewater, NJ; Sandoz, Vienna, Austria; BASF, Mount Olive, NJ; and Hoechst, Frankfurt, Germany). Suitable hair coloring agents include, but are not limited to dyes, such as 4-hydroxypropylamino-3-nitrophenol, 4-amino-3-nitrophenol, 2-amino-6-chloro-4-nitrophenol, 2-nitro-paraphenylenediamine, N, N-hydroxyethyl-2-nitro-phenylenediamine, 4-nitro-indole, Henna, HC Blue 1, HC Blue 2, HC Yellow 4, HC Red 3, HC Red 5, Disperse Violet 4, Disperse Black 9, HC Blue 7, HC Blue 12, HC Yellow 2, HC Yellow 6, HC Yellow 8, HC Yellow 12, HC Brown 2, D&C Yellow 1, D&C Yellow 3, D&C Blue 1, Disperse Blue 3, Disperse violet 1, eosin derivatives such as D&C Red No. 21 and halogenated fluorescein derivatives such as D&C Red No. 27, D&C Red Orange No. 5 in combination with D&C Red No. 21 and D&C Orange No. 10; and pigments, such as D&C Red No. 36 and D&C Orange No. 17, the calcium lakes of D&C Red Nos. 7, 11, 31 and 34, the barium lake of D&C Red No. 12, the strontium lake of D&C Red No. 13, the aluminum lakes of FD&C Yellow No. 5, of FD&C Yellow No. 6, of D&C Red No. 27, of D&C Red No. 21, and of FD&C Blue No. 1, iron oxides, manganese violet, chromium oxide, titanium dioxide, titanium dioxide nanoparticles, zinc oxide, barium oxide, ultramarine blue, bismuth citrate, and carbon black particles. In one embodiment, the hair coloring agents are D&C Yellow 1 and 3, HC Yellow 6 and 8, D&C Blue 1, HC Blue 1, HC Brown 2, HC Red 5, 2-nitro-paraphenylenediamine, N, N-hydroxyethyl-2-nitro-phenylenediamine, 4-nitro-indole, and carbon black. Metallic and semiconductor nanoparticles may also be used as hair coloring agents due to their strong emission of light (U.S. Patent Application Publication No. 2004-0010864 to Vic et al.).

Hair care compositions may include, but are not limited to, shampoos, conditioners, lotions, aerosols, gels, mousses, and hair dyes.

Personal care products may be in the form of lotions, creams, pastes, balms, ointments, pomades, gels, liquids, or combinations thereof. A personal care product can also be in the form of makeup, lipstick, mascara, rouge, foundation, blush, eyeliner, lip liner, lip gloss, other cosmetics, sunscreen, sun block, nail polish, mousse (e.g., hair styling mousse), hair spray (e.g., hair styling spray), styling gel (e.g., hair styling gel), nail conditioner, bath gel, shower gel, body wash, face wash, shampoo, hair conditioner (leave-in or rinse-out), cream rinse, hair dye, hair coloring product, hair shine product, hair serum, hair anti-frizz product, hair split-end repair product, lip balm, skin conditioner, cold cream, moisturizer, body spray, soap, body scrub, exfoliant, astringent, scruffing lotion, depilatory, permanent waving solution, antidandruff formulation, antiperspirant composition, deodorant, shaving product, pre-shaving product, after-shaving product, cleanser, skin gel, rinse, dentifrice composition, toothpaste, or mouthwash, for example.

A composition in some aspects can be a hair care composition such as a hair styling or hair setting composition (e.g., hair spray, hair gel or lotion, hair mousse/foam) (e.g., aerosol hair spray, non-aerosol pump-spray, spritze, foam, crème, paste, non-runny gel, mousse, pomade, lacquer, hair wax). A hair styling/setting composition/formulation that can be adapted to include a poly alpha-1,6-glucan ether compound herein can be as disclosed in, for example, U.S. 20090074697, WO1999048462, U.S. 20130068849, JPH0454116A, U.S. 5304368, AU667246B2, U.S. 5413775, U.S. 5441728, U.S. 5939058, JP2001302458A, U.S. 6346234, U.S. 20020085988, U.S. 7169380, U.S. 2,090060858, U.S. 20090326151, U.S. 20160008257, WO2020164769, or U.S. 20110217256, all of which are incorporated herein by reference. A hair care composition such as a hair styling/setting composition can comprise one or more ingredients/additives as disclosed in any of the foregoing references, and/or one or more of a fragrance/perfume, aroma therapy essence, herb, infusion, antimicrobial, stimulant (e.g., caffeine), essential oil, hair coloring, dying or tinting agent, anti-gray agent, anti-foam agent, sunscreen/UV-blocker (e.g., benzophenone-4), vitamin, antioxidant, surfactant or other wetting agent, mica, silica, metal flakes or other glitter-effect material, conditioning agent (e.g., a volatile or non-volatile silicone fluid), anti-static agent, opacifier, detackifying agent, penetrant, preservative (e.g., phenoxyethanol, ethylhexylglycerin, benzoate, diazolidinyl urea, iodopropynyl butylcarbamate), emollient (e.g., panthenol, isopropyl myristate), rheology-modifying or thickening polymer (e.g., acrylates/methacrylamide copolymer, polyacrylic acid [e.g., CARBOMER]), emulsified oil phase, petrolatum, fatty alcohols, diols and polyols, emulsifier (e.g., PEG-40 hydrogenated castor oil, Oleth-20), humectant (e.g., glycerin, caprylyl glycol), silicone derivative, protein, amino acid (e.g., isoleucine), conditioner, chelant (e.g., EDTA), solvent (e.g., see below), monosaccharide (e.g., dextrose), disaccharide, oligosaccharide, pH-stabilizing compound (e.g., aminomethyl propanol), film former (e.g., acrylates/hydroxyester acrylate copolymer, polyvinylpyrrolidone/vinyl acetate copolymer, triethyl acetate), aerosol propellant (e.g., C₃-C₅ alkane such as propane, isobutane, or n-butane, monoalkyl ether, dialkyl ether such as di(C₁-C₄ alkyl) ether [e.g., dimethyl ether]), and/or any other suitable material herein. A poly alpha-1,6-glucan ether compound as used in a hair styling/setting composition herein can function as a hair fixing/styling agent (typically non-permanent hair fixing, but durable), for example, and optionally is the only hair fixing agent in the composition. Optional additional hair fixing/styling agents herein include PVP (polyvinylpyrrolidone), octylacrylamide/acrylates/butylaminoethyl methacrylate copolymer, vinyl caprolactam/PVP/dimethylaminoethyl methacrylate copolymer, AMPHOMER, or any film former such as listed above.

The total content of one or more poly alpha-1,6-glucan ether compounds in a hair care composition such as a hair styling/setting composition herein can be about, at least about, or less than about, 0.5, 1, 2, 3, 4, 5, 6, 7, 8, 9, 10, 11, 12, 13, 14, 15, 0.5-15, 0.5-10, 0.5-5, 0.5-2, 1-15, 1-10, 1-5, 1-2, 2.5-7.5, 3-7, or 4-6 wt %, for example. A hair styling/setting composition can comprise a solvent comprising water and optionally a water-miscible (typically polar) organic compound (e.g., liquid or gas) such as an alcohol (e.g., ethanol, propanol, isopropanol, n-butanol, iso-butanol, tert-butanol), an alkylene glycol alkyl ether, and/or a monoalkyl or dialkyl ether (e.g., dimethyl ether), for example. If an organic compound is included, it can constitute about 10%, 20%, 30%, 40%, 50%, or 60% by weight or volume of the solvent (balance is water), for example. The amount of solvent in a hair styling/setting composition herein can be about 50-90, 60-90, 70-90, 80-90, 50-95, 60-95, 70-95, 80-95, or 90-95 wt %, for example.

An example of a hair styling gel formulation herein can comprise about 90-95 wt % (e.g., ˜92 wt %) solvent (e.g., water), 0.3-1.0 wt % (e.g., ˜0.5 wt %) thickener (e.g., polyacrylic acid), 0.1-0.3 wt % (e.g., ˜0.2 wt %) chelant (e.g., EDTA) (optional), 0.2-1.0 wt % (e.g., ˜0.5 wt %) humectant (e.g., glycerin), 0.01-0.05 wt % (e.g., ˜0.02 wt %) UV-blocker (e.g., benzophenone-4) (optional), 0.05-0.3 wt % (e.g., ˜0.1 wt %) preservative (e.g., diazolidinyl urea) (optional), 0.5-1.2 wt % (e.g., ˜0.8 wt %) emulsifier (e.g., Oleth-20), 0.1-0.3 wt % (e.g., ˜0.2 wt %) fragrance/perfume (optional), 0.2-1.0 wt % (e.g., ˜0.5 wt %) pH-stabilizing compound (e.g., aminomethyl propanol), and 3-7 wt % (e.g., ˜5 wt %) poly alpha-1,6-glucan ether compound herein (e.g., as a hair fixing/styling agent).

An example of a hair styling spray formulation herein can comprise about 0.2-1.0 wt % (e.g., ˜0.5 wt %) pH-stabilizing compound (e.g., aminomethyl propanol), 0.1-0.3 wt % (e.g., ˜0.2 wt %) fragrance/perfume (optional), 0.05-0.12 wt % (e.g., ˜0.08 wt %) surfactant (e.g., ethoxylated dimethicone polyol), 0.05-0.12 wt % (e.g., ˜0.08 wt %) conditioner (e.g., cyclomethicone) (optional), 0.05-0.3 wt % (e.g., ˜0.2 wt %) preservative (e.g., sodium benzoate) (optional), 15-20 wt % (e.g., ˜17 wt %) water, 30-40 wt % (e.g., ˜65 wt %) alcohol (e.g., ethanol), 40-60 wt % (e.g., ˜45 wt %) propellant (e.g., dimethyl ether, or a ˜2:1 mix of dimethyl ether to C₃-C₅ alkane [e.g., mix of propane and isobutane]), and 2-4 wt % (e.g., ˜2.75 wt %) poly alpha-1,6-glucan ether compound herein (e.g., as a hair fixing/styling agent).

Some aspects of the present disclosure regard hair that has been treated with a hair care composition herein (e.g., hair styling/setting composition, shampoo, or conditioner). For example, hair can comprise a poly alpha-1,6-glucan ether compound on its surface, such as in a film/coating of the hair; optionally, one or more other ingredients of a hair care composition herein can also be present.

Personal care products can include the poly alpha-1,6-glucan ether compounds as disclosed herein, and can further comprise personal care active ingredient materials including sun screen agents, moisturizers, humectants, benefiting agents for hair, skin, nails and mouth, depositing agents such as surfactants, occlusive agents, moisture barriers, lubricants, emollients, anti-aging agents, antistatic agents, abrasive, antimicrobials, conditioners, exfoliants, fragrances, viscosifying agents, salts, lipids, phospholipids, vitamins, foam stabilizers, pH modifiers, preservatives, suspending agents, silicone oils, silicone derivatives, essential oils, oils, fats, fatty acids, fatty acid esters, fatty alcohols, waxes, polyols, hydrocarbons, and mixtures thereof. An active ingredient is generally recognized as an ingredient that causes an intended pharmacological effect.

In certain embodiments, a skin care product can include at least one active ingredient for the treatment or prevention of skin ailments, providing a cosmetic effect, or for providing a moisturizing benefit to skin, such as zinc oxide, petrolatum, white petrolatum, mineral oil, cod liver oil, lanolin, dimethicone, hard fat, vitamin A, allantoin, calamine, kaolin, glycerin, or colloidal oatmeal, and combinations of these. A skin care product may include one or more natural moisturizing factors such as ceramides, hyaluronic acid, glycerin, squalane, amino acids, cholesterol, fatty acids, triglycerides, phospholipids, glycosphingolipids, urea, linoleic acid, glycosaminoglycans, mucopolysaccharide, sodium lactate, or sodium pyrrolidone carboxylate, for example. Other ingredients that may be included in a skin care product include, without limitation, glycerides, apricot kernel oil, canola oil, squalane, squalene, coconut oil, corn oil, jojoba oil, jojoba wax, lecithin, olive oil, safflower oil, sesame oil, shea butter, soybean oil, sweet almond oil, sunflower oil, tea tree oil, shea butter, palm oil, cholesterol, cholesterol esters, wax esters, fatty acids, and orange oil.

Various examples of personal care formulations comprising at least one poly alpha-1,6-glucan ether as presently disclosed are disclosed below (1-3).
(1) A hair conditioner composition comprising: cetyl alcohol (1-3%), isopropyl myristate (1-3%), hydroxyethyl cellulose (Natrosol® 250 HHR), 0.1-1%, poly alpha-1,6-glucan ether (0.1-2%), potassium salt (0.1-0.5%), Germaben® II preservative (0.5%, available from International Specialty Products), and the balance being water.
(2) A hair shampoo composition comprising: 5-20% sodium laureth sulfate (SLES), 1-2 wt % cocamidopropyl betaine, 1-2 wt % sodium chloride, 0.1-2% poly alpha-1,6-glucan ether, preservative (0.1-0.5%), and the balance being water.
(3) A skin lotion composition comprising: 1-5% glycerin, 1-5% glycol stearate, 1-5% stearic acid, 1-5% mineral oil, 0.5-1% acetylated lanolin (Lipolan® 98), 0.1-0.5 cetyl alcohol, 0.2-1% triethanolamine, 0.1-1 wt % Germaben® II preservative, 0.5-2 wt % poly alpha-1,6-glucan ether, and the balance being water.

Personal care compositions disclosed herein can be in the form of an oral care composition. An “oral care composition” herein is any composition suitable for treating any soft or hard surface in the oral cavity such as dental (teeth) and/or gum surfaces. Examples of oral care compositions include dentifrices, toothpaste, mouth wash, mouth rinse, chewing gum, and edible strips that provide some form of oral care (e.g., treatment or prevention of cavities [dental caries], gingivitis, plaque, tartar, and/or periodontal disease). An oral care composition can also be for treating an “oral surface”, which encompasses any soft or hard surface within the oral cavity including surfaces of the tongue, hard and soft palate, buccal mucosa, gums and dental surfaces. A “dental surface” herein is a surface of a natural tooth or a hard surface of artificial dentition including a crown, cap, filling, bridge, denture, or dental implant, for example.

One or more poly alpha-1,6-glucan ethers comprised in an oral care composition typically are provided therein as a thickening agent and/or dispersion agent, which may be useful to impart a desired consistency and/or mouth feel to the composition. An oral care composition herein can comprise about 0.01-15.0 wt % (e.g., ˜0.1-10 wt % or ˜0.1-5.0 wt %, ˜0.1-2.0 wt %) of one or more poly alpha-1,6-glucan ethers disclosed herein. One or more other thickening agents or dispersion agents can also be provided in an oral care composition herein, such as a carboxyvinyl polymer, carrageenan (e.g., L-carrageenan), natural gum (e.g., karaya, xanthan, gum arabic, tragacanth), colloidal magnesium aluminum silicate, or colloidal silica, for example.

An oral care composition herein may be a toothpaste or other dentifrice, for example. Such compositions, as well as any other oral care composition herein, can additionally comprise, without limitation, one or more of an anticaries agent, antimicrobial or antibacterial agent, anticalculus or tartar control agent, surfactant, abrasive, pH-modifying agent, foam modulator, humectant, flavorant, sweetener, pigment/colorant, whitening agent, and/or other suitable components.

An anticaries agent herein can be an orally acceptable source of fluoride ions. Suitable sources of fluoride ions include fluoride, monofluorophosphate and fluorosilicate salts as well as amine fluorides, including olaflur (N′-octadecyltrimethylendiamine-N, N, N′-tris(2-ethanol)-dihydrofluoride), for example. An anticaries agent can be present in an amount providing a total of about 100-20000 ppm, about 200-5000 ppm, or about 500-2500 ppm, fluoride ions to the composition, for example. In oral care compositions in which sodium fluoride is the sole source of fluoride ions, an amount of about 0.01-5.0 wt %, about 0.05-1.0 wt %, or about 0.1-0.5 wt %, sodium fluoride can be present in the composition, for example.

An antimicrobial or antibacterial agent suitable for use in an oral care composition herein includes, for example, phenolic compounds (e.g., 4-allylcatechol; p-hydroxybenzoic acid esters such as benzylparaben, butylparaben, ethylparaben, methylparaben and propylparaben; 2-benzylphenol; butylated hydroxyanisole; butylated hydroxytoluene; capsaicin; carvacrol; creosol; eugenol; guaiacol; halogenated bisphenolics such as hexachlorophene and bromochlorophene; 4-hexylresorcinol; 8-hydroxyquinoline and salts thereof; salicylic acid esters such as menthyl salicylate, methyl salicylate and phenyl salicylate; phenol; pyrocatechol; salicylanilide; thymol; halogenated diphenylether compounds such as triclosan and triclosan monophosphate), copper (II) compounds (e.g., copper (II) chloride, fluoride, sulfate and hydroxide), zinc ion sources (e.g., zinc acetate, citrate, gluconate, glycinate, oxide, and sulfate), phthalic acid and salts thereof (e.g., magnesium monopotassium phthalate), hexetidine, octenidine, sanguinarine, benzalkonium chloride, domiphen bromide, alkylpyridinium chlorides (e.g. cetylpyridinium chloride, tetradecylpyridinium chloride, N-tetradecyl-4-ethylpyridinium chloride), iodine, sulfonamides, bisbiguanides (e.g., alexidine, chlorhexidine, chlorhexidine digluconate), piperidino derivatives (e.g., delmopinol, octapinol), magnolia extract, grapeseed extract, rosemary extract, menthol, geraniol, citral, eucalyptol, antibiotics (e.g., augmentin, amoxicillin, tetracycline, doxycycline, minocycline, metronidazole, neomycin, kanamycin, clindamycin), and/or any antibacterial agents disclosed in U.S. Pat. No. 5,776,435, which is incorporated herein by reference. One or more antimicrobial agents can optionally be present at about 0.01-10 wt % (e.g., 0.1-3 wt %), for example, in the disclosed oral care composition.

An anticalculus or tartar control agent suitable for use in an oral care composition herein includes, for example, phosphates and polyphosphates (e.g., pyrophosphates), polyaminopropanesulfonic acid (AMPS), zinc citrate trihydrate, polypeptides (e.g., polyaspartic and polyglutamic acids), polyolefin sulfonates, polyolefin phosphates, diphosphonates (e.g., azacycloalkane-2,2-diphosphonates such as azacycloheptane-2,2-diphosphonic acid), N-methyl azacyclopentane-2,3-diphosphonic acid, ethane-1-hydroxy-1,1-diphosphonic acid (EHDP), ethane-1-amino-1,1-diphosphonate, and/or phosphonoalkane carboxylic acids and salts thereof (e.g., their alkali metal and ammonium salts). Useful inorganic phosphate and polyphosphate salts include, for example, monobasic, dibasic and tribasic sodium phosphates, sodium tripolyphosphate, tetrapolyphosphate, mono-, di-, tri- and tetra-sodium pyrophosphates, disodium dihydrogen pyrophosphate, sodium trimetaphosphate, sodium hexametaphosphate, or any of these in which sodium is replaced by potassium or ammonium. Other useful anticalculus agents in certain embodiments include anionic polycarboxylate polymers (e.g., polymers or copolymers of acrylic acid, methacrylic, and maleic anhydride such as polyvinyl methyl ether/maleic anhydride copolymers). Still other useful anticalculus agents include sequestering agents such as hydroxycarboxylic acids (e.g., citric, fumaric, malic, glutaric and oxalic acids and salts thereof) and aminopolycarboxylic acids (e.g., EDTA). One or more anticalculus or tartar control agents can optionally be present at about 0.01-50 wt % (e.g., about 0.05-25 wt % or about 0.1-15 wt %), for example, in the disclosed oral care composition.

A surfactant suitable for use in an oral care composition herein may be anionic, non-ionic, or amphoteric, for example. Suitable anionic surfactants include, without limitation, water-soluble salts of C₈₋₂₀ alkyl sulfates, sulfonated monoglycerides of C₈₋₂₀ fatty acids, sarcosinates, and taurates. Examples of anionic surfactants include sodium lauryl sulfate, sodium coconut monoglyceride sulfonate, sodium lauryl sarcosinate, sodium lauryl isoethionate, sodium laureth carboxylate and sodium dodecyl benzenesulfonate. Suitable non-ionic surfactants include, without limitation, poloxamers, polyoxyethylene sorbitan esters, fatty alcohol ethoxylates, alkylphenol ethoxylates, tertiary amine oxides, tertiary phosphine oxides, and dialkyl sulfoxides. Suitable amphoteric surfactants include, without limitation, derivatives of C₈₋₂₀ aliphatic secondary and tertiary amines having an anionic group such as a carboxylate, sulfate, sulfonate, phosphate or phosphonate. An example of a suitable amphoteric surfactant is cocoamidopropyl betaine. One or more surfactants are optionally present in a total amount of about 0.01-10 wt % (e.g., about 0.05-5.0 wt % or about 0.1-2.0 wt %), for example, in the disclosed oral care composition.

An abrasive suitable for use in an oral care composition herein may include, for example, silica (e.g., silica gel, hydrated silica, precipitated silica), alumina, insoluble phosphates, calcium carbonate, and resinous abrasives (e.g., a urea-formaldehyde condensation product). Examples of insoluble phosphates useful as abrasives herein are orthophosphates, polymetaphosphates and pyrophosphates, and include dicalcium orthophosphate dihydrate, calcium pyrophosphate, beta-calcium pyrophosphate, tricalcium phosphate, calcium polymetaphosphate and insoluble sodium polymetaphosphate. One or more abrasives are optionally present in a total amount of about 5-70 wt % (e.g., about 10-56 wt % or about 15-30 wt %), for example, in the disclosed oral care composition. The average particle size of an abrasive in certain embodiments is about 0.1-30 microns (e.g., about 1-20 microns or about 5-15 microns).

An oral care composition in certain embodiments may comprise at least one pH-modifying agent. Such agents may be selected to acidify, make more basic, or buffer the pH of a composition to a pH range of about 2-10 (e.g., pH ranging from about 2-8, 3-9, 4-8, 5-7, 6-10, or 7-9). Examples of pH-modifying agents useful herein include, without limitation, carboxylic, phosphoric and sulfonic acids; acid salts (e.g., monosodium citrate, disodium citrate, monosodium malate); alkali metal hydroxides (e.g. sodium hydroxide, carbonates such as sodium carbonate, bicarbonates, sesquicarbonates); borates; silicates; phosphates (e.g., monosodium phosphate, trisodium phosphate, pyrophosphate salts); and imidazole.

A foam modulator suitable for use in an oral care composition herein may be a polyethylene glycol (PEG), for example. High molecular weight PEGs are suitable, including those having an average molecular weight of about 200000-7000000 (e.g., about 500000-5000000 or about 1000000-2500000), for example. One or more PEGs are optionally present in a total amount of about 0.1-10 wt % (e.g. about 0.2-5.0 wt % or about 0.25-2.0 wt %), for example, in the disclosed oral care composition.

An oral care composition in certain embodiments may comprise at least one humectant. A humectant in certain embodiments may be a polyhydric alcohol such as glycerin, sorbitol, xylitol, or a low molecular weight PEG. Most suitable humectants also may function as a sweetener herein. One or more humectants are optionally present in a total amount of about 1.0-70 wt % (e.g., about 1.0-50 wt %, about 2-25 wt %, or about 5-15 wt %), for example, in the disclosed oral care composition.

A natural or artificial sweetener may optionally be comprised in an oral care composition herein. Examples of suitable sweeteners include dextrose, sucrose, maltose, dextrin, invert sugar, mannose, xylose, ribose, fructose, levulose, galactose, corn syrup (e.g., high fructose corn syrup or corn syrup solids), partially hydrolyzed starch, hydrogenated starch hydrolysate, sorbitol, mannitol, xylitol, maltitol, isomalt, aspartame, neotame, saccharin and salts thereof, dipeptide-based intense sweeteners, and cyclamates. One or more sweeteners are optionally present in a total amount of about 0.005-5.0 wt %, for example, in the disclosed oral care composition.

A natural or artificial flavorant may optionally be comprised in an oral care composition herein. Examples of suitable flavorants include vanillin; sage; marjoram; parsley oil; spearmint oil; cinnamon oil; oil of wintergreen (methylsalicylate); peppermint oil; clove oil; bay oil; anise oil; eucalyptus oil; citrus oils; fruit oils; essences such as those derived from lemon, orange, lime, grapefruit, apricot, banana, grape, apple, strawberry, cherry, or pineapple; bean- and nut-derived flavors such as coffee, cocoa, cola, peanut, or almond; and adsorbed and encapsulated flavorants. Also encompassed within flavorants herein are ingredients that provide fragrance and/or other sensory effect in the mouth, including cooling or warming effects. Such ingredients include, without limitation, menthol, menthyl acetate, menthyl lactate, camphor, eucalyptus oil, eucalyptol, anethole, eugenol, cassia, oxanone, Irisone®, propenyl guaiethol, thymol, linalool, benzaldehyde, cinnamaldehyde, N-ethyl-p-menthan-3-carboxamine, N,2,3-trimethyl-2-isopropylbutanamide, 3-(1-menthoxy)-propane-1,2-diol, cinnamaldehyde glycerol acetal (CGA), and menthone glycerol acetal (MGA). One or more flavorants are optionally present in a total amount of about 0.01-5.0 wt % (e.g., about 0.1-2.5 wt %), for example, in the disclosed oral care composition.

An oral care composition in certain embodiments may comprise at least one bicarbonate salt. Any orally acceptable bicarbonate can be used, including alkali metal bicarbonates such as sodium or potassium bicarbonate, and ammonium bicarbonate, for example. One or more bicarbonate salts are optionally present in a total amount of about 0.1-50 wt % (e.g., about 1-20 wt %), for example, in the disclosed oral care composition.

An oral care composition in certain embodiments may comprise at least one whitening agent and/or colorant. A suitable whitening agent is a peroxide compound such as any of those disclosed in U.S. Pat. No. 8,540,971, which is incorporated herein by reference. Suitable colorants herein include pigments, dyes, lakes and agents imparting a particular luster or reflectivity such as pearling agents, for example. Specific examples of colorants useful herein include talc; mica; magnesium carbonate; calcium carbonate; magnesium silicate; magnesium aluminum silicate; silica; titanium dioxide; zinc oxide; red, yellow, brown and black iron oxides; ferric ammonium ferrocyanide; manganese violet; ultramarine; titaniated mica; and bismuth oxychloride. One or more colorants are optionally present in a total amount of about 0.001-20 wt % (e.g., about 0.01-10 wt % or about 0.1-5.0 wt %), for example, in the disclosed oral care composition.

Additional components that can optionally be included in an oral composition herein include one or more enzymes (above), vitamins, and anti-adhesion agents, for example. Examples of vitamins useful herein include vitamin C, vitamin E, vitamin B5, and folic acid. Examples of suitable anti-adhesion agents include solbrol, ficin, and quorum-sensing inhibitors.

The composition can be in any useful form, for example, as powders, granules, pastes, bars, unit dose, or liquid.

The unit dose form may be water-soluble, for example, a water-soluble unit dose article comprising a water-soluble film and a liquid or solid laundry detergent composition, also referred to as a pouch. A water-soluble unit dose pouch comprises a water-soluble film which fully encloses the liquid or solid detergent composition in at least one compartment. The water-soluble unit dose article may comprise a single compartment or multiple compartments. The water-soluble unit dose article may comprise at least two compartments or at least three compartments. The compartments may be arranged in a superposed orientation or in a side-by-side orientation.

A unit dose article is typically a closed structure, made of the water-soluble film enclosing an internal volume which comprises the liquid or solid laundry detergent composition. The pouch can be of any form and shape which is suitable to hold and protect the composition, e.g. without allowing the release of the composition from the pouch prior to contact of the pouch to water.

A liquid detergent composition may be aqueous, typically containing up to about 70% by weight of water and 0% to about 30% by weight of organic solvent. It may also be in the form of a compact gel type containing less than or equal to 30% by weight water.

The cationic poly alpha-1,6-glucan ether compounds disclosed herein can be used as an ingredient in the desired product or may be blended with one or more additional suitable ingredients and used as, for example, fabric care applications, laundry care applications, and/or personal care applications. Any of the disclosed compositions, for example, a fabric care, a laundry care or a personal care composition can comprise in the range of 0.01 to 99 percent by weight of the poly alpha-1,6-glucan ether compound, based on the total dry weight of the composition (dry solids basis). The term “total dry weight” means the weight of the composition excluding any solvent, for example, any water that might be present. In other embodiments, the composition comprises 0.1 to 10% or 0.1 to 9% or 0.5 to 8% or 1 to 7% or 1 to 6% or 1 to 5% or 1 to 4% or 1 to 3% or 5 to 10% or 10 to 15% or 15 to 20% or 20 to 25% or 25 to 30% or 30 to 35% or 35 to 40% or 40 to 45% or 45 to 50% or 50 to 55% or 55 to 60% or 60 to 65% or 65 to 70% or 70 to 75% or 75 to 80% or 80 to 85% or 85 to 90% or 90 to 95% or 95 to 99% by weight of the cationic poly alpha-1,6-glucan ether compound, wherein the percentages by weight are based on the total dry weight of the composition.

A composition in some aspects can comprise one or more cationic poly alpha-1,6-glucan ether compounds as disclosed herein, and one or more unsubstituted and/or non-cationic poly alpha-1,6-glucan compounds, which may be residual reactants that are unreacted/unsubstituted, or may have hydrolyzed. Typically, a low level of unsubstituted/non-cationic poly alpha-1,6-glucan compounds is indicative of reaction completeness with regard to the substitution, and/or chemical stability of the compounds in the composition. The weight ratio of cationic poly alpha-1,6-glucan ether compounds to unsubstituted/non-cationic poly alpha 1,6-glucan compounds can be 95:5, 96:4, 97:3, 98:2, 99:1, or greater.

The composition can further comprise at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer inhibiting agent, a chelating agent, a hueing dye, a calcium cation, a magnesium cation, a visual signaling ingredient, an anti-foam, a structurant, a thickener, an anti-caking agent, a starch, sand, a gelling agents, or a combination thereof. In one embodiment, the enzyme is a cellulase. In another embodiment, the enzyme is a protease. In yet another embodiment, the enzyme is an amylase.

The composition can be a detergent composition useful for, for example, fabric care, laundry care and/or personal care and may further contain one or more active enzymes. Non-limiting examples of suitable enzymes include proteases, cellulases, hemicellulases, peroxidases, lipolytic enzymes (e.g., metallolipolytic enzymes), xylanases, phospholipases, perhydrolases, cutinases, pectinases, pectate lyases, mannanases, keratinases, reductases, oxidases (e.g., choline oxidase), phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, amylases, or a combination thereof. In some embodiments, a combination of two or more enzymes can be used in the composition. In some embodiments, the two or more enzymes are cellulase and one or more of proteases, hemicellulases, peroxidases, lipolytic enzymes, xylanases, phospholipases, perhydrolases, cutinases, pectinases, pectate lyases, mannanases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, amylases, or a combination thereof.

A cellulase can have endocellulase activity (EC 3.2.1.4), exocellulase activity (EC 3.2.1.91), or cellobiase activity (EC 3.2.1.21). A cellulase is an “active cellulase” having activity under suitable conditions for maintaining cellulase activity; it is within the skill of the art to determine such suitable conditions. Besides being able to degrade cellulose, a cellulase in certain embodiments can also degrade cellulose ether derivatives such as carboxymethyl cellulose.

The cellulase may be derived from any microbial source, such as a bacteria or fungus. Chemically-modified cellulases or protein-engineered mutant cellulases are included. Suitable cellulases include, for example, cellulases from the genera Bacillus, Pseudomonas, Streptomyces, Trichoderma, Humicola, Fusarium, Thielavia and Acremonium. As other examples, the cellulase may be derived from Humicola insolens, Myceliophthora thermophile, Fusarium oxysporum, Trichoderma reesei or a combination thereof. The cellulase, such as any of the foregoing, can be in a mature form lacking an N-terminal signal peptide. Commercially available cellulases useful herein include CELLUSOFT®, CELLUCLEAN®, CELLUZYME® and CAREZYME® (Novozymes A/S); CLAZINASE® and PURADAX® HA and REVITALENZ™ (DuPont Industrial Biosciences), BIOTOUCH® (AB Enzymes); and KAC-500(B)® (Kao Corporation).

Alternatively, a cellulase herein may be produced by any means known in the art, for example, a cellulase may be produced recombinantly in a heterologous expression system, such as a microbial or fungal heterologous expression system. Examples of heterologous expression systems include bacterial (e.g., E. coli, Bacillus sp.) and eukaryotic systems. Eukaryotic systems can employ yeast (e.g., Pichia sp., Saccharomyces sp.) or fungal (e.g., Trichoderma sp. such as T. reesei, Aspergillus species such as A. niger) expression systems, for example.

The cellulase in certain embodiments can be thermostable. Cellulase thermostability refers to the ability of the enzyme to retain activity after exposure to an elevated temperature (e.g. about 60-70° C.) for a period of time (e.g., about 30-60 minutes). The thermostability of a cellulase can be measured by its half-life (t1/2) given in minutes, hours, or days, during which time period half the cellulase activity is lost under defined conditions.

The cellulase in certain embodiments can be stable to a wide range of pH values (e.g. neutral or alkaline pH such as pH of ˜7.0 to ˜11.0). Such enzymes can remain stable for a predetermined period of time (e.g., at least about 15 min., 30 min., or 1 hour) under such pH conditions.

At least one, two, or more cellulases may be included in the composition. The total amount of cellulase in a composition herein typically is an amount that is suitable for the purpose of using cellulase in the composition (an “effective amount”). For example, an effective amount of cellulase in a composition intended for improving the feel and/or appearance of a cellulose-containing fabric is an amount that produces measurable improvements in the feel of the fabric (e.g., improving fabric smoothness and/or appearance, removing pills and fibrils which tend to reduce fabric appearance sharpness). As another example, an effective amount of cellulase in a fabric stonewashing composition herein is that amount which will provide the desired effect (e.g., to produce a worn and faded look in seams and on fabric panels). The amount of cellulase in a composition herein can also depend on the process parameters in which the composition is employed (e.g., equipment, temperature, time, and the like) and cellulase activity, for example. The effective concentration of cellulase in an aqueous composition in which a fabric is treated can be readily determined by a skilled artisan.

Suitable enzymes are known in the art and can include, for example, MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (Genencor); ALCALASE®, SAVINASE®, PRIMASE®, DURAZYM™, POLARZYME®, OVOZYME®, KANNASE®, LIQUANASE®, NEUTRASE®, RELASE® and ESPERASE® (Novozymes); BLAP™ and BLAP™ variants (Henkel Kommanditgesellschaft auf Aktien, Duesseldorf, Germany), and KAP (B. alkalophilus subtilisin; Kao Corp., Tokyo, Japan) proteases; MANNASTAR®, PURABRITE™, and MANNAWAY® mannanases; M1 LIPASE™, LUMA FAST™, and LIPOMAX™ (Genencor); LIPEX®, LIPOLASE® and LIPOLASE® ULTRA (Novozymes); and LIPASE P™ “Amano” (Amano Pharmaceutical Co. Ltd., Japan) lipases; STAINZYME®, STAINZYME PLUS®, NATALASE®, DURAMYL®, TERMAMYL®, TERMAMYL ULTRA®, FUNGAMYL® and BAN™ (Novo Nordisk A/S and Novozymes A/S); RAPIDASE®, POWERASE®, PURASTAR® and PREFERENZ™ (DuPont Industrial Biosciences) amylases; GUARDZYME™ (Novo Nordisk A/S and Novozymes A/S) peroxidases or a combination thereof.

In some embodiments, the enzymes in the composition can be stabilized using conventional stabilizing agents, e.g., a polyol such as propylene glycol or glycerol; a sugar or sugar alcohol; lactic acid; boric acid or a boric acid derivative (e.g., an aromatic borate ester).

A detergent composition herein typically comprises one or more surfactants, wherein the surfactant is selected from nonionic surfactants, anionic surfactants, cationic surfactants, ampholytic surfactants, zwitterionic surfactants, semi-polar nonionic surfactants and mixtures thereof. The surfactant may be petroleum-derived (also referred to as synthetic) or non-petroleum-derived (also referred to as natural). A detergent will usually contain an anionic surfactant such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap.

The detergent composition may comprise an alcohol ethoxysulfate of the formula R¹—(OCH₂CH₂)ₓ—O—SO₃M, wherein R¹ is a non-petroleum derived, linear or branched fatty alcohol consisting of even numbered carbon chain lengths of from about C₈ to about C₂₀, and wherein x is from about 0.5 to about 8, and where M is an alkali metal or ammonium cation. The fatty alcohol portion of the alcohol ethoxysulfate (R¹) is derived from a renewable source (e.g., animal or plant derived) rather than geologically derived (e.g., petroleum-derived). Fatty alcohols derived from a renewable source may be referred to as natural fatty alcohols. Natural fatty alcohols have an even number of carbon atoms with a single alcohol (—OH) attached to the terminal carbon. The fatty alcohol portion of the surfactant (R¹) may comprise distributions of even number carbon chains, e.g., C12, C14, C16, C18, and so forth.

In addition, a detergent composition may optionally contain a nonionic surfactant such as alcohol ethoxylate (AEO or AE), carboxylated alcohol ethoxylates, nonylphenol ethoxylate, alkylpolyglycoside, alkyldimethylamineoxide, ethoxylated fatty acid monoethanolamide, fatty acid monoethanolamide, or polyhydroxy alkyl fatty acid amide. The detergent composition may comprise an alcohol ethoxylate of formula R²—(OCH₂CH₂)_{y}—OH, wherein R² is a non-petroleum derived, linear or branched fatty alcohol consisting of even numbered carbon chain lengths of from about C₁₀ to about C₁₈, and wherein y is from about 0.5 to about 15. The fatty alcohol portion of the alcohol ethoxylate (R²) is derived from a renewable source (e.g., animal or plant derived) rather than geologically derived (e.g., petroleum-derived). The fatty alcohol portion of the surfactant (R²) may comprise distributions of even number carbon chains, e.g., C12, C14, C16, C18, and so forth.

The composition can further comprise one or more detergent builders or builder systems. Builders include, for example, the alkali metal, ammonium and/or alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof. Examples of a detergent builder or complexing agent include zeolite, diphosphate, triphosphate, phosphonate, citrate, nitrilotriacetic acid (NTA), ethylenediaminetetraacetic acid (EDTA), diethylenetriaminepentaacetic acid (DTMPA), alkyl- or alkenylsuccinic acid, soluble silicates or layered silicates (e.g., SKS-6 from Hoechst). A detergent may also be unbuilt, i.e., essentially free of detergent builder.

The composition can further comprise at least one chelating agent. Suitable chelating agents include, for example, copper, iron and/or manganese chelating agents and mixtures thereof.

The composition can further comprise at least one deposition aid. Suitable deposition aids include, for example, polyethylene glycol, polypropylene glycol, polycarboxylate, soil release polymers such as polytelephthalic acid, clays such as kaolinite, montmorillonite, atapulgite, illite, bentonite, halloysite, or a combination thereof.

The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetriacetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

The composition can further comprise silicates. Suitable silicates can include, for example, sodium silicates, sodium disilicate, sodium metasilicate, crystalline phyllosilicates or a combination thereof.

The composition can further comprise dispersants. Suitable water-soluble organic materials can include, for example, homo- or co-polymeric acids or their salts, in which the polycarboxylic acid comprises at least two carboxyl radicals separated from each other by not more than two carbon atoms.

The composition can further comprise one or more other types of polymers in addition to the present poly alpha-1,6-glucan ether compounds. Examples of other types of polymers useful herein include carboxymethyl cellulose (CMC), poly(vinylpyrrolidone) (PVP), polyethylene glycol (PEG), poly(vinyl alcohol) (PVA), polycarboxylates such as polyacrylates, maleic/acrylic acid copolymers and lauryl methacrylate/acrylic acid copolymers.

The composition can further comprise a bleaching system. For example, the bleaching system can comprise an H₂O₂ source such as perborate, percarbonate, perhydrate salts, mono or tetra hydrate sodium salt of perborate, persulfate, perphosphate, persilicate, percarboxylic acids and salts, percarbonic acids and salts, perimidic acids and salts, peroxymonosulfuric acids and salts, sulfonated zinc phthalocyanines, sulfonated aluminum phthalocyanines, xanthene dyes which may be combined with a peracid-forming bleach activator such as, for example, dodecanoyl oxybenzene sulfonate, decanoyl oxybenzene sulfonate, decanoyl oxybenzoic acid or salts thereof, tetraacetylethylenediamine (TAED) or nonanoyloxybenzenesulfonate (NOBS). Alternatively, a bleaching system may comprise peroxyacids (e.g., amide, imide, or sulfone type peroxyacids). In other embodiments, the bleaching system can be an enzymatic bleaching system comprising perhydrolase. Combinations of any of the above may also be used.

The composition can further comprise conventional detergent ingredients such as fabric conditioners, clays, foam boosters, suds suppressors, anti-corrosion agents, soil-suspending agents, anti-soil redeposition agents, dyes, bactericides, tarnish inhibiters, optical brighteners, or perfumes. The pH of a detergent composition herein (measured in aqueous solution at use concentration) can be neutral or alkaline (e.g., pH of about 7.0 to about 11.0).

The composition can be a detergent composition and optionally, a heavy duty (all purpose) laundry detergent composition.

The composition can be a detergent composition, optionally including, for example, a surfactancy boosting polymer consisting of amphiphilic alkoxylated grease cleaning polymers. Suitable amphiphilic alkoxylated grease cleaning polymers can include, for example, alkoxylated polymers having branched hydrophilic and hydrophobic properties, such as alkoxylated polyalkylenimines, random graft polymers comprising a hydrophilic backbone comprising monomers, for example, unsaturated C₁-C₆ carboxylic acids, ethers, alcohols, aldehydes, ketones, esters, sugar units, alkoxy units, maleic anhydride, saturated polyalcohols such as glycerol, and mixtures thereof; and hydrophobic side chain(s), for example, one or more C₄-C₂₅ alkyl groups, polypropylene, polybutylene, vinyl esters of saturated C₁-C₆ mono-carboxylic acids, C₁-C₆ alkyl esters of acrylic or methacrylic acid, and mixtures thereof.

Suitable heavy duty laundry detergent compositions can optionally include additional polymers such as soil release polymers (include anionically end-capped polyesters, for example SRP1, polymers comprising at least one monomer unit selected from saccharide, dicarboxylic acid, polyol and combinations thereof, in random or block configuration, ethylene terephthalate-based polymers and co-polymers thereof in random or block configuration, for example REPEL-O-TEX SF, SF-2 AND SRP6, TEXCARE SRA100, SRA300, SRN100, SRN170, SRN240, SRN300 AND SRN325, MARLOQUEST SL), anti-redeposition polymers, include carboxylate polymers, such as polymers comprising at least one monomer selected from acrylic acid, maleic acid (or maleic anhydride), fumaric acid, itaconic acid, aconitic acid, mesaconic acid, citraconic acid, methylenemalonic acid, and any mixture thereof, vinylpyrrolidone homopolymer, and/or polyethylene glycol, molecular weight in the range of from 500 to 100,000 Daltons (Da); and polymeric carboxylate (such as maleate/acrylate random copolymer or polyacrylate homopolymer).

The heavy duty laundry detergent composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic starch, cationic polyacrylamides or a combination thereof.

The compositions disclosed herein can be in the form of a dishwashing detergent composition. Examples of dishwashing detergents include automatic dishwashing detergents (typically used in dishwasher machines) and hand-washing dish detergents. A dishwashing detergent composition can be in any dry or liquid/aqueous form as disclosed herein, for example. Components that may be included in certain embodiments of a dishwashing detergent composition include, for example, one or more of a phosphate; oxygen- or chlorine-based bleaching agent; non-ionic surfactant; alkaline salt (e.g., metasilicates, alkali metal hydroxides, sodium carbonate); any active enzyme disclosed herein; anti-corrosion agent (e.g., sodium silicate); anti-foaming agent; additives to slow down the removal of glaze and patterns from ceramics; perfume; anti-caking agent (in granular detergent); starch (in tablet-based detergents); gelling agent (in liquid/gel based detergents); and/or sand (powdered detergents).

Additional examples of personal care, household care, and other products and ingredients herein can be any as disclosed in U.S. Pat. No. 8,796,196, which is incorporated herein by reference. Examples of personal care, household care, and other products and ingredients herein include perfumes, fragrances, air odor-reducing agents, insect repellents and insecticides, bubble-generating agents such as surfactants, pet deodorizers, pet insecticides, pet shampoos, disinfecting agents, hard surface (e.g., floor, tub/shower, sink, toilet bowl, door/cabinet handle/panel, glass/window, table, countertop, desk) treatment products (e.g., cleaning product, disinfecting product, coating product, wipe), wipes and other non-woven materials, colorants, preservatives, antioxidants, emulsifiers, emollients, oils, medicaments, flavors, and suspending agents.

In other embodiments, the disclosure relates to a method for treating a substrate, the method comprising the steps:
(a) providing a composition comprising a poly alpha-1,6-glucan ether compound, the ether compound comprising:
   (i) poly alpha-1,6-glucan substituted with at least one positively charged organic group;
   (ii) a weight average degree of polymerization of at least 5; and
   (iii) a degree of substitution of about 0.001 to about 3.0;
      wherein the poly alpha-1,6-glucan comprises a backbone of glucose monomer units, wherein at least 40% of the glucose monomer units are linked via alpha-1,6-glycosidic linkages, and optionally at least 3% of the backbone glucose monomer units have branches via alpha-1,2 and/or alpha-1,3 glycosidic linkages.
(b) contacting the substrate with the composition; and
(c) optionally rinsing the substrate.

In one embodiment, the substrate can be a textile, a fabric, carpet, or apparel. In another embodiment, the substrate can be carpet, upholstery, or a surface. By “upholstery” is meant the soft, padded textile covering that is fixed to furniture such as armchairs and sofas. The treatment provides a benefit to the substrate, for example, one or more of improved fabric hand, improved resistance to soil deposition, improved colorfastness, improved wear resistance, improved wrinkle resistance, improved antifungal activity, improved antimicrobial activity, improved freshness, improved stain resistance, improved cleaning performance when laundered, improved drying rates, improved dye, pigment or lake update, improved whiteness retention, or a combination thereof. In another embodiment, the substrate can be a surface, for example a wall, a floor, a door, or a panel, or paper, or the substrate can be a surface of an object, such as a table. The treatment provides a benefit to the substrate, for example improved resistance to soil deposition, improved stain resistance, improved cleaning performance, improved antifungal activity, improved antimicrobial activity, or a combination thereof.

In one embodiment, the method of treating the substrate can impart anti-greying properties to the substrate, by which is meant that soil which is detached from a fabric during washing of the fabric is suspended in the wash liquor and thus prevented from being redeposited on the fabric. In another embodiment, the method of treating the substrate can impart anti-redeposition properties to a substrate. The effectiveness of anti-greying and anti-redeposition agents can be determined with the use of a tergotometer and multiple washings of pre-soiled fabrics in the presence of initially clean fabrics which act as redeposition monitors, for example using methods known in the art.

A fabric herein can comprise natural fibers, synthetic fibers, semi-synthetic fibers, or any combination thereof. A semi-synthetic fiber is produced using naturally occurring material that has been chemically derivatized, an example of which is rayon. Non-limiting examples of fabric types herein include fabrics made of (i) cellulosic fibers such as cotton (e.g., broadcloth, canvas, chambray, chenille, chintz, corduroy, cretonne, damask, denim, flannel, gingham, jacquard, knit, matelassé, oxford, percale, poplin, plissé, sateen, seersucker, sheers, terry cloth, twill, velvet), rayon (e.g., viscose, modal, lyocell), linen, and TENCEL®; (ii) proteinaceous fibers such as silk, wool and related mammalian fibers; (iii) synthetic fibers such as polyester, acrylic, nylon, and the like; (iv) long vegetable fibers from jute, flax, ramie, coir, kapok, sisal, henequen, abaca, hemp and sunn; and (v) any combination of a fabric of (i)-(iv). Fabric comprising a combination of fiber types (e.g., natural and synthetic) includes those with both a cotton fiber and polyester, for example. Materials/articles containing one or more fabrics include, for example, clothing, curtains, drapes, upholstery, carpeting, bed linens, bath linens, tablecloths, sleeping bags, tents, car interiors, etc. Other materials comprising natural and/or synthetic fibers include, for example, non-woven fabrics, paddings, paper, and foams. Fabrics are typically of woven or knit construction.

The step of contacting can be performed at a variety of conditions, for example, times, temperatures, wash/rinse volumes. Methods for contacting a fabric or textile substrate, for example, a fabric care method or laundry method are generally well known. For example, a material comprising fabric can be contacted with the disclosed composition: (i) for at least about 5, 10, 20, 30, 40, 50, 60, 70, 80, 90, 100, 110, or 120 minutes; (ii) at a temperature of at least about 10, 15, 20, 25, 30, 35, 40, 45, 50, 55, 60, 65, 70, 75, 80, 85, 90, or 95° C. (e.g., for laundry wash or rinse: a “cold” temperature of about 15-30° C., a “warm” temperature of about 30-50° C., a “hot” temperature of about 50-95° C.); (iii) at a pH of about 2, 3, 4, 5, 6, 7, 8, 9, 10, 11, or 12 (e.g., pH range of about 2-12, or about 3-11); (iv) at a salt (e.g., NaCl) concentration of at least about 0.5, 1.0, 1.5, 2.0, 2.5, 3.0, 3.5, or 4.0% by weight; or any combination of (i)-(iv). The contacting step in a fabric care method or laundry method can comprise any of washing, soaking, and/or rinsing steps, for example. In some embodiments, the rinsing step is a step of rinsing with water.

Other substrates that can be contacted include, for example, surfaces that can be treated with a dish detergent (e.g., automatic dishwashing detergent or hand dish detergent). Examples of such materials include surfaces of dishes, glasses, pots, pans, baking dishes, utensils and flatware made from ceramic material, china, metal, glass, plastic (e.g., polyethylene, polypropylene, and polystyrene) and wood (collectively referred to herein as “tableware”). Examples of conditions (e.g., time, temperature, wash volume) for conducting a dishwashing or tableware washing method are known in the art. In other examples, a tableware article can be contacted with the composition herein under a suitable set of conditions such as any of those disclosed above with regard to contacting a fabric-comprising material.

Certain embodiments of a method of treating a substrate further comprise a drying step, in which a material is dried after being contacted with the composition. The drying step can be performed directly after the contacting step, or following one or more additional steps that might follow the contacting step, for example, drying of a fabric after being rinsed, in water for example, following a wash in an aqueous composition. Drying can be performed by any of several means known in the art, such as air drying at a temperature of at least about 30, 40, 50, 60, 70, 80, 90, 100, 120, 140, 160, 170, 175, 180, or 200° C., for example. A material that has been dried herein typically has less than 3, 2, 1, 0.5, or 0.1 wt % water comprised therein.

In another embodiment, the substrate can be a surface, for example a wall, a floor, a door, or a panel, or the substrate can be a surface of an object, such as a table or dish. The treatment provides a benefit to the substrate, for example improved resistance to soil deposition, improved stain resistance, improved cleaning performance, or a combination thereof. The step of contacting can include wiping or spraying the substrate with the composition.

Non-limiting examples of the embodiments disclosed herein include:
1. A poly alpha-1,6-glucan ether compound comprising: (i) poly alpha-1,6-glucan substituted with at least one positively charged organic group; (ii) a weight average degree of polymerization of at least 5; and (iii) a degree of substitution of about 0.001 to about 3.0; wherein the poly alpha-1,6-glucan comprises a backbone of glucose monomer units, and wherein at least 40% of the glucose monomer units are linked via alpha-1,6-glycosidic linkages; optionally wherein the poly alpha-1,6-glucan is (a) only substituted with the at least one positively charged organic group, or (b) not substituted with a hydrophobic group or negatively charged organic group.
2. A poly alpha-1,6-glucan ether compound of embodiment 1, wherein at least 3% of the backbone glucose monomer units have branches via alpha-1,2- and/or alpha-1,3-glycosidic linkages.
3. A poly alpha-1,6-glucan ether compound of embodiment 1 or 2, wherein about 3% to about 35% of the backbone glucose monomer units have branches via alpha-1,2 and/or alpha-1,3 glycosidic linkages.
4. A poly alpha-1,6-glucan ether compound of embodiment 1, 2, or 3, wherein the degree of substitution is about 0.01 to about 1.5.
5. A poly alpha-1,6-glucan ether compound of embodiment 1, 2, 3, or 4, wherein the degree of substitution is about 0.01 to about 0.7.
6. A poly alpha-1,6-glucan ether compound of embodiment 1, 2, 3, 4, or 5, wherein the degree of substitution is about 0.01 to about 0.4.
7. A poly alpha-1,6-glucan ether compound of embodiment 1, 2, 3, 4, 5, or 6, wherein the degree of substitution is about 0.01 to about 0.2.
8. A poly alpha-1,6-glucan ether compound of embodiment 1, 2, 3, 4, 5, 6, or 7, wherein the poly alpha-1,6-glucan ether has a weight average degree of polymerization in the range of from about 5 to about 6000.
9. A poly alpha-1,6-glucan ether compound of embodiment 1, 2, 3, 4, 5, 6, 7, or 8, wherein at least 90% of the glucose monomer units in the backbone of the ether compound are linked via alpha-1,6-glycosidic linkages.
10. A poly alpha-1,6-glucan ether compound of embodiment 1, 2, 3, 4, 5, 6, 7, 8, or 9, wherein the positively charged organic group comprises a substituted ammonium group.
11. A poly alpha-1,6-glucan ether compound of embodiment 10, wherein the substituted ammonium group comprises a quaternary ammonium group.
12. A poly alpha-1,6-glucan ether compound of embodiment 11, wherein the quaternary ammonium group comprises at least one C₁ to C₁₈ alkyl group.
13. A poly alpha-1,6-glucan ether compound of embodiment 11 or 12, wherein the quaternary ammonium group comprises at least one C₁ to C₄ alkyl group.
14. A poly alpha-1,6-glucan ether compound of embodiment 11, 12, or 13, wherein the quaternary ammonium group comprises at least one C₁₀ to C₁₆ alkyl group.
15. A poly alpha-1,6-glucan ether compound of embodiment 11, 12, 13, or 14, wherein the quaternary ammonium group further comprises two C₁ to C₄ alkyl groups.
16. A poly alpha-1,6-glucan ether compound of embodiment 1, 2, 3, 4, 5, 6, 7, 8, 9, 10, 11, 12, 13, 14, or 15, wherein the quaternary ammonium group comprises a trimethylammonium group.
17. A poly alpha-1,6-glucan ether compound of embodiment 1, 2, 3, 4, 5, 6, 7, 8, 9, 10, 11, 12, 13, 14, 15, or 16, wherein the positively charged organic group comprises a quaternary ammonium hydroxyalkyl group.
18. A poly alpha-1,6-glucan ether compound of embodiment 17, wherein the quaternary ammonium hydroxyalkyl group comprises a quaternary ammonium hydroxymethyl group, a quaternary ammonium hydroxyethyl group, or a quaternary ammonium hydroxypropyl group.
19. A poly alpha-1,6-glucan ether compound of embodiment 17 or 18, wherein the quaternary ammonium hydroxyalkyl group comprises a trimethylammonium hydroxyalkyl group.
20. A poly alpha-1,6-glucan ether compound of embodiment 19, wherein the trimethylammonium hydroxyalkyl group is a trimethylammonium hydroxypropyl group.
21. A composition comprising a poly alpha-1,6-glucan ether compound of embodiment 1, 2, 3, 4, 5, 6, 7, 8, 9, 10, 11, 12, 13, 14, 15, 16, 17, 18, 19, or 20.
22. A composition of embodiment 21, in the form of a liquid, a gel, a powder, a hydrocolloid, an aqueous solution, a granule, a tablet, a capsule, a bead or pastille, a single compartment sachet, a pad, a multi-compartment sachet, a single compartment pouch, or a multi-compartment pouch.
23. A composition of embodiment 22, further comprising at least one of an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer-inhibiting agent, a chelating agent, a hueing dye, a calcium cation, a magnesium cation, a visual signaling ingredient, an anti-foam, a structurant, a thickener, an anti-caking agent, a starch, sand, a gelling agent, or a combination thereof.
24. A composition of embodiment 23, wherein the enzyme is a cellulase, a protease, an amylase, or a combination thereof.
25. A personal care product, a home care product, an industrial product, or a fabric care product comprising a composition of embodiment 21, 22, 23, or 24.
26. A personal care product comprising a poly alpha-1,6-glucan ether compound of embodiment 1, 2, 3, 4, 5, 6, 7, 8, 9, 10, 11, 12, 13, 14, 15, 16, 17, 18, 19, or 20.
27. A home care product comprising a poly alpha-1,6-glucan ether compound of embodiment 1, 2, 3, 4, 5, 6, 7, 8, 9, 10, 11, 12, 13, 14, 15, 16, 17, 18, 19, or 20.
28. An industrial product comprising a poly alpha-1,6-glucan ether compound of embodiment 1, 2, 3, 4, 5, 6, 7, 8, 9, 10, 11, 12, 13, 14, 15, 16, 17, 18, 19, or 20.
29. A product comprising the poly alpha-1,6-glucan ether compound of embodiment 1, 2, 3, 4, 5, 6, 7, 8, 9, 10, 11, 12, 13, 14, 15, 16, 17, 18, 19, or 20, wherein (i) the product further comprises one or more of a perfume, fragrance, flavor, air odor-reducing agent, insect repellent, insecticide, bubble-generating agent, non-woven material, colorant, preservative, antioxidant, emulsifier, emollient, oil, medicament, or suspending agent; and/or (ii) the product is a disinfecting product, cleaning product, coating product, wipe, or hard surface cleaner such as for a floor, countertop, table, desk, tub/shower, sink, toilet bowl, door/cabinet handle/panel, or glass/window; wherein the product is not a fabric care product or dish care product.
30. A method for treating a substrate, the method comprising the steps: (a) providing a composition of embodiment 21, 22, 23, 24, 25, 26, 27, or 28; (b) contacting the substrate with the composition; and (c) optionally rinsing the substrate; wherein the substrate is not a fabric substrate or dish substrate. 30. The method of embodiment 29, wherein the substrate is a surface.

Further non-limiting examples of the embodiments disclosed herein include:
A. A composition, such as any disclosed herein, comprising: a poly alpha-1,6-glucan ether compound comprising a poly alpha-1,6-glucan substituted with at least one positively charged organic group, wherein the poly alpha-1,6-glucan comprises a backbone of glucose monomer units, wherein at least 65% of the glucose monomer units are linked via alpha-1,6 glycosidic linkages, and wherein the poly alpha-1,6-glucan ether compound is characterized by: i) a weight average degree of polymerization of at least 5 (e.g., about 500-2000), and ii) a degree of substitution of about 0.001 to about 3.0.
B1. A composition, such as any disclosed herein, comprising: a poly alpha-1,6-glucan ether compound comprising a poly alpha-1,6-glucan substituted with at least one positively charged organic group, wherein the poly alpha-1,6-glucan comprises a backbone of glucose monomer units, wherein at least 65% of the glucose monomer units are linked via alpha-1,6 glycosidic linkages, and wherein the poly alpha-1,6-glucan ether compound is characterized by: a) a weight average molecular weight of about 1000 to about 500,000 daltons (e.g., about 80000-500000 daltons), and/or b) having been derived from a poly alpha-1,6-glucan having a weight average molecular weight of about 900 to about 450,000 daltons (e.g., about 50000-450000 daltons), as determined prior to substitution with the least one positively charged organic group; wherein the poly alpha-1,6-glucan ether compound is further characterized by a degree of substitution of about 0.001 to about 3.0.
B2. A composition, such as any disclosed herein, comprising: a poly alpha-1,6-glucan ether compound comprising a poly alpha-1,6-glucan substituted with at least one positively charged organic group, wherein the poly alpha-1,6-glucan ether compound is characterized by: (a) a weight average molecular weight of about 1000-150000, 5000-100000, 10000-80000, or 20000-60000 daltons, (b) a backbone of glucose monomer units wherein greater than or equal to 65% of the glucose monomer units are linked via alpha-1,6-glycosidic linkages, (c) about 20-60%, 30-60%, 30-50%, 35-45%, or 40% of the glucose monomer units have branches via alpha-1,2- and/or alpha-1,3-glycosidic linkages, and (d) a degree of cationic substitution of about 0.001 to about 3.0.
C. The composition of any of paragraphs A, B1, or B2, wherein at least 3%, or at least about 5%, preferably about 5% to about 35%, more preferably about 5% to about 30%, more preferably about 5% to about 30%, more preferably about 5% to about 25%, even more preferably about 5% to about 20% of the backbone glucose monomer units have branches via alpha-1,2 and/or alpha-1,3 glycosidic linkages.
D. The composition of any of paragraphs A-C, wherein the positively charged organic group comprises a substituted ammonium group, preferably a quaternary ammonium group.
E. The composition of paragraph D, wherein the quaternary ammonium group comprises at least one C₁ to C₁₈ alkyl group.
F. The composition of any of paragraphs D or E, wherein the quaternary ammonium group comprises at least one C₁ to C₄ alkyl group.
G. The composition of any of paragraphs D-F, wherein the quaternary ammonium group comprises at least one C₁₀ to C₁₆ alkyl group, preferably wherein the quaternary ammonium group further comprises two C₁ to C₄ alkyl groups.
H. The composition of any of paragraphs D-G, wherein the quaternary ammonium group comprises a trimethylammonium group.
I. The composition of any of paragraphs A-H, wherein the positively charged organic group comprises a quaternary ammonium hydroxyalkyl group, preferably wherein the quaternary ammonium hydroxyalkyl group comprises a quaternary ammonium hydroxymethyl group, a quaternary ammonium hydroxyethyl group, or a quaternary ammonium hydroxypropyl group.
J. The composition paragraph I, wherein the quaternary ammonium hydroxyalkyl group comprises a trimethylammonium hydroxyalkyl group, preferably a trimethylammonium hydroxypropyl group.
K. The composition of any of paragraphs A-J, wherein the degree of substitution is about 0.01 to about 1.5, preferably about 0.01 to about 1.0, more preferably about 0.01 to about 0.8, more preferably about 0.03 to about 0.7, or about 0.04 to about 0.6, or about 0.05 to about 0.5.
L. The composition of any of paragraphs A-K, wherein the poly alpha-1,6-glucan ether compound has a weight average degree of polymerization in the range of about 5 to about 6000, preferably about from 50 to 5000, or 100 to 4000, or 250 to 3000, or 500 to 2000, or 750 to 1500, or 1000 to 1400, or 1100 to 1300.
M. The composition of any of paragraphs A-L, wherein the poly alpha-1,6-glucan ether compound is characterized by a weight average molecular weight of about 10,000 to about 400,000 daltons, or about 40,000 to about 300,000 daltons, or about 80,000 to about 300,000 daltons, or about 100,000 to about 250,000 daltons, or about 150,000 to about 250,000 daltons, or about 180,000 to about 225,000 daltons, or about 180,000 to about 200,000 daltons.
N. The composition of any of paragraphs A-M, wherein the poly alpha-1,6-glucan ether compound is characterized by having been derived from a poly alpha-1,6-glucan having a weight average molecular weight of about 10,000 to about 350,000 daltons, or about 50,000 to about 350,000 daltons, or about 90,000 to about 300,000 daltons, or about 125,000 to about 250,000 daltons, or about 150,000 to about 200,000 daltons, as determined prior to substitution with the least one positively charged organic group.
O. The composition of any of paragraphs A-N, wherein the poly alpha-1,6-glucan comprises a backbone of glucose monomer units, wherein at least 70%, or at least 75%, or at least 80%, or at least 90%, or at least 95%, of the glucose monomer units are linked via alpha-1,6-glycosidic linkages.
P. The composition of any of paragraphs A-O, wherein the poly alpha-1,6-glucan ether compound is characterized by a weight average molecular weight of about 150,000 to about 225,000, a degree of substitution of about 0.05 to about 0.5, and where about 5% to about 20% of the backbone glucose monomer units have branches via alpha-1,2 and/or alpha-1,3 glycosidic linkages, preferably alpha-1,2 glycosidic linkages.
Q. The composition of any of paragraphs A-P, wherein the poly alpha-1,6-glucan ether compound is characterized by a biodegradability, as determined by the Biodegradability Test Method described herein (i.e., the Carbon Dioxide Evolution Test Method of OECD Guideline 301B), of at least 5% on the 90th day of the test duration, more preferably on the 60th day of the test duration, even more preferably a biodegradability of at least 10%, or of at least 15%, or of at least 20%, or of at least 25%, or of at least 30%, or of at least 35%, or of at least 40%, or of at least 45%, or of at least 50%, or of at least 55%, or of at least 60%, or of at least 65%, or of at least 70%, or of at least 75%, or of at least 80% by the 90th or 60th day of the test duration.
R. The composition of any of paragraphs A-Q, wherein the composition comprises about 0.01% to about 10%, or about 0.1% to about 5%, or about 0.1% to about 3%, or about 0.1% to about 2%, or about 0.1% to about 1%, or about 0.1% to about 0.8%, by weight of the composition, of the poly alpha-1,6-glucan ether compound.
S. The composition of any of paragraphs A-R, further comprising an ingredient selected from the group consisting of surfactants, conditioning actives, deposition aids, rheology modifiers or structurants, bleach systems, stabilizers, builders, chelating agents, dye transfer-inhibiting agents, dispersants, enzymes, and enzyme stabilizers, catalytic metal complexes, polymeric dispersing agents, clay and soil removal/anti-redeposition agents, brighteners, suds suppressors, silicones, hueing agents, aesthetic dyes, additional perfumes and perfume delivery systems, structure-elasticizing agents, carriers, hydrotropes, processing aids, anti-agglomeration agents, coatings, formaldehyde scavengers, pigments, and mixtures thereof.
T. The composition of any of paragraphs A-S, wherein the composition is in the form of a liquid composition, a granular composition, a hydrocolloid, a single-compartment pouch, a multi-compartment pouch, a dissolvable sheet, a pastille or bead, a fibrous article, a tablet, a stick, a bar, a flake, a foam/mousse, a non-woven sheet, or a mixture thereof.
U. The composition of any of paragraphs A-T, wherein the composition is a liquid characterized by a viscosity of about 1 to 1500 centipoise (1-1500 mPa*s), or 100 to 1000 centipoise (100-1000 mPa*s), or 100 to 500 centipoise (100-500 mPa*s), or 100 to 300 centipoise (100-300 mPa*s), or 100 to 200 centipoise (100-200 mPa*s) at 20 s⁻¹ and 21° C.
V. The composition of any of paragraphs A-U, wherein at least one of (a)-(d) is true: (a) the composition is in the form of a single-compartment pouch or a multi-compartment pouch, and wherein an additional ingredient comprises less than 20% water by weight of the composition, and optionally wherein the poly alpha-1,6-glucan ether compound is characterized by a weight average molecular weight of about 150,000 to about 225,000, a degree of substitution of from about 0.05 to about 0.4, and where about 5% to about 20% of the backbone glucose monomer units have branches via alpha-1,2 and/or alpha-1,3 glycosidic linkages, preferably alpha-1,2; or (b) the composition is in the form of particles, wherein individual particles have a mass of about 1 mg to about 1 gram, and wherein the particles comprise the poly alpha-1,6-glucan ether compound dispersed in a water-soluble carrier, preferably a water-soluble carrier selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, starch, and mixtures thereof; and optionally wherein the poly alpha-1,6-glucan ether compound is characterized by a weight average molecular weight of about 150,000 to about 225,000, a degree of substitution of about 0.1% to about 0.4%, and where about 5% to about 10% of the backbone glucose monomer units have branches via alpha-1,2 and/or alpha-1,3 glycosidic linkages, preferably alpha-1,2; or (c) the composition is in the form of a liquid, the composition comprising about 40% to about 95%, by weight of the composition, of water, the composition further comprising about 5% to about 50%, by weight of the composition, of surfactant, and optionally wherein the poly alpha-1,6-glucan ether compound is characterized by a weight average molecular weight of about 150,000 to about 225,000, a degree of substitution of about 0.05 to about 0.4, and where from about 5% to about 20% of the backbone glucose monomer units have branches via alpha-1,2 and/or alpha-1,3 glycosidic linkages, preferably alpha-1,2; or (d) the composition is in the form of a liquid, the composition comprising about 40% to about 98%, by weight of the composition, of water, and about 1% to about 35%, by weight of the composition, of a fabric softening agent, preferably a quaternary ammonium compound and/or a silicone, and optionally wherein the poly alpha-1,6-glucan ether compound is characterized by a weight average molecular weight of about 150,000 to about 225,000, a degree of substitution of from about 0.4 to about 0.5, and where from about 5% to about 10% of the backbone glucose monomer units have branches via alpha-1,2 and/or alpha-1,3 glycosidic linkages, preferably alpha-1,2.
W. A method of treating a surface with the composition according to any of paragraphs A-V, the method comprising the step of contacting the surface with the composition, optionally in the presence of water.

### EXAMPLES

Unless otherwise stated, all ingredients are available from Sigma-Aldrich, St. Louis, Missouri and were used as received. 3-Chloro-2-hydroxypropyltrimethylammonium chloride (QUAB 188), glycidyltrimethylammonium chloride (also referred to as 2,3-epoxypropyltrimethylammonium chloride) (QUAB 151), and 3-chloro-2-hydroxypropyl dodecyldimethylammonium chloride (QUAB 342) were obtained from SKW QUAB Chemicals.

As used herein, “Comp. Ex.” Means Comparative Example; “Ex.” means Example; “std dev” means standard deviation; “g” means gram(s); “kg” means kilogram(s); “mL” means milliliter(s); “uL” means microliter(s); “wt” means weight; “L” means liter(s); “min” means minute(s); “kDa” means kilodaltons; “PES” means polyethersulfone.

### Method for Determining Anomeric Linkages by NMR Spectroscopy

Glycosidic linkages in water soluble oligosaccharides and polysaccharide products synthesized by a glucosyltransferase GTF8117 and alpha-1,2 branching enzyme were determined by ¹H NMR (Nuclear Magnetic Resonance Spectroscopy). Dry oligosaccharide/polysaccharide polymer (6 mg to 8 mg) was dissolved in a solution of 0.7 mL of 1 mM DSS (4,4-dimethyl-4-silapentane-1-sulfonic acid; NMR reference standard) in D₂O. The sample was stirred at ambient temperature overnight. 525 μL of the clear homogeneous solution was transferred to a 5 mm NMR tube. 2D ¹H, ¹³C homo/hetero-nuclear suite of NMR experiments were used to identify AGU (anhydroglucose unit) linkages. The data were collected at 20° C. and processed on a Bruker Avance III NMR spectrometer, operating at either 500 MHz or 600 MHz. The systems are equipped with a proton optimized, helium cooled cryoprobe. The 1D ¹H NMR spectrum was used to quantify glycosidic linkage distribution and finds the polysaccharide backbone as primarily alpha-1,6. The results reflect the ratio of the integrated intensity of a NMR resonance representing an individual linkage type divided by the integrated intensity of the sum of all peaks which represent glucose linkages, multiplied by 100.

### ¹H Nuclear Magnetic Resonance (NMR) Method for Determining Molar Substitution of Poly Alpha-1,6-Glucan Ether Derivatives

Approximately 30 mg of poly alpha-1,6-glucan ether derivative was weighed into a vial on an analytical balance. The vial was removed from the balance and 1.0 mL of deuterium oxide was added to the vial. A magnetic stir bar was added to the vial and the mixture was stirred to suspend the solid. Deuterated sulfuric acid (50% v/v in D₂O), 1.0 mL, was then added to the vial and the mixture was heated at 90° C. for 1 hour in order to depolymerize and solubilize the polymer. The solution was allowed to cool to room temperature and then a 0.8-mL portion of the solution was transferred into a 5-mm NMR tube using a glass pipet. A quantitative 1H NMR spectrum was acquired using an Agilent VNMRS 400 MHZ NMR spectrometer equipped with a 5-mm Autoswitchable Quad probe. The spectrum was acquired at a spectral frequency of 399.945 MHZ, using a spectral window of 6410.3 Hz, an acquisition time of 3.744 seconds, an inter-pulse delay of 10 seconds and 64 pulses. The time domain data were transformed using exponential multiplication of 0.50 Hz.

Determination of Weight Average Molecular Weight and/or Degree of Polymerization

Degree of polymerization (DP) was determined by size-exclusion chromatography (SEC). For SEC analysis, dry poly alpha-1,6-glucan ether derivative was dissolved in phosphate-buffered saline (PBS) (0.02-0.2 mg/mL). The chromatographic system used was an Alliance™ 2695 liquid chromatograph from Waters Corporation (Milford, MA) coupled with three on-line detectors: a differential refractometer 410 from Waters, a multi-angle light-scattering photometer Heleos™ 8+ from Wyatt Technologies (Santa Barbara, CA), and a differential capillary viscometer ViscoStar™ from Wyatt Technologies. The columns used for SEC were two Tosoh Haas Bioscience TSK GMPW_{XL} g3K and g4K G3000 PW and G4000 PW polymeric columns for aqueous polymers. The mobile phase was PBS. The chromatographic conditions used were 30° C. at column and detector compartments, 30° C. at sample and injector compartments, a flow rate of 0.5 mL/min, and injection volume of 100 μL. The software packages used for data reduction were Astra version 6 from Wyatt (triple detection method with column calibration).

### Milliequivalents Calculation

As used herein, the term “Cationic Charge Density (CCD) per dose” means the amount of positive charge present in a volume of a single dose of fabric conditioner composition to be dispensed. By way of example, assuming a fabric conditioner dose of 48.5 g containing 0.48% of a cationic polymer having a monomer average molecular weight of 220 g/mol and a degree of cationic substitution of 0.38, the CCD is calculated as follows: polymer charge density is 0.38/220×1000 or 1.7 meq/g, and the CCD is 48.5g×0.0048×1.7 meq/g, or 0.40 meq per dose.

### Zeta Potential Measurement

Zeta potential is measured using a Malvern Zeta Sizer ZEN3600 and a disposable capillary sample cell (green cell). The instrument is calibrated using zeta potential transfer standard DTS 1235, Batch #311808, −42 mV+/−4.2 m to assure proper instrument function. Flush the capillary cell with 1-2 mL ethanol, then with DI water before starting of the experiment. Samples are prepared by mixing 99.75 g the Tide HDL solution at the target concentration with 0.25 g of the fabric conditioner composition. Tide HDL solution is prepared by diluting the target amount of Tide HDL detergent using 7 gpg water hardness. Sample is transferred to the capillary sample cell using a syringe, making sure that no air bubbles are present in the cell. Cell is filled to the top, then place a cap on the cell outlet and inlet, again making sure no air bubbles are present in the sample. Finally, place the cell in the sample chamber, with the electrodes facing the sides of the system. The experiment is run using a refractive index of 1.46 (this number may vary for suspensions and one can measure the refractive index for any particulate suspension using a refractometer), a temperature of 25° C., and a 120 second equilibration time. The instrument uses the Smoluchowski model to calculate the zeta potential of the sample.

### Biodegradation Test Method

The biodegradability of the polysaccharide derivative is determined following the OECD 301B Ready Biodegradability CO₂ Evolution Test Guideline (see OECD, 1992. Organization for Economic Co-operation and Development, OECD 301 Ready Biodegradability. OECD Guidelines for the Testing of Chemicals, Section 3-herein incorporated by reference). In this study, the test substance is the sole carbon and energy source, and under aerobic conditions, microorganisms metabolize the test substance producing CO₂ or incorporating the carbon into biomass. The amount of CO₂ produced by the test substance (corrected for the CO₂ evolved by the blank inoculum) is expressed as a percentage of the theoretical amount of CO₂ (ThCO₂) that could have been produced if the organic carbon in the test substance was completely converted to CO₂.

### Homogenization

Homogenization was performed using an IKA ULTRA TURRAX T25 Digital Homogenizer (IKA, Wilmington, NC).

### Fabric Preparation

To assess performance of a conditioning composition and/or polymer contained therein, fabrics were prepared/treated according to the following method.

### A. Equipment and Materials

Fabrics are assessed using Kenmore FS 600 and/or 80 series washer machines. Wash Machines are set at: 32° C./15° C. wash/rinse temperature, 6 gpg hardness, normal cycle, and medium load (64 liters). Fabric bundles consist of 2.5 kilograms of clean fabric consisting of 100% cotton. Test swatches are included with this bundle and comprise of 100% cotton Euro Touch terrycloth towels (purchased from Standard Textile, Inc. Cincinnati, OH).

### B. Stripping and Desizing

Prior to treatment with any test products, the fabric bundles are stripped according to the Fabric Preparation-Stripping and Desizing procedure before running the test.

The Fabric Preparation-Stripping and Desizing procedure includes washing the clean fabric bundle (2.5 Kg of fabric comprising 100% cotton) including the test swatches of 100% cotton EuroTouch terrycloth towels for 5 consecutive wash cycles followed by a drying cycle. AATCC (American Association of Textile Chemists and Colorists) High Efficiency (HE) liquid detergent is used to strip/de-size the test swatch fabrics and clean fabric bundle (1× recommended dose per wash cycle). The wash conditions are as follows: Kenmore FS 600 and/or 80 series wash machines (or equivalent), set at: 48° C./48° C. wash/rinse temperature, water hardness equal to 0 gpg, normal wash cycle, and medium sized load (64 liters). The dryer timer is set for 55 minutes on the cotton/high/timed dry setting.

### C. Test Treatment

Tide Free liquid detergent (1× recommended dose) is added under the surface of the water after the machine is at least half full. Once the water stops flowing and the washer begins to agitate, the clean fabric bundle is added. When the machine is almost full with rinse water, and before agitation has begun, the fabric care testing composition (e.g., the liquid conditioning composition) is slowly added (1× dose), ensuring that none of the fabric care testing composition comes in direct contact with the test swatches or fabric bundle. When the wash/rinse cycle is complete, each wet fabric bundle is transferred to a corresponding dryer. The dryer used is a Maytag commercial series (or equivalent) electric dryer, with the timer set for 55 minutes on the cotton/high heat/timed dry setting. This process is repeated for a total of three (3) complete wash-dry cycles. After the third drying cycle and once the dryer stops, 12 Terry towels from each fabric bundle are removed for actives deposition analysis. The fabrics are then placed in a constant Temperature/Relative Humidity (21° C., 50% relative humidity) controlled grading room for 12-24 hours and then graded for softness and/or actives deposition.

### Secant Modulus Instron Method

The Secant Modulus is measured using a Tensile and Compression Tester Instrument, such as the Instron Model 5565 (Instron Corp., Norwood, Massachusetts, U.S.A.). The instrument is configured depending on the fabric type by selecting the following settings: the mode is Tensile Extension; the Waveform Shape is Triangle; the Maximum Strain is 10% for 479 Sanforized and 35% for 7422 Knitted, the Rate is 0.83 mm/sec for 479 Sanforized and 2.5 mm/sec for 7422 Knitted, the number of Cycles is 4; and the Hold time is 15 seconds between cycles.
1. With scissors, cut serged edge of one entire side of each swatch in the warp direction and carefully peel off strings without stressing the fabric until an even edge is achieved.
2. Place a fabric press die that cuts strips 1″ wide and at least 4″ long parallel to the even edge and cut strips lengthwise in the warp direction.
3. Cut 3 strips of test fabric 479 Sanforized 100% cotton woven or test fabric 7422 50:50 polycotton knitted from 3 separate fabric swatches per treatment. Condition fabrics in a constant temperature (70° F.) and humidity (50% RH) room for at least 6 hours before analysis.
4. Clamp the top and then the bottom of fabric strip into the 2.54 cm grips on the tensile tester instrument with a 2.54 cm gap setting, loading a small amount of force (0.0.05N-0.2N) on the sample.
5. Release bottom clamp and re-clamp sample during the hold cycle, loading 0.05N-0.2N of force on the sample removing the slack by again loading the same force.
6. When 4 hysteresis cycles have been completed for the sample, Secant Modulus is reported in megapascal (MPa). The final result is the average of the individual cycle 4 modulus results from all test strips for a given treatment on a given fabric type. The Secant Modulus reported is calculated at the Maximum Strain for each fabric type.

### Method for Determining Viscosity

The viscosity of the fabric conditioning composition is measured using a TA instrument AR G2 controlled stress rheometer, with a concentric cylinder geometry. Temperature is held constant at 20° C. for 2 minutes before starting of the test. Viscosity is then measured at different shear rates from 0.01 to 100 sec-1 using a logarithmic steady state flow ramp of 5 points per decade going upwards.

### Technical Olfactive Panel

The dry olfactive performance of cotton terry towels from Calderon Textiles is assessed by a panel of 20 experts after dry fabrics equilibrate overnight in constant 70° F. temperature and 50% humidity room. Comparisons are made using an intensity scale from 0 to 10 where 0 means not detectable, 1-3: slight fragrance, 4-7: moderate fragrance, 8-10: strong fragrance. Panelists grades are converted to a 10-100 scale and averaged across all 20 panelists.

### Determining Coefficient of Friction (CoF)

To determine the Coefficient of Friction (CoF or kCoF, for kinetic Coefficient of Friction), the following method is used.

Five fabrics (32 cm×32 cm 100% cotton terry wash cloths, such as RN37002LL from Calderon Textiles, Indianapolis, Indiana, USA) are treated three times with standard wash/dry cycles.

When the 3^{rd} drying cycle is completed, the treated fabric cloths are equilibrated for a minimum of 8 hours at 23° C. and 50% Relative Humidity. Treated fabrics are laid flat and stacked no more than 10 cloths high while equilibrating. Friction measurements for the test product and nil-polymer control product are made on the same day under the same environmental conditions used during the equilibration step.

A friction/peel tester with a 2 kilogram force load cell is used to measure fabric to fabric friction (such as model FP2250, Thwing-Albert Instrument Company, West Berlin, New Jersey, USA). A clamping style sled with a 6.4×6.4 cm footprint and weight of 200 g is used (such as item number 00225-218, Thwing Albert Instrument Company, West Berlin, New Jersey, USA). The distance between the load cell and the sled is set at 10.2 cm. The distance between the crosshead arm and the sample stage is adjusted to 25 mm, as measured from the bottom of the cross arm to the top of the stage. The instrument is configured with the following settings: T2 kinetic measure time of 10.0 seconds, total measurement time of 20.0 seconds, test rate of 20 cm/minute.

The terry wash cloth is placed tag side down and the face of the fabric is then defined as the side that is upwards. If there is no tag and the fabric is different on the front and back, it is important to establish one side of the terry fabric as being designated “face” and be consistent with that designation across all terry wash cloths. The terry wash cloth is then oriented so that the pile loops are pointing toward the left. An 11.4 cm×6.4 cm fabric swatch is cut from the terry wash cloth using fabric shears, 2.54 cm in from the bottom and side edges of the cloth. The fabric swatch should be aligned so that the 11.4 cm length is parallel to the bottom of the cloth and the 6.4 cm edge is parallel to the left and right sides of the cloth. The wash cloth from which the swatch was cut is then secured to the instrument's sample table while maintaining this same orientation.

The 11.4 cm×6.4 cm fabric swatch is attached to the clamping sled with the face side outward so that the face of the fabric swatch on the sled can be pulled across the face of the wash cloth on the sample plate. The sled is then placed on the wash cloth so that the loops of the swatch on the sled are oriented against the nap of the loops of the wash cloth. The sled is attached to the load cell. The crosshead is moved until the load cell registers 1.0-2.0 gf (gram force), and is then moved back until the load reads 0.0 gf. Next, the measurement is started and the Kinetic Coefficient of Friction (kCOF) is recorded by the instrument every second during the sled drag.

For each wash cloth, the average kCOF over the measurement time frame of 10 seconds to 20 seconds is calculated:

$$f = ( {kCOF}_{10 s} + {kCOF}_{11 s} + {kCOF}_{12 s} + … + {kCOF}_{20 s} ) / 12$$

Then the average kCOF of the five wash cloths per product is calculated:

$$F = ( {f}_{1} + {f}_{2} + {f}_{3} + {f}_{4} + {f}_{5} ) / 5$$

The Friction Change for the test product versus the control detergent is calculated as follows:

$${F}_{( control )} - {F}_{( test product )} = Friction Change$$

### Formulation Ingredients

For formulation Examples below, ingredients are according to the following key unless otherwise indicated:

| | |
|---|---|
| Fabric Softening Active | N,N-di(alkanoyloxyethyl)-N,N-dimethylammonium |
| 1 | chloride where alkyl consists predominantly of C₁₆-C₁₈ |
| | alkyl chains with an IV value of about 20, available from |
| | Evonik |
| Fabric Softening Active | C₁₈ Unsaturated DEEHMAMS (Diethyl Ester |
| 2 | Hydroxyethyl Methyl Ammonium Methyl Sulphate), |
| | available from Evonik |
| Fabric Softening Active | Esterification product of fatty acids (C₁₆₋₁₈ and C₁₈ |
| 3 | unsaturated) with triethanolamine, quaternized with |
| | dimethyl sulphate (REWOQUAT WE 18, ex Evonik) |
| Amino-functional | As described in U.S. Pat. Appl. Publ. Nos. |
| Organosiloxane | 2011/0243878 and/or US2012/0323032, which are |
| | incorporated herein by reference |
| Crosslinked Structuring | Dimethylamino Ethyl Acrylate methochloride ((DMA3) + |
| Polymer | Acrylamide (AM) in a 60:40 weight ratio, respectively); |
| | 375 ppm Pentaerythrityl triacrylate/pentaerythrityl |
| | tetraacrylate (PETIA) cross-linker; 0 ppm chain transfer |
| | agent. |
| Quaternized | Dimethylamino Ethyl Acrylate methochloride ((DMA3) + |
| Polyacrylamide | Acrylamide (AM) in a 60:40 weight ratio, respectively); |
| | 10 ppm Pentaerythrityl triacrylate/pentaerythrityl |
| | tetraacrylate (PETIA) cross-linker; 0 ppm chain transfer |
| | agent. |
| Flowsoft FS 222 | Available from SNF Floerger |
| Quaternary Ammonium | Details provided in each Example for presently |
| Poly alpha-1,6-glucan | disclosed quaternary ammonium poly alpha-1,6-glucan |
| Encapsulated Perfume | Perfume encapsulates (melamine-formaldehyde shells, |
| | with deposition aid coating); obtained from Encapsys, |
| | Inc. (Appleton, Wis., USA) |
| Cat HEC | Cationically-modified hydroxyethylcellulose |
| Aminosilicone | PDMS with propoxylated pendant diamino groups |

### Preparation of Poly Alpha-1,6-Glucan Samples

Methods to prepare poly alpha-1,6-glucan containing various amounts of alpha-1,2 branching are disclosed in published patent application WO2017/091533, which is incorporated herein by reference. Reaction parameters such as sucrose concentration, temperature, and pH can be adjusted to provide poly alpha-1,6-glucan having various levels of alpha-1,2-branching and molecular weight. A representative procedure for the preparation of alpha-1,2-branched poly alpha-1,6-glucan is provided below (containing 24% alpha-1,2-branching and 76% alpha-1,6 linkages). The 1D 1H NMR spectrum was used to quantify glycosidic linkage distribution. Additional samples of poly alpha-1,6-glucan with alpha-1,2-branching were prepared similarly. For example, one sample contained 32% alpha-1,2-branching and 68% alpha-1,6 linkages, another contained 10% alpha-1,2-branching and 90% alpha-1,6 linkages, and another contained 5% alpha-1,2-branching and 90% alpha-1,6 linkages.

Preparation of Poly Alpha-1,6-Glucan with 24% Alpha-1,2 Branching

Soluble alpha-1,2-branched poly alpha-1,6-glucan was prepared using stepwise combination of glucosyltransferase GTF8117 and alpha-1,2 branching enzyme GTFJ18T1, according to the following procedure.

A reaction mixture (2 L) comprised of sucrose (450 g/L), GTF8117 (9.4 U/mL), and 50 mM sodium acetate was adjusted to pH 5.5 and stirred at 47° C. Aliquots (0.2-1 mL) were withdrawn at predetermined times and quenched by heating at 90° C. for 15 min. The resulting heat-treated aliquots were passed through 0.45-μm filter. The flow-through was analyzed by HPLC to determine the concentration of sucrose, glucose, fructose, leucrose, oligosaccharides and polysaccharides. After 23.5 h, the reaction mixture was heated to 90° C. for 30 minutes. An aliquot of the heat-treated reaction mixture was passed through 0.45-μm filter and the flow through was analyzed for soluble mono/disaccharides, oligosaccharides, and polysaccharides. A major product was linear dextran with a DPw of 93.

A second reaction mixture was prepared by adding 238.2 g of sucrose and 210 mL of alpha-1,2-branching enzyme GTFJ18T1 (5.0 U/mL) to the leftover heat-treated reaction mixture that was obtained from the GTF8117 reaction described immediately above. The mixture was stirred at 30° C. with a volume of ˜2.2 L. Aliquots (0.2-1 mL) were withdrawn at predetermined times and quenched by heating at 90° C. for 15 min. The resulting heat-treated aliquots were passed through 0.45-μm filter. The flow-through was analyzed by HPLC to determine the concentration of sucrose, glucose, fructose, leucrose, oligosaccharides and polysaccharides. After 95 h, the reaction mixture was heated to 90° C. for 30 minutes. An aliquot of the heat-treated reaction mixture was passed through 0.45-μm filter and the flow-through was analyzed for soluble mono/disaccharides, oligosaccharides, and polysaccharides. Leftover heat-treated mixture was centrifuged using 1 L centrifugation bottles. The supernatant was collected and cleaned more than 200-fold using ultrafiltration system with 1 or 5 KDa MWCO cassettes and deionized water. The cleaned oligo/polysaccharide product solution was dried. Dry sample was then analyzed by 1H NMR spectroscopy to determine the anomeric linkages of the oligosaccharides and polysaccharides.

### Example 1

This Example describes preparation of a quaternary ammonium poly alpha-1,6-glucan ether compound, specifically trimethylammonium hydroxypropyl poly alpha-1,6-glucan.

Polysaccharide solution (43% solids, 7.3 kg; alpha-1,6-glucan with 32% alpha-1,2-branching and 68% alpha 1,6 linkages, Mw 53 kDa) was charged into a 22 L reactor equipped with an overhead stirrer. To the stirring solution was added 2.72 kg of 50% NaOH solution. The mixture was heated to 50° C. To this was added 7.6 kg of a 65% solution of 3-chloro-2-hydroxypropyltrimethylammonium chloride (QUAB 188) with an addition funnel over 2 hours and 45 min. The reaction was then kept at 58° C. for 3 hours. The reaction was diluted with water (500 mL), and neutralized with 18 wt % HCl. The product was purified by ultrafiltration (10-kDa membrane), and freeze-dried. The degree of substitution of the product was determined to be 0.4 by 1H NMR.

### Example 2

This Example describes preparation of a quaternary ammonium poly alpha-1,6-glucan ether compound, specifically trimethylammonium hydroxypropyl poly alpha-1,6-glucan.

To a 1-L round bottom flask equipped with an overhead stirrer was added 100 mL water, followed by 100 g of polysaccharide (alpha-1,6-glucan with 10% alpha-1,2-branching and 90% alpha 1,6 linkages, Mw 60 kDa). After dissolution, 50% sodium hydroxide solution was added (87 g) over 5-10 min. The mixture was stirred at room temperature for 1 hour. To this was added 265 g of a 60% solution of 3-chloro-2-hydroxypropyltrimethylammonium chloride (QUAB 188) over an additional 10 min. The mixture was heated at 60° C. under nitrogen for 3 hours. The mixture was cooled to about 50° C., and neutralized with 18% HCl. The resulting solution was diluted with water (4 L) and the product was purified by ultrafiltration (30-kDa membrane), and freeze dried. The degree of substitution of the product was determined to be 0.6 by 1H NMR.

### Example 3

This Example describes preparation of a quaternary ammonium poly alpha-1,6-glucan ether compound, specifically trimethylammonium propyl poly alpha-1,6-glucan.

To a 2-L reactor equipped with an overhead stirrer was added 690 g of a polysaccharide solution (29% solids; alpha-1,6-glucan with 5% alpha-1,2-branching and 95% alpha 1,6 linkages, Mw 185 kDa). The solution was stirred. To this stirring solution was added 12 g of 50% sodium hydroxide dropwise. The mixture was stirred at room temperature for 45 min. To this stirring mixture was added 100 g 71-75% solution of glycidyltrimethylammonium chloride (QUAB 151). The mixture was heated for 4 hours at 60° C. The mixture was diluted with 200 mL water, and neutralized with 18 wt % HCl. The product was purified by ultrafiltration (30-kDa membrane), and freeze-dried. The degree of substitution of the product was determined to be 0.4 by 1H NMR.

### Example 4

This Example describes preparation of a quaternary ammonium poly alpha-1,6-glucan ether compound, specifically trimethylammonium propyl poly alpha-1,6-glucan.

To a 2-L reactor equipped with an overhead stirrer was added 690 g of a polymer solution (29% solids; alpha-1,6-glucan with 5% alpha-1,2-branching and 95% alpha 1,6 linkages, Mw 185 kDa). The solution was stirred. To this stirring solution was added 12 g of 50% sodium hydroxide dropwise. The mixture was stirred at room temperature for 45 min. To this stirring mixture was added 33 g 71-75% solution of glycidyltrimethylammonium chloride (QUAB 151). The mixture was heated for 4 hours at 60° C. The mixture was diluted with 200 mL water, and neutralized with 18 wt % HCl. The product was purified by ultrafiltration (30-kDa membrane), and freeze-dried. The degree of substitution of the product was determined to be 0.03 by 1H NMR.

### Example 5

This Example describes preparation of a quaternary ammonium poly alpha-1,6-glucan ether compound, specifically dodecyldimethylammonium hydroxypropyl poly alpha-1,6-glucan.

A 4-neck, 500-mL reactor equipped with a mechanical stir rod, thermocouple, and addition funnel was charged with 19 g of water. Polysaccharide (21 g, alpha-1,6-glucan with 32% alpha-1,2-branching and 68% alpha 1,6 linkages, Mw 68 kDa) was then added to provide a solution. The solution was stirred while 137 g of 40 wt %3-chloro-2-hydroxypropyl dodecyldimethylammonium chloride (QUAB 342) was added thereto. The resulting mixture was stirred at room temperature for 2 hours. Sodium hydroxide (15.8 g, 50 wt %) was added over a 10-minute period. The reaction mixture was heated to 60° C. (10 min) and stirred at 57-60° C. for 3 hours. After being cooled to 35° C., the reaction mixture was poured into water to a total volume about 3 L. The pH of the mixture was adjusted to about 7 by the addition of 18.5 wt % hydrochloric acid. The product was purified by using ultrafiltration (5-kDa membrane) and freeze-dried. The degree of substitution of the product was determined to be 0.4 by ¹H NMR.

### Example 6

This Example describes preparation of a quaternary ammonium poly alpha-1,6-glucan ether compound, specifically dodecyldimethylammonium hydroxypropyl poly alpha-1,6-glucan.

A 4-neck, 500-mL reactor equipped with a mechanical stir rod, thermocouple, and addition funnel was charged with 80 g of a 3-chloro-2-hydroxypropyl dodecyldimethylammonium chloride (QUAB 342) preparation containing 32 g of the chloride and 48 g water. Glucan powder (21 g, alpha-1,6-glucan with 32% alpha-1,2-branching and 68% alpha 1,6 linkages, Mw 68 kDa) was then added. The mixture was stirred at room temperature for 2 hours. Sodium hydroxide (10 g, 50 wt %) was added over a 10-minute period. Water (10 mL) was then added. The reaction mixture was heated to 60° C. (10 min) and stirred at 58-60° C. for 3 hours. After being cooled to 35° C., the reaction mixture was poured into water to a total volume of about 3 L. The pH of the mixture was adjusted to about 7 by the addition of 18.5 wt % HCl. The mixture was filtered and no solid was observed in the filter. The filtrate was purified by ultra-filtration (10K membrane), and then freeze-dried to render a product. The degree of substitution of the product was determined to be 0.4 by 1H NMR.

### Example 7

This Example describes various quaternary ammonium poly alpha-1,6-glucan ether compounds produced according to the presently disclosed procedures. In the compounds listed in Table 1 below, the cationic group is a quaternary ammonium group substituted with three methyl groups (i.e., trimethyl ammonium), unless otherwise indicated with one asterisk (*). The quaternary ammonium group in each compound is linked to the ether group (and thus to the glucan backbone) by a hydroxypropyl group, but any suitable alkyl group or other hydroxyalkyl group could be used to link, accordingly.

TABLE 1

| | Poly Alpha-1,6-Glucan Cationic Ether | | |
|---|---|---|---|
| | | | Degree of |
| | Backbone | | Alpha-1,2 |
| Polymer | MW (kDa) | DoS | Branching |
| A | 40 | 0.5 | 40% |
| B | 40 | 0.5 | 40% |
| | (75)** | | |
| C | 17 | 0.3 | 40% |
| D | 40 | 0.4* | 40% |
| | (59)** | | |
| E | 40 | 0.26* | 40% |
| F | 40 | 0.8 | 40% |
| | (84)** | | |
| G | 109 | 0.51 | 26% |
| | (148)** | | |
| H | 194 | 0.50 | 41% |
| | (245)** | | |
| I | 194 | 0.7 | 41% |
| | (269)** | | |
| J | 185 | 0.15 | 5% |
| K | 185 | 0.38 | 5% |
| L | 185 | 0.03 | 5% |
| M | 200 | 0.21 | 20% |
| N | 200 | 0.19 | 10% |
| O | 185 | 0.05 | 5% |
| P | 185 | 0.40 | 20% |
| Q | 185 | 0.07 | 5% |
| R | 185 | 0.11 | 5% |
| S | 185 | 0.59 | 5% |
| T | 109 | 0.22 | 26% |

*Cationic group: quaternary ammonium group substituted with two methyl groups and one C₁₂ alkyl group (dimethyl, C12 ammonium group).
**Parenthetical number is molecular weight of ether compound (i.e., backbone plus derivatized cationic ether groups).

### Example 8. Softness Benefits

The following tests are run to show that the presence of poly alpha-1,6-glucan ether compound having a cationic charge can improve performance of a liquid conditioning composition.

Fabrics are treated according to the Fabric Preparation method provided above. The liquid conditioning compositions are liquid fabric enhancers according to the formulas shown below in Table 2. Formulas V and VI include a cationic poly alpha-1,6-glucan ether compound as disclosed herein; Formula IV does not and thus is a comparative example. For each test, 49.5 g/dose of liquid conditioning composition is provided. After fabric treatment, the Secant Modulus and freshness performance of the fabrics are determined using an Instron instrument according to the methods described above.

TABLE 2
Improving Fabric Secant Modulus

| Liquid Fabric Conditioning | IV | V | VI |
|---|---|---|---|
| Composition Ingredients | (comp.) | (inv.) | (inv.) |
| Fabric Softener Active 1 | 7.5% | 6.5% | 2.0% |
| Crosslinked Structuring | 0.12% | 0.12% | 0.12% |
| Polymer | | | |
| Quaternized Polyacrylamide | 0.04% | — | — |
| Quaternary Ammonium Poly | — | 0.24% | 1.0% |
| Alpha-1,6-Glucan | | | |
| (Polymer K, Table 1) | | | |
| Perfume | 1.2% | 1.2% | 1.2% |
| Encapsulated Perfume | 0.25% | 0.25% | 0.25% |
| Water, suds suppressor, | Complete | Complete | Complete |
| stabilizer, pH control agent, | to 100% | to 100% | to 100% |
| buffers, dyes | | | |
| Secant Modulus | 182 MPa | 157 MPa | 166 MPa |
| (479 Sanforized) | | | |

As shown in Table 2, addition of a cationically substituted poly-alpha-1,6-glucan ether compound according to the present disclosure can result in lower secant modulus measurements, which is correlated with improved softness, even when the composition contains a relatively lower amount of fabric softener active.

### Example 9. Softness and Freshness Benefits (1)

The following tests are run to show the effect of molecular weight of poly-alpha-1,6-glucan ether compounds on Secant Modulus values and on freshness benefits as determined by a Technical Olfactive Panel.

Fabrics are treated according to the Fabric Preparation method provided above. The liquid conditioning compositions are liquid fabric enhancers according to the formulas shown below in Table 3, and the cationic poly-alpha-1,6-glucan ether compounds used are as shown below in Table 4. Formula VIII (Table 3) includes a cationic poly-alpha-1,6-glucan ether compound as listed in Table 4; Formula VII does not and thus is a comparative example. For each test, 49.5 g/dose of liquid conditioning composition is provided. After treatment, the Secant Modulus and freshness performance of the fabric were determined using an Instron instrument and a technical olfactive panel according to the methods described above. Results are shown in Table 4.

TABLE 3
Liquid Fabric Conditioning Compositions

| | VII | VIII |
|---|---|---|
| Ingredient | (comp.) | (inv.) |
| Fabric Softener Active 1 | 4.5% | 4.5% |
| Crosslinked Structuring | 0.12% | 0.12% |
| Polymer | | |
| Quaternized Polyacrylamide | 0.04% | — |
| Quaternary Ammonium Poly | — | 0.48% |
| Alpha-1,6-Glucan (see Table 4 | | |
| below) | | |
| Perfume | 1.2% | 1.2% |
| Encapsulated Perfume | 0.25% | 0.25% |
| Water, suds suppressor, | Complete | Complete |
| stabilizer, pH control agent, | to 100% | to 100% |
| buffers, dyes | | |

TABLE 4
Secant Modulus and Freshness Performance of Liquid Fabric
Conditioning Compositions

| Cationic Poly Alpha-1,6-Glucan Ether | | | | Performance of Formula | |
|---|---|---|---|---|---|
| as Provided in Formula VIII | | | | VII or VIII | |
| Polymer | Backbone | | Degree of | Secant | Average Dry Fabric |
| (see | MW | | Alpha-1,2 | Modulus | Olfactive Panel |
| Table 1) | (kDa) | DoS | Branching | (MPa) | Grade |
| B | 40 | 0.5 | 40% | 213 | 34 |
| | (75)** | | | | |
| F | 40 | 0.8 | 40% | 200 | 36 |
| | (84)** | | | | |
| G | 109 | 0.51 | 26% | 204 | 47 |
| | (148)** | | | | |
| H | 194 | 0.50 | 41% | 218 | 42 |
| | (245)** | | | | |
| I | 194 | 0.7 | 41% | 184 | 40 |
| | (269)** | | | | |
| J | 185 | 0.15 | 5% | 194 | 44 |
| K | 185 | 0.38 | 5% | 166 | 46 |
| M | 185 | 0.21 | 20% | 185 | 44 |
| N | 185 | 0.19 | 10% | 197 | — |
| Formula VII | — | — | — | 214 | 36 |
| (comp.) | | | | | |

**Parenthetical number is molecular weight of ether compound (i.e., backbone plus derivatized cationic ether groups).

Relatively lower Secant Modulus values and/or relatively higher olfactive panel scores are associated with increased performance. Thus, the data in Table 4 indicate that poly-alpha-1,6-glucan ether compounds according to the present disclosure having a weight average molecular weight of, for example, greater than 100,000 Daltons can provide improved benefits.

### Example 10. Softness and Freshness Benefits (2)

The following tests are run to show the effect of DoS of poly-alpha-1,6-glucan ether compounds on Secant Modulus values.

Fabrics are treated according to the Fabric Preparation method provided above. The liquid conditioning compositions are liquid fabric enhancers according to the formulas shown below in Table 5, and the cationic poly-alpha-1,6-glucan ether compounds used are as shown below in Table 6. Formulas IX to XII include a cationic poly-alpha-1,6-glucan ether compound.

TABLE 5
Liquid Fabric Conditioning Compositions

| Ingredient | IX | X | XI | XII |
|---|---|---|---|---|
| Fabric Softener Active 1 | 4.5% | 4.5% | 4.5% | 4.5% |
| Crosslinked Structuring | 0.12% | 0.12% | 0.12% | 0.12% |
| Polymer | | | | |
| Quaternary Ammonium | 0.24% | 0.48% | 0.75% | 1.0% |
| Poly Alpha-1,6-Glucan | | | | |
| (see Table 6 below) | | | | |
| Perfume | 1.2% | 1.2% | 1.2% | 1.2% |
| Encapsulated Perfume | 0.25% | 0.25% | 0.25% | 0.25% |
| Water, suds suppressor, | Complete | Complete | Complete | Complete |
| stabilizer, pH control | to 100% | to 100% | to 100% | to 100% |
| agent, buffers, dyes | | | | |

For each test, 49.5 g/dose of liquid conditioning composition is provided. After treatment, the Secant Modulus and freshness performance of the fabric were determined using an Instron instrument and a technical olfactive panel according to the methods described above. Results are shown in Table 6, including the cationic charge density (CCD) delivered per dose (measured as above), as attributable to the included poly alpha-1,6-glucan ether compound.

TABLE 6
Secant Modulus and Freshness Performance of Liquid Fabric
Conditioning Compositions

| Formula | Cationic Poly Alpha- | | | Average |
|---|---|---|---|---|
| (see | 1,6-Glucan Ether as | meq | Secant | Dry Fabric |
| Table | Provided | CCD/ | Modulus | Olfactive |
| 5) | in Formula | dose | (MPa) | Panel Grade |
| IX | Polymer J¹ | 0.09 | 203 | 39 |
| X | Polymer J¹ | 0.19 | 191 | 44 |
| X | Polymer M¹ | 0.25 | 175 | 44 |
| XI | Polymer M¹ | 0.39 | 170 | 44 |
| X | Polymer K¹ | 0.40 | 166 | 46 |
| XII | Polymer M¹ | 0.53 | 143 | 48 |

¹See Table 1 for information regarding cationic poly alpha-1,6-glucan ethers of Polymers J, M and K.

Examples in Table 6 show that poly alpha-1,6-glucan ether compounds according to the present disclosure having a weight average molecular weight between about 185,000 to about 200,000 Da, and a relative low degree of branching of, for example, about 5% to about 20% (refer to Table 1 for MW and branching), provide improved benefits when the equivalents of cationic charge density per dose of fabric conditioner composition is above 0.1 milliequivalents.

### Example 11. Viscosity Effects

The following tests are run to show relative impact on viscosity of alpha-1,2-branching of cationic poly alpha-1,6-glucan ether compounds, including a comparison to a cationic poly alpha-1,3 glucan ether compound.

Liquid conditioning compositions having formulas according to Table 7 are prepared with different cationic glucan ethers as indicated below. The viscosity of each liquid conditioning composition is determined according to the method described above. Results are shown in Table 8.

TABLE 7
Liquid Fabric Conditioning Compositions

| | XII | |
|---|---|---|
| Ingredient | (comp.) | XIII |
| Fabric Softener Active 1 | 7.5% | 7.5% |
| Crosslinked Structuring Polymer | 0.15% | 0.15% |
| Cationic Glucan Ether | — | 0.48% |
| (type varies-see Table 8 below) | | |
| Perfume | 1.2% | 1.2% |
| Encapsulated Perfume | 0.25% | 0.25% |
| Water, suds suppressor, stabilizer, | Complete to | Complete to |
| pH control agent, buffers, dyes | 100% | 100% |

TABLE 8
Fabric Conditioner Viscosity @ 60 rpm

| | | Backbone | | Degree of | Viscosity | Viscosity |
|---|---|---|---|---|---|---|
| | | MW | | Alpha-1,2 | Pa-s | Pa-s |
| Formula | Polymer | (kDa) | DoS | Branching | (0.01 s⁻¹) | (0.1 s⁻¹) |
| XII | — | — | — | — | 7 | 4 |
| XIII | L¹ | 185 | 0.03 | 5% | 15 | 3 |
| XIII | J¹ | 185 | 0.15 | 5% | 34 | 11 |
| XIII | K¹ | 185 | 0.38 | 5% | 35 | 9 |
| XIII | S¹ | 185 | 0.59 | 5% | 40 | 12 |
| XIII | N¹ | 200 | 0.19 | 10% | 41 | 13 |
| XIII | Cationic | 120 | 0.4 | — | 142 | 29 |
| | Alpha-1,3- | | | | | |
| | Glucan | | | | | |
| | Ether² | | | | | |

¹See Table 1 for information regarding cationic poly alpha-1,6-glucan ethers of Polymers L, J, K, S and N.
²Cationic poly alpha-1,3-glucan ether compound with total MW of 145 kDa and derivatized with trimethylammonium hydroxypropyl groups.

As shown in Table 8, the product viscosity associated with poly alpha-1,6-glucan ether compounds in Formula XIII is relatively lower than the viscosity associated with a poly alpha-1,3-glucan ether. It is believed that addition of branching to the poly alpha-1,6-glucan ether disrupts internal interactions between poly alpha-1,6-glucan chains resulting in a less ordered crystalline structure that is easier to formulate into compositions without negatively impacting product viscosity. The lower viscosity can lead to an improved dispensing experience and less machine residue.

### Example 12. Example of Different Cationic Functional Groups

The following tests are run to show the impact of type of cationic functional group on fabric Secant Modulus.

Fabrics are treated according to the Fabric Preparation method provided above. The liquid conditioning compositions are liquid fabric enhancers according to Formula XIV shown below in Table 9A. For each test, 80 g/dose of fabric enhancer composition is provided. After treatment, the Secant Modulus of the fabrics are determined using an Instron instrument according to the methods described above; results are provided in Table 9B.

TABLE 9A

| Ingredient | XIV |
|---|---|
| Fabric Softener Active 1 | 11% |
| Amino-functional Organosiloxane | 3% |
| Crosslinked Structuring Polymer | 0.10% |
| Quaternized Polyacrylamide | 0.064% |
| Poly Alpha-1,6-Glucan Ether (see Table 9B) | 0.12% |
| Free Perfume | 2.05% |
| Encapsulated Perfume | 0.20% |
| Water, suds suppressor, stabilizer, pH control | Complete |
| agent, buffers, dyes | to 100% |

TABLE 9B
Secant Modulus of Liquid Fabric Conditioning Compositions

| | Cationic Poly Alpha-1,6-Glucan Ether | | | | |
|---|---|---|---|---|---|
| | | | | Degree of | |
| | Backbone | | Cationic | Alpha-1,2 | Secant |
| Polymer | MW (kDa) | DoS | Functional Group | Branching | Modulus |
| B¹ | 40 | 0.5 | Trimethylammonium | 40% | 151 MPa |
| | (75)** | | | | |
| D¹ | 40 | 0.4 | Dimethyl, C₁₂ | 40% | 143 MPa |
| | (59)** | | ammonium | | |
| E¹ | 40 | 0.26 | Dimethyl, C₁₂ | 40% | 140 MPa |
| | | | ammonium | | |

¹See Table 1 for information regarding cationic poly alpha-1,6-glucan ethers of Polymers B,D and E.
**Parenthetical number is molecular weight of ether compound (i.e., backbone plus derivatized cationic ether groups).

### Example 13. Ratio of Cationic Glucan Polymer to Softening Active

Cationic polymers are known in the art to interact with anionic surfactants creating an insoluble complex polymer rich phase held together via electrostatic and hydrophobic interactions. Typically, insoluble complex systems that are electropositive have a relative higher affinity to cellulose-based fabrics due to their anionic character. Altering the electrostatic potential of the insoluble complex systems under a fixed set of conditions is possible by, for example, adjusting the ratio of total cationic actives in the composition.

Zeta potential is determined according to the test method provided above. The detergent is the equivalent of 3 wt % of liquid TIDE detergent in water having 7 gpg water hardness. The liquid fabric enhancer/softener composition comprises 4 wt % of a cationic alkyl ester quat fabric softening active (“FSA”), where the levels of cationic poly alpha-1,6-glucan ether compound is as provided in Table 10. Results are shown in Table 10.

TABLE 10

| | Poly Alpha- | Cationic Fabric | Poly Alpha-1,6- | Zeta |
|---|---|---|---|---|
| Test | 1,6-Glucan | Softener Active | Glucan Ether:FSA | Potential |
| Leg | Ether (wt %)¹ | (“FSA”) (wt %) | Weight Ratio | (mV) |
| 1 | 0.1 | 4 | 1:40 | −22 |
| 2 | 0.2 | 4 | 1:20 | −24 |
| 3 | 0.5 | 4 | 1:8 | −11 |
| 4 | 1 | 4 | 1:4 | −4 |
| 5 | 2 | 4 | 1:2 | +27 |

¹Polymer K-refer to Table 1.

Zeta potential measurements in Table 10 show that liquid fabric enhancer compositions according to the present disclosure comprising a cationic poly-alpha-1,6-glucan ether polymer are relative more effective at creating a more electropositive insoluble complex system when the weight ratio of cationic poly alpha-1,6-glucan ether to FSA is greater than 1:40. Such greater ratios are likely to be particularly relevant when the level of FSA in a treatment composition is relatively low, such as equal to or less than 8 wt %.

### Example 14. Softness Performance in a Heavy-Duty Liquid Detergent

In the following example, fabrics are treated with a heavy-duty liquid detergent formulation. The detergent formulation is provided in Table 11.

TABLE 11

| | Formula | Formula |
|---|---|---|
| | I | II |
| Ingredient | (comp.) | (inv.) |
| Water | 73.63% | 73.47% |
| Nonionic surfactant | 5.62% | 5.62% |
| Fatty Acid | 2.91% | 2.91% |
| MEA + Tetraborate Premix | 0.63% | 0.63% |
| LAS (anionic surfactant) | 2.30% | 2.30% |
| DTPA | 0.29% | 0.29% |
| Polymer (PEI600 EO20) | 0.27% | 0.27% |
| AES (anionic surfactant) | 7% | 7% |
| Poly Alpha-1,6-Glucan (see | 0.00% | 0.16% |
| Table 12 below) | | |
| Perfume | 0.50% | 0.50% |
| Enzyme | 0.01% | 0.01% |
| Encapsulated perfume | 0.18% | 0.18% |
| Structurant | 0.17% | 0.17% |
| Misc. (e.g., pH adjusters, salt, | Balance | Balance |
| solvent, hydrotrope, | to 100% | to 100% |
| preservative) | | |

Various polymers, as listed in Table 12 below, are tested in combination with the detergent formulation, and Instron Secant Modulus (7422) data are collected. The results are provided in Table 12.

TABLE 12

| | | | | | Instron |
|---|---|---|---|---|---|
| | | Backbone | | Degree of | Secant |
| | | MW | | Alpha-1,2 | Modulus |
| Formula | Polymer | (kDa) | DoS | Branching | (7422) |
| I | — | — | — | — | 5.3 |
| II | T¹ | 109 | 0.26 | 26% | 3.5 |
| II | K¹ | 185 | 0.38 | 5% | 3.9 |
| II | L¹ | 185 | 0.03 | 5% | 3.1 |

¹See Table 1 for information regarding cationic poly alpha-1,6-glucan ethers of Polymers T, K and L.

### Example 15. Softness Performance in a Laundry Additive Particle (1)

In the following example, fabrics are treated with a laundry additive formulation in the form of a particle (a pastille or bead). The treatment occurred during a wash cycle of an automatic washing machine in combination with a heavy-duty laundry detergent. The additive formulation is provided in Table 13. After treatment, the fabrics are tested with an Instron instrument for Secant Modulus values, which are provided in Table 14.

TABLE 13

| | I | II | III | IV |
|---|---|---|---|---|
| Ingredient | (comp.) | (inv.) | (inv.) | (inv.) |
| Polyhydroxystearic Acid | 20% | 20% | 20% | — |
| (MW5000) | | | | |
| Aminosilicone | 10% | 10% | 10% | — |
| Quaternary Ammonium Poly | — | 3% | 6% | 6% |
| Alpha-1,6-Glucan Ether | | | | |
| (see Table 14 below) | | | | |
| CatHEC | 3% | — | — | — |
| Polyethylene Glycol MW 8000 | 67% | 67% | 67% | 79.9 |
| PMC (31% active) | — | — | — | 3.8% |
| Perfume | — | — | — | 10.3% |

TABLE 14

| | Instron Secant Modulus | | | Terry Coefficient | | |
|---|---|---|---|---|---|---|
| | (479) | | | of Friction | | |
| | Formula | Formula | Formula | Formula | Formula | Formula |
| Polymer | I | II | III | I | II | III |
| CatHEC | 185 | — | — | 1.1555 | — | — |
| | MPa | | | | | |
| J¹ | — | 184 | — | — | 1.151 | — |
| | | MPa | | | | |
| K¹ | — | 195 | 159 | — | 1.2085 | 1.1195 |
| | | MPa | MPa | | | |
| L¹ | — | 217 | — | — | 1.448 | — |
| | | MPa | | | | |

¹See Table 1 for information regarding cationic poly alpha-1,6-glucan ethers of Polymers J, K and L.

### Example 16. Softness Performance in a Laundry Additive Particle (2)

In the following example, fabrics are treated with a laundry additive formulation in the form of a particle (a pastille or bead). The treatment occurred during a wash cycle of an automatic washing machine in combination with a heavy-duty laundry detergent. The additive formulation is provided in Table 15. After treatment, the fabrics are tested with an Instron instrument for Secant Modulus values, which are provided in Table 16.

TABLE 15

| | V | IX |
|---|---|---|
| Ingredient | (inv.) | (comp.) |
| PEG 8000 | 67% | 70% |
| Fabric Softening Active 3 | 30% | 30% |
| Quaternary Ammonium Poly | 3% | — |
| Alpha-1,6-Glucan Ether | | |
| (see Table 16 below) | | |

TABLE 16

| | Instron Secant Modulus | | | |
|---|---|---|---|---|
| | (7422) | | Coefficient of Friction | |
| | | Formula IX | | Formula IX |
| Polymer | Formula V | (comp.) | Formula V | (comp.) |
| — | — | 4.93 | — | 1.48 |
| A¹ | 3.60 | — | 1.26 | — |
| B¹ | 2.32 | — | 1.18 | — |
| C¹ | 4.04 | — | 1.39 | — |

¹See Table 1 for information regarding cationic poly alpha-1,6-glucan ethers of Polymers A, B and C.

### Example 17. Exemplary Heavy-Duty Liquid Laundry Detergent Formulations

Table 17 shows exemplary formulations (1-7) for heavy-duty liquid (HDL) laundry detergent compositions.

TABLE 17

| | 1 | 2 | 3 | 4 | 5 | 6 | 7 |
|---|---|---|---|---|---|---|---|
| Ingredient | % weight | | | | | | |
| C₁₂₋₁₅ alkyl ethoxy | 6.77 | 5.16 | 1.36 | 1.30 | — | — | — |
| (1.8) sulfate | | | | | | | |
| C₁₂₋₁₅ alkyl ethoxy (3) | — | — | — | — | 0.45 | — | — |
| sulfate | | | | | | | |
| LAS | 0.86 | 2.06 | 2.72 | 0.68 | 0.95 | 1.56 | 3.55 |
| HSAS | 1.85 | 2.63 | 1.02 | — | — | — | — |
| AE9 | 6.32 | 9.85 | 10.20 | 7.92 | | | |
| AE8 | | | | | | | 35.45 |
| AE7 | | | | | 8.40 | 12.44 | |
| C₁₂₋₁₄ dimethyl amine | 0.30 | 0.73 | 0.23 | 0.37 | — | — | — |
| oxide | | | | | | | |
| C₁₂₋₁₈ Fatty Acid | 0.80 | 1.90 | 0.60 | 0.99 | 1.20 | — | 15.00 |
| Citric Acid | 2.50 | 3.96 | 1.88 | 1.98 | 0.90 | 2.50 | 0.60 |
| Optical Brightener 1 | 1.00 | 0.80 | 0.10 | 0.30 | 0.05 | 0.50 | 0.001 |
| Optical Brightener 2 | 0.001 | 0.05 | 0.01 | 0.20 | 0.50 | — | 1.00 |
| Sodium formate | 1.60 | 0.09 | 1.20 | 0.04 | 1.60 | 1.20 | 0.20 |
| DTI | 0.32 | 0.05 | — | 0.60 | — | 0.60 | 0.01 |
| Sodium hydroxide | 2.30 | 3.80 | 1.70 | 1.90 | 1.70 | 2.50 | 2.30 |
| Monoethanolamine | 1.40 | 1.49 | 1.00 | 0.70 | — | — | — |
| Diethylene glycol | 5.50 | — | 4.10 | — | — | — | — |
| Chelant | 0.15 | 0.15 | 0.11 | 0.07 | 0.50 | 0.11 | 0.80 |
| 4-formyl-phenylboronic | — | — | — | — | 0.05 | 0.02 | 0.01 |
| acid | | | | | | | |
| Sodium tetraborate | 1.43 | 1.50 | 1.10 | 0.75 | — | 1.07 | — |
| Ethanol | 1.54 | 1.77 | 1.15 | 0.89 | — | 3.00 | 7.00 |
| Polymer 1 | 0.10 | — | — | — | — | — | 2.00 |
| Polymer 2 | 0.30 | 0.33 | 0.23 | 0.17 | — | — | — |
| Polymer 3 | — | — | — | — | — | — | 0.80 |
| Polymer 4 | 0.80 | 0.81 | 0.60 | 0.40 | 1.00 | 1.00 | — |
| Polymer 5 (cat. poly | 0.50 | 0.15 | 0.60 | 0.25 | 0.75 | 0.10 | 0.20 |
| alpha-1,6 glucan ether | | | | | | | |
| herein) | | | | | | | |
| 1,2-Propanediol | — | 6.60 | — | 3.30 | 0.50 | 2.00 | 8.00 |
| Structurant | 0.10 | — | — | — | — | — | 0.10 |
| (Hydrogenated Castor | | | | | | | |
| Oil) | | | | | | | |
| Perfume | 1.60 | 1.10 | 1.00 | 0.80 | 0.90 | 1.50 | 1.60 |
| Perfume encapsulate | 0.10 | 0.05 | 0.01 | 0.02 | 0.10 | 0.05 | 0.10 |
| Protease | 0.80 | 0.60 | 0.70 | 0.90 | 0.70 | 0.60 | 1.50 |
| Mannanase | 0.07 | 0.05 | 0.045 | 0.06 | 0.04 | 0.045 | 0.10 |
| Amylase 1 | 0.30 | — | 0.30 | 0.10 | — | 0.40 | 0.10 |
| Amylase 2 | — | 0.20 | 0.10 | 0.15 | 0.07 | — | 0.10 |
| Xyloglucanase | 0.20 | 0.10 | — | — | 0.05 | 0.05 | 0.20 |
| Lipase | 0.40 | 0.20 | 0.30 | 0.10 | 0.20 | — | — |
| Polishing enzyme | — | 0.04 | — | — | — | 0.004 | — |
| Nuclease | 0.05 | — | — | — | — | — | 0.003 |
| Dispersin B | — | — | — | 0.05 | 0.03 | 0.001 | 0.001 |
| Liquitint ® V200 | 0.01 | — | — | — | — | — | 0.005 |
| Leuco colorant | 0.05 | 0.035 | 0.01 | 0.02 | 0.004 | 0.002 | 0.004 |
| Dye control agent | — | 0.3 | — | 0.03 | — | 0.3 | 0.3 |

| | |
|---|---|
| Water, dyes and | Balance |
| minors | |
| pH | 8.2 |

Based on total cleaning and/or treatment composition weight. Enzyme levels are reported as raw material.

### Table 17 Key:

AE7 is C₁₂₋₁₃ alcohol ethoxylate, with an average degree of ethoxylation of 7.
AE8 is C₁₂₋₁₃ alcohol ethoxylate, with an average degree of ethoxylation of 8.
AE9 is C₁₂₋₁₃ alcohol ethoxylate, with an average degree of ethoxylation of 9.
Amylase 1 is Stainzyme®, 15 mg active/g, supplied by Novozymes.
Amylase 2 is Natalase®, 29 mg active/g, supplied by Novozymes.
Xyloglucanase is Whitezyme®, 20 mg active/g, supplied by Novozymes.
Chelant is diethylene triamine pentaacetic acid.
Dispersin B is a glycoside hydrolase, reported as 1000 mg active/g.
DTI is either poly(4-vinylpyridine-1-oxide) (such as Chromabond S-403E®), or poly(l-vinylpyrrolidone-co-1-vinylimidazole) (such as Sokalan HP56®).
Dye control agent is a suitable dye control agent, for example Suparex® O.IN (M1), Nylofixan® P (M2), Nylofixan® PM (M3), or Nylofixan® HF (M4).
HSAS is mid-branched alkyl sulfate as disclosed in U.S. 6020303 and U.S. 6060443.
LAS is linear alkylbenzenesulfonate having an average aliphatic carbon chain length C₉-C₁₅ (HLAS is acid form).
Leuco colorant is any suitable leuco colorant or mixtures thereof.
Lipase is Lipex®, 18 mg active/g, supplied by Novozymes.
Liquitint® V200 is a thiophene azo dye provided by Milliken.
Mannanase is Mannaway®, 25 mg active/g, supplied by Novozymes.
Nuclease is a Phosphodiesterase, reported as 1000 mg active/g.
Optical Brightener 1 is disodium 4,4′-bis{[4-anilino-6-morpholino-s-triazin-2-yl]-amino}-2,2′-stilbenedisulfonate.
Optical Brightener 2 is Optiblanc SPL10® from 3V Sigma.
Perfume encapsulate is a core-shell melamine formaldehyde perfume microcapsules (ex Encapsys).
Polishing enzyme is Para-nitrobenzyl esterase, reported as 1000 mg active/g.
Polymer 1 is bis((C₂H₅O)(C₂H₄O)n)(CH₃)—N⁺—CₓH₂ₓ—N⁺—(CH₃)-bis((C₂H₅O)(C₂H₄O)n), wherein n=20-30, x=3 to 8 or sulphated or sulfonated variants thereof.
Polymer 2 is ethoxylated (EO₁₅) tetraethylene pentamine.
Polymer 3 is ethoxylated polyethylenimine.
Polymer 4 is ethoxylated hexamethylene diamine.
Polymer 5 is cationic poly alpha-1,6-glucan ethers according to the present disclosure—e.g., see Table 1 above (Polymers A-T).
Protease is Purafect Prime®, 40.6 mg active/g, supplied by DuPont.

### Example 18. Exemplary Soluble Unit Dose Formulation

Table 18 shows an exemplary formulation for use in a water-soluble unit dose article. The composition can be part of a single chamber water-soluble unit dose article or can be split over multiple compartments resulting in an “averaged 10 across compartments” full article composition. The composition is encapsulated by a water-soluble film that forms a compartment. A multi-compartmented pouch may include side-by-side compartments, or superposed compartments.

TABLE 18

| Ingredient | (wt %) |
|---|---|
| Fatty alcohol ethoxylate non-ionic surfactant, | 3.8 |
| C₁₂₋₁₄ average degree of ethoxylation of 7 | |
| Lutensol XL100 | 0.5 |
| Linear C₁₁₋₁₄ alkylbenzene sulphonate | 24.6 |
| AE3S Ethoxylated alkyl sulphate with an average | 12.5 |
| degree of ethoxylation of 3 | |
| Citric acid | 0.7 |
| Palm Kernel Fatty acid | 5.3 |
| Nuclease enzyme (wt % active protein) | 0.01 |
| Protease enzyme (wt % active protein) | 0.07 |
| Amylase enzyme (wt % active protein) | 0.005 |
| Xyloglucanase enzyme (wt % active protein) | 0.005 |
| Mannanase enzyme (wt % active protein) | 0.003 |
| Ethoxylated polyethyleneimine | 1.6 |
| Amphiphilic graft copolymer | 2.6 |
| Zwitterionic polyamine | 1.8 |
| Cationic poly alpha-1,6 glucan ether of | 5.0 |
| present disclosure (e.g. Table 1) | |
| Anionic polyester terephthalate | 0.6 |
| HEDP | 2.2 |
| Brightener 49 | 0.4 |
| Silicone anti-foam | 0.3 |
| Hueing dye | 0.05 |
| 1,2 Propanediol | 12.3 |
| Glycerine | 4.7 |
| DPG (DiPropyleneGlycol) | 1.7 |
| TPG (TriPropyleneGlycol) | 0.1 |
| Sorbitol | 0.1 |
| Monoethanolamine | 10.2 |
| K₂SO₃ | 0.4 |
| MgCl₂ | 0.3 |
| water | 10.8 |
| Hydrogenated castor oil | 0.1 |
| Perfume | 2.1 |
| Aesthetic dye and minors | Balance to |
| | 100 |
| pH (10% product concentration in | 7.4 |
| demineralized water at 20° C.) | |

### Example 19. Exemplary Powdered Detergent Formulations

Table 19 shows exemplary formations for solid free-flowing particulate laundry detergent compositions.

TABLE 19

| Ingredient | Amount |
|---|---|
| Anionic detersive surfactant (such as alkyl benzene | 8 wt % to 15 wt % |
| sulphonate, alkyl ethoxylated sulphate and mixtures | |
| thereof) | |
| Non-ionic detersive surfactant (such as alkyl | 0.1 wt % to 4 wt % |
| ethoxylated alcohol) | |
| Cationic detersive surfactant (such as quaternary | 0 wt % to 4 wt % |
| ammonium compounds) | |
| Other detersive surfactant (such as zwitterionic | 0 wt % to 4 wt % |
| detersive surfactants, amphoteric surfactants and | |
| mixtures thereof) | |
| Carboxylate polymer (such as co-polymers of maleic | 0.1 wt % to 4 wt % |
| acid and acrylic acid and/or carboxylate polymers | |
| comprising ether moieties and sulfonate moieties) | |
| Polyethylene glycol polymer (such as a polyethylene | 0 wt % to 4 wt % |
| glycol polymer comprising polyvinyl acetate side chains) | |
| Polyester soil release polymer (such as Repel-o-tex | 0 wt % to 2 wt % |
| and/or Texcare polymers) | |
| Cellulosic polymer (such as carboxymethyl cellulose, | 0.5 wt % to 2 wt % |
| methyl cellulose and combinations thereof) | |
| Cationic poly alpha-1,6 glucan ether of present | 0.1 wt % to 4 wt % |
| disclosure-e.g., see Table 1 | |
| Other polymer (such as care polymers) | 0 wt % to 4 wt % |
| Zeolite builder and phosphate builder (such as | 0 wt % to 4 wt % |
| zeolite 4A and/or sodium tripolyphosphate) | |
| Other co-builder (such as sodium citrate and/or citric | 0 wt % to 3 wt % |
| acid) | |
| Carbonate salt (such as sodium carbonate and/or | 0 wt % to 20 wt % |
| sodium bicarbonate) | |
| Silicate salt (such as sodium silicate) | 0 wt % to 10 wt % |
| Filler (such as sodium sulphate and/or bio-fillers) | 10 wt % to 70 wt % |
| Source of hydrogen peroxide (such as sodium | 0 wt % to 20 wt % |
| percarbonate) | |
| Bleach activator (such as tetraacetylethylene diamine | 0 wt % to 8 wt % |
| (TAED) and/or nonanoyloxybenzenesulphonate | |
| (NOBS)) | |
| Bleach catalyst (such as oxaziridinium-based bleach | 0 wt % to 0.1 wt % |
| catalyst and/or transition metal bleach catalyst) | |
| Other bleach (such as reducing bleach and/or pre- | 0 wt % to 10 wt % |
| formed peracid) | |
| Photobleach (such as zinc and/or aluminum | 0 wt % to 0.1 wt % |
| sulphonated phthalocyanine) | |
| Chelant (such as ethylenediamine-N′N′-disuccinic acid | 0.2 wt % to 1 wt % |
| (EDDS) and/or hydroxyethane diphosphonic acid | |
| (HEDP)) | |
| Hueing agent (such as direct violet 9, 66, 99, acid red | 0 wt % to 1 wt % |
| 50, solvent violet 13 and any combination thereof) | |
| Brightener (C.I. fluorescent brightener 260 or C.I. | 0.1 wt % to 0.4 wt % |
| fluorescent brightener 351) | |
| Protease (such as Savinase, Savinase Ultra, Purafect, | 0.1 wt % to 0.4 wt % |
| FN3, FN4 and any combination thereof) | |
| Amylase (such as Termamyl, Termamyl ultra, Natalase, | 0 wt % to 0.2 wt % |
| Optisize, Stainzyme, Stainzyme Plus and any | |
| combination thereof) | |
| Cellulase (such as Carezyme and/or Celluclean) | 0 wt % to 0.2 wt % |
| Lipase (such as Lipex, Lipolex, Lipoclean and any | 0 wt % to 1 wt % |
| combination thereof) | |
| Other enzyme (such as xyloglucanase, cutinase, | 0 wt % to 2 wt % |
| pectate lyase, mannanase, bleaching enzyme) | |
| Fabric softener (such as montmorillonite clay and/or | 0 wt % to 15 wt % |
| polydimethylsiloxane (PDMS)) | |
| Flocculant (such as polyethylene oxide) | 0 wt % to 1 wt % |
| Suds suppressor (such as silicone and/or fatty acid) | 0 wt % to 4 wt % |
| Perfume (such as perfume microcapsule, spray-on | 0.1 wt % to 1 wt % |
| perfume, starch encapsulated perfume accords, | |
| perfume loaded zeolite, and any combination thereof) | |
| Aesthetics (such as coloured soap rings and/or | 0 wt % to 1 wt % |
| coloured speckles/noodles) | |
| Miscellaneous | balance to 100 wt % |

### Example 20. Exemplary Shampoo Formulation and Use in Lubricating Hair (Conditioning)

TABLE 20

| Ingredient | Amount |
|---|---|
| Cocamidopropyl betaine | 3 wt % |
| Sodium laureth sulfate (SLES) | 14 wt % |
| Cationic poly alpha-1,6 glucan ether | 1 wt % |
| of Example 1 | |
| Sodium chloride | 2.2 wt % |

Lubrication can be measured by a method as described in Garcia and Diaz (1976, J. Soc. Cosmet. Chem. 27:379-398), for example, which is incorporated herein by reference. The formula of Table 20 had hair lubricating properties as compared to a control formula that only differed by lacking the cationic poly alpha-1,6 glucan ether. For example, washing hair with the formulation of Table 20 resulted in a 35% reduction in the maximum force needed to comb the washed hair, as compared to the force needed to comb hair washed using the control formulation.

### Example 21. Demonstration of Benefit in Beauty Care: Hair Styling Application

Polymer Q from Example 7 (Table 1, 185 kDa poly alpha-1,6-glucan backbone with 5% alpha-1,2 branching, DoS of 0.07 with hydroxypropyl trimethylammonium) was fully dissolved at 1 wt % in an ethanol/water (1/1) mixture. The turbidity of this solution was measured to be 1 NTU (nephelometric turbidity unit) using a calibrated turbidimeter (HACH 2100P). The solution was then poured into a Petri dish and allowed to evaporate overnight at room temperature. The resulting film was examined to be clear and coherent. These features (low turbidity, ability to form clear film) are believed to render this material as useful in hair styling products—e.g., can render clear and transparent application on hair to provide hair styling hold while avoiding an unclean look. In a curl retention test, ˜0.5 gram of the above polymer solution was applied to a hair tress (8″ RINBOOOL hair swatches). In a control test, the above solvent alone (without Polymer Q) was applied instead. Each hair tress was then dried at room temperature overnight with half of the hair tress curled back at a >90 degree angle. The treated hair tresses were hung in a 45° C. oven and heated for 3 hours. The height of the curled half of each hair tress was then measured. In the control experiment, the height of the curled half of the hair tress changed by 4.1 cm. However, the height of the curled half of the hair tress treated with polymer Q changed by only 1.2 cm, thereby indicating a significant improvement of hair styling retention.

1. A composition comprising a poly alpha-1,6-glucan ether compound that comprises:
(i) poly alpha-1,6-glucan substituted with at least one positively charged organic group;
(ii) a weight average degree of polymerization of 5 about 5 to about 6000; and
(iii) a degree of substitution of about 0.001 to about 3.0;
wherein the poly alpha-1,6-glucan comprises a backbone of glucose monomer units, and wherein at least 90% of the backbone glucose monomer units are linked via alpha-1,6-glycosidic linkages, at least about 3% of the backbone glucose monomer units have branches via alpha-1,2 glycosidic linkages, and less than 1% of the glycosidic linkages of the poly alpha-1.6-glucan are alpha-1,3 glycosidic linkages.

2. The composition of claim 1, wherein at least about 3% about 35% of the backbone glucose monomer units have branches via alpha-1,2 glycosidic linkages.

3. The composition of claim 1, wherein the positively charged organic group comprises a substituted ammonium group.

4. The composition of claim 3, wherein the substituted ammonium group comprises a quaternary ammonium group.

5. The composition of claim 4, wherein the quaternary ammonium group comprises at least one C₁ to C₁₈ alkyl group.

6. The composition of claim 4, wherein the quaternary ammonium group comprises at least one C₁ to C₄ alkyl group.

7. The composition of claim 4, wherein the quaternary ammonium group comprises at least one C₁₀ to C₁₆ alkyl group.

8. The composition of claim 7, wherein the quaternary ammonium group further comprises two C₁ to C₄ alkyl groups.

9. The composition of claim 4, wherein the quaternary ammonium group comprises a trimethylammonium group.

10. The composition of claim 1, wherein the positively charged organic group comprises a quaternary ammonium hydroxyalkyl group.

11. The composition of claim 10, wherein the quaternary ammonium hydroxyalkyl group comprises a quaternary ammonium hydroxymethyl group, a quaternary ammonium hydroxyethyl group, or a quaternary ammonium hydroxypropyl group.

12. (canceled)

13. The composition of claim 10, wherein the quaternary ammonium hydroxyalkyl group comprises a trimethylammonium hydroxypropyl group.

14. The composition of claim 1, wherein the degree of substitution is about 0.01 to about 1.5.

15. The composition of claim 1, wherein the poly alpha-1.6-glucan ether compound has a weight average degree of polymerization of about 5 to about 2000.

16-19. (canceled)

20. The composition of claim 1, in the form of a liquid, gel, powder, hydrocolloid, aqueous solution, granule, tablet, capsule, bead or pastille, single compartment sachet, pad, multi-compartment sachet, single compartment pouch, or multi-compartment pouch.

21. The composition of claim 20, further comprising at least one detergent builder, complexing agent, polymer, soil release polymer, surfactancy-boosting polymer, bleaching agent, bleach activator, bleaching catalyst, fabric conditioner, clay, foam booster, suds suppressor, anti-corrosion agent, soil-suspending agent, anti-soil re-deposition agent, dye, bactericide, tarnish inhibitor, optical brightener, perfume, saturated or unsaturated fatty acid, dye transfer-inhibiting agent, chelating agent, hueing dye, calcium cation, magnesium cation, visual signaling ingredient, anti-foam, structurant, thickener, anti-caking agent, starch, sand, gelling agent, or combination thereof.

22-23. (canceled)

24. The composition of claim 1, wherein
(i) the composition further comprises one or more of a perfume, fragrance, flavor, air odor-reducing agent, insect repellent, insecticide, bubble-generating agent, non-woven material, colorant, preservative, antioxidant, emulsifier, emollient, oil, medicament, or suspending agent; and/or
(ii) the composition is a disinfecting product, cleaning product, coating product, wipe, or hard surface cleaner such as for a floor, countertop, table, desk, tub/shower, sink, toilet bowl, door/cabinet handle/panel, or glass/window;
wherein the composition is not a fabric care product or dish care product.

25. A method for treating a substrate, the method comprising the steps:
(a) providing a composition according to claim 1;
(b) contacting the substrate with the composition; and
(c) optionally rinsing the substrate;
wherein the substrate is not a fabric substrate or dish substrate.

26. The composition of claim 1, wherein the degree of substitution is about 0.01 to about 0.4.

27. The composition of claim 1, further comprising at least one enzyme, optionally wherein the enzyme is a cellulase, protease, lipase, or amylase.
